(19) United States
(12) Patent Application Publication
(10) Pub. No.: US 2026/0138377 A1
(43) Pub. Date: May 21, 2026

(54) SYSTEM

(71) Applicant: CANON KABUSHIKI KAISHA, Tokyo (JP)

(72) Inventors: YUTA SANO, Tokyo (JP); KANTO KURASAWA, Tokyo (JP)

(21) Appl. No.: 19/388,914

(22) Filed: Nov. 13, 2025

(30) Foreign Application Priority Data
Nov. 21, 2024 (JP) 2024-203414
Dec. 24, 2024 (JP) 2024-227962

(51) Int. Cl. B41J 2/20; B01F 31/31; B01F 35/22; B01F 35/221; B01F 101/35; B41J 2/175; B41J 29/00

(52) U.S. Cl. CPC B41J 2/20; B01F 31/31; B01F 35/2209; B01F 35/2211; B01F 35/22161; B41J 2/17513; B41J 2/17553; B41J 29/00; B01F 2101/35; B41J 2002/17516

(57) ABSTRACT

A system includes a storage unit configured to store a liquid container; a discharging unit configured to discharge a liquid to a medium; a stirring unit configured to perform a stirring operation for the liquid container stored in the storage unit such that the liquid stored in the liquid container is stirred; a supplying unit configured to perform a supply operation for supplying the liquid from the liquid container stored in the storage unit to the discharging unit; and a control unit configured to execute first control of prioritizing the supply operation over the stirring operation.

### BACKGROUND

### Field of the Technology

The present disclosure relates to a system.

### Description of the Related Art

In some cases, a liquid containing a substance with that is sediment forming needs to be stirred to disperse a sediment at the time of use. For example, in a printing apparatus that performs printing by discharging liquid ink to a print medium, when using ink such as pigment ink or metallic ink, stirring may be needed to disperse a sediment. Japanese Patent Laid-Open No. 2008-238476 discloses an apparatus which, upon receiving print data, performs control to stir ink in a mode with a higher stirring capability than a mode having a predetermined stirring capability.

By the way, there is a case where a liquid needs to be supplied to discharge the liquid. In such a case, if the liquid is stirred, this may impede liquid supply. However, there is a case where the liquid needs to be stirred, as described above. Hence, a contrivance to perform an operation that should have priority is required. In this regard, the prior art has room for improvement.

### SUMMARY

The present disclosure provides a technique capable of executing an operation that should have priority out of a plurality of operations concerning a liquid.

According to an aspect of the present disclosure, there is provided a system comprising: a storage unit configured to store a liquid container; a discharging unit configured to discharge a liquid to a medium; a stirring unit configured to perform a stirring operation for the liquid container stored in the storage unit such that the liquid stored in the liquid container is stirred; a supplying unit configured to perform a supply operation for supplying the liquid from the liquid container stored in the storage unit to the discharging unit; and a control unit configured to execute first control of prioritizing the supply operation over the stirring operation.

Features of the present disclosure will become apparent from the following description of embodiments with reference to the attached drawings. The following description of embodiments is given by way of example.

### BRIEF DESCRIPTION OF THE DRAWINGS

FIG. 1 is a perspective view of a system according to an embodiment of the present disclosure;

FIG. 2A is a front view of the system shown in FIG. 1;

FIG. 2B is an explanatory view showing the internal structure of a liquid discharge apparatus;

FIG. 3 is a partially exploded perspective view of a liquid supply apparatus;

FIG. 4 is a perspective view of a liquid container and a support unit;

FIG. 5 is an explanatory view of operation of a handle and a lock mechanism;

FIG. 6 is an explanatory view of operation of the lock mechanism;

FIG. 7 is a view showing the attachment posture and the insertion/removal mode of the support unit to a slot;

FIG. 8 is an explanatory view of operation of a pressing unit;

FIG. 9 is an explanatory view of operation of the pressing unit;

FIG. 10 is an explanatory view of a cam;

FIG. 11 is a perspective view of a case with a stirring function and the support unit in a separated state;

FIG. 12 is a perspective view of the case with a stirring function and the support unit in an attached state;

FIG. 13A is an explanatory view of a stirring operation;

FIG. 13B is an explanatory view of a stirring operation;

FIG. 14A is a front view of the liquid supply apparatus;

FIG. 14B is a front view of a liquid supply apparatus of another example;

FIG. 15 is an explanatory view of a supply operation and a stirring operation;

FIG. 16 is a block diagram of the control circuit of the system shown in FIG. 1;

FIG. 17 is a timing chart for explaining an example of control of the stirring operation;

FIG. 18 is a timing chart for explaining an example of control of the stirring operation and the supply operation;

FIGS. 19A and 19B are timing charts for explaining an example of control of the stirring operation and the supply operation;

FIG. 20 is a timing chart for explaining an example of control of the stirring operation and the supply operation;

FIGS. 21A and 21B are timing charts for explaining an example of control of the stirring operation and the supply operation;

FIG. 22 is a flowchart showing an example of processing executed by a control unit;

FIG. 23 is a flowchart showing an example of processing executed by the control unit;

FIG. 24 is a perspective view of a liquid supply apparatus according to another embodiment;

FIG. 25 is an explanatory view showing the internal structure of the liquid supply apparatus shown in FIG. 24;

FIG. 26 is a perspective view of a liquid container;

FIG. 27 is a perspective view of a tray;

FIG. 28 is a perspective view of a tray;

FIG. 29 is a perspective view of a lock mechanism;

FIGS. 30A to 30C are explanatory views of operation of the lock mechanism shown in FIG. 29;

FIG. 31 is a perspective view of a tray with a liquid container placed thereon;

FIG. 32 is a front view of the connecting portion of the liquid container;

FIG. 33 is a view showing the tray with the liquid container placed thereon viewed from the side of a rear wall portion;

FIG. 34 is a perspective view of the periphery of the holding portion of the tray;

FIG. 35 is a perspective view of a connecting unit;

FIGS. 36A and 36B are explanatory views of operation of a driving unit;

FIGS. 37A and 37B are explanatory views of operation of the driving unit;

FIG. 38 is a flowchart showing an example of control;

FIG. 39 is a flowchart showing an example of control;

FIGS. 40A and 40B are timing charts showing a detailed example of the control shown in FIG. 39;

FIG. 41 is a flowchart showing another example of control;

FIGS. 42A and 42B are timing charts showing a detailed example of the control shown in FIG. 41;

FIG. 43 is a flowchart showing another example of control;

FIGS. 44A and 44B are timing charts showing a detailed example of the control shown in FIG. 43;

FIG. 45 is a flowchart showing another example of control; and

FIGS. 46A to 46C are timing charts showing a detailed example of the control shown in FIG. 45.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

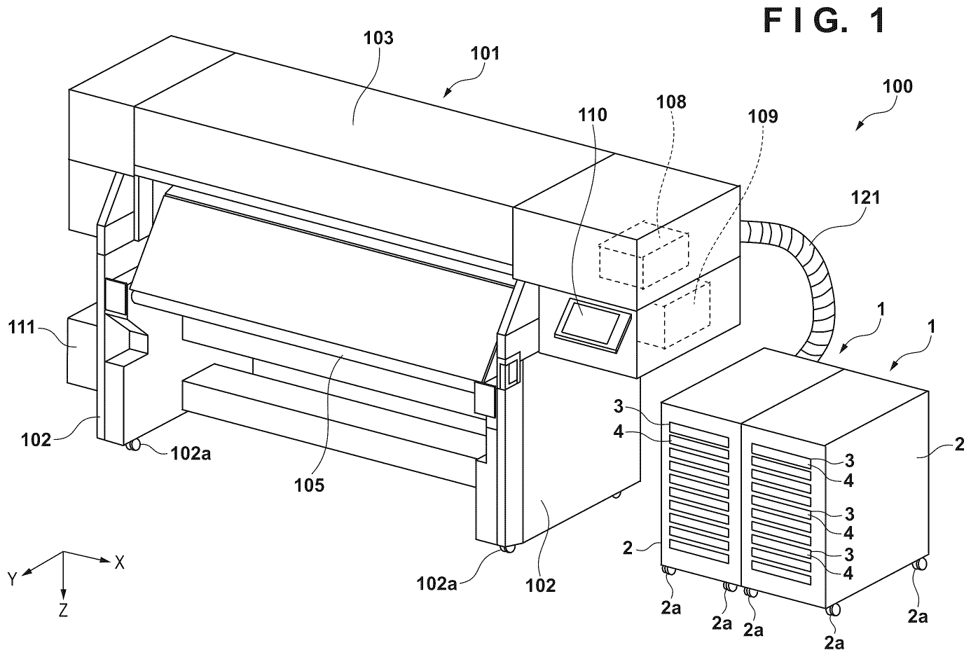

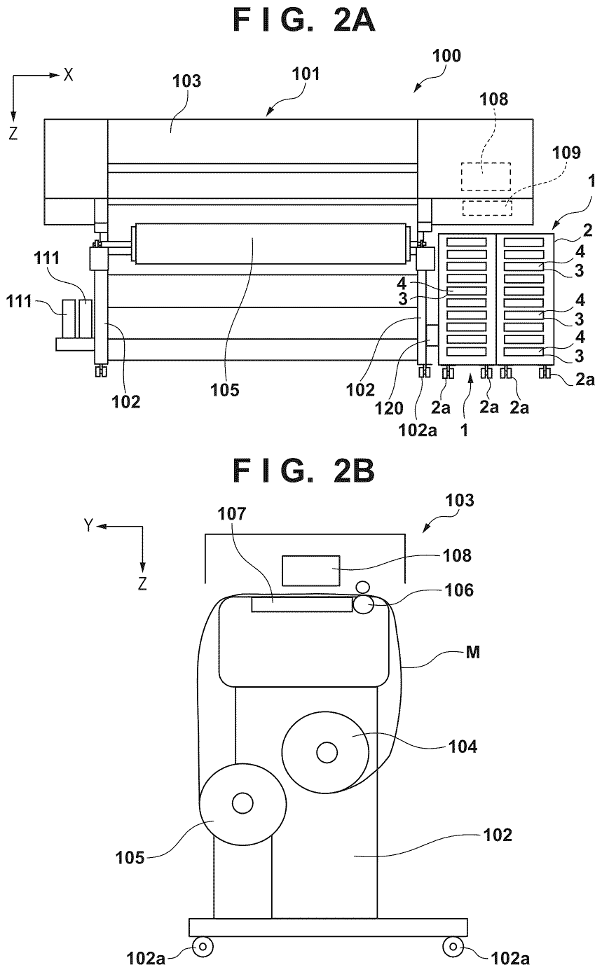

FIG. 1 is a perspective view of a system 100 according to an embodiment of the present disclosure, and FIG. 2A is a front view of the system 100. In the drawings, arrows X, Y, and Z indicate directions crossing each other, and in this embodiment, the directions are orthogonal to each other. The left-right direction in a case where the system 100 is installed on a horizontal surface is the X direction, the front-back direction is the Y direction, and the upward-downward direction is the Z direction. In addition, the right side when the system 100 is viewed from the front is the +X direction, the left side is the −X direction, the near side is the +Y direction, the far side is the −Y direction, the lower side (downward in the gravity direction) is the +Z direction, and the upper side (upward in the gravity direction) is the −Z direction.

The system 100 according to this embodiment is a printing system that includes a liquid supply apparatus 1 and a liquid discharge apparatus 101, and prints an image by discharging ink to a print medium such as paper. In this embodiment, two liquid supply apparatuses 1 are provided while being connected to each other. The liquid discharge apparatus 101 and the two liquid supply apparatuses 1 are arranged side by side in the X direction. A liquid that the liquid supply apparatuses 1 supply to the liquid discharge apparatus 101 is ink, and the liquid discharge apparatus 101 is a printing apparatus that discharges the ink to the print medium. However, the present disclosure is not limited to the printing system, and can also be applied to various kinds of liquid discharge systems aiming at discharging a liquid to a medium.

Note that “printing” is not limited to formation of significant information such as a character or figure, and includes, in a broad sense, to form an image, design, pattern, or the like on a print medium or process a medium regardless of whether information is significant or insignificant, or whether information is so visualized as to allow a person to visually perceive it. Also, in this embodiment, the “print medium” is assumed to be sheet-shaped paper but may be a cloth, a plastic film, or the like.

### <Liquid Discharge Apparatus>

The liquid discharge apparatus 101 will be described with reference to FIG. 2B in addition to FIGS. 1 and 2A. FIG. 2B is an explanatory view of the internal structure of the liquid discharge apparatus 101. The liquid discharge apparatus 101 includes a pair of left and right stands 102, and a main body 103 supported on the pair of stands 102. Each stand 102 is provided with casters 102a, and the liquid discharge apparatus 101 can be relatively easily moved on the floor. A feeding unit 104 and a winding unit 105 are arranged under the main body 103. In this embodiment, a print medium M is roll paper, and the feeding unit 104 includes a shaft on which the print medium M is wound. The winding unit 105 includes a shaft for winding up the print medium M. In this embodiment, roll paper has been exemplified as the print medium M, but it may be cut paper.

A conveyance unit 106 is provided in the main body 103. The conveyance unit 106 includes a driving roller and a driven roller, and the print medium M fed from the feeding unit 104 is sandwiched in the nip portion between the rollers. When the driving roller rotates, the print medium M is conveyed onto a platen 107. A discharge head 108 is arranged facing the platen 107. The discharge head 108 is a printhead that discharges ink to form an image. The discharge head 108 discharges the ink to the print medium M conveyed onto the platen 107, thereby forming an image on the print medium M.

The discharge head 108 includes, for example, a discharge energy generation element such as an electrothermal transducer (heater) or a piezoelectric element, and discharges ink from an orifice. If the electrothermal transducer is used, ink can be foamed by generated heat and discharged from the orifice using the foaming energy. The printing method of the discharge head 108 can be a serial scan method or a full-line method. In a case of the serial scan method, the discharge head 108 is mounted on a carriage and reciprocally moved in the X direction. Discharging ink while moving the discharge head 108 in the X direction is called print scanning. The conveyance operation of the print medium M and print scanning of the discharge head 108 are alternately repeated, thereby printing an image on the print medium M. In this embodiment, employment of the serial scan method is assumed. In a case of the full-line method, a long discharge head 108 extending in the X direction is used, and an image is printed while continuously conveying the print medium M.

The print medium M with the image printed thereon is wound up by the winding unit 105. A drying unit 14 reduces liquid components contained in the ink applied, by the discharge head 108, to the print medium M, thereby increasing the fixing properties between the print medium M and the ink. The drying unit 14 includes a heat source such as a heater, and a blower mechanism such as a fan, and applies hot air at least from the ink application surface side to the passing print medium M, thereby drying the print medium M. Note that as for the drying method, not only the method of applying hot air but also a method of irradiating the surface of the print medium M with an electromagnetic wave (ultraviolet rays or infrared rays) or a heat conduction method using contact of a heat generating body may be used in combination. In addition, the drying unit 14 may only blow air without having any heat source. The print medium M with the image printed thereon is cut by a user using scissors or automatically cut by a cutter (not shown).

A recovery unit 109 is arranged in the main body 103. The recovery unit 109 is arranged outside the print region (outside the discharge region) of the discharge head 108, and performs processing associated with recovery and maintaining of the discharge performance of the discharge head 108. Examples of the processing are preliminary discharge of discharging a predetermined amount of ink before and after a printing operation and processing of sucking remaining ink or the like from the orifices of the discharge head 108. The discharge head 108 is moved onto the recovery unit 109, as shown in FIG. 2A, if recovery processing is necessary.

In this embodiment, the stands 102 are arranged at positions slightly outside in the ±X directions with respect to the width of the print medium M because these support the feeding unit 104 and the winding unit 105 of heavy weight while supporting the main body 103. The main body 103 incorporating the recovery unit 109 projects to the outer side of the stand 102 in the +X direction. The main body 103 also projects to the outer side of the print medium M in the −X direction on the opposite side. A mechanism configured to move a carriage (not shown) with the discharge head 108 mounted thereon is incorporated here.

An operation panel 110 is provided on the front surface of the main body 103. Also, the operation panel 110 is, for example, a touch panel and can accept input of various kinds of settings concerning printing and display the state of a print job.

The liquid discharge apparatus 101 is also provided with a waste liquid cartridge 111. The waste liquid cartridge 111 is arranged under an end portion of the main body 103 on the opposite side (−X side) of the liquid supply apparatuses 1 in the X direction. When the waste liquid cartridge 111 is arranged on the lower side of the portion of the main body 103 projecting in the −X side, the installation area of the liquid discharge apparatus 101 can be made small.

A waste liquid (waste ink, or the like) sucked by the recovery unit 109 flows into the waste liquid cartridge 111 to be collected. The waste liquid cartridge 111 may be arranged near the recovery unit 109. In this embodiment, however, the waste liquid cartridge 111 is arranged in a free space under the end portion of the main body 103, thereby reducing the installation area of the liquid discharge apparatus 101.

### <Liquid Supply Apparatus>

FIGS. 1 and 2A will be referred to. The liquid supply apparatus 1 is an apparatus that supplies ink to be discharged from the discharge head 108 to the liquid discharge apparatus 101. The liquid supply apparatus 1 includes a box-shaped main body 2 that forms a plurality of slots 3. Casters 2a are provided on the bottom surface of the main body 2, and the liquid supply apparatus 1 can be relatively easily moved on the floor. A plurality of slots 3 open to an outer wall portion 2b on the front side of the main body 2, and the plurality of slots 3 are arrayed in the Z direction. The outer wall portion 2b forms the housing of the main body 2. In each slot 3, a support unit 4 is detachably inserted in the Y direction. The support unit 4 supports a liquid container 200 (to be also simply referred to as a container 200) to be described later. Each slot 3 functions as the storage portion of the container 200.

Each slot 3 is provided with a tube that connects the container 200 and the liquid discharge apparatus 101. Each tube is connected to the liquid discharge apparatus 101 through a single hose 121 that stores all the tubes. Ink in the container 200 is supplied to the discharge head 108 via the tube.

The height of the liquid supply apparatus 1 is set to be lower than the lower surface of the end portion of the main body 103 of the liquid discharge apparatus 101 projecting to the +X side. For this reason, as shown in FIG. 2A, the liquid supply apparatus 1 can be stored under the main body 103. The liquid supply apparatus 1 can be moved close to a position where it contacts the stand 102 in the X direction. As shown in FIG. 2A, the liquid supply apparatus 1 can be fixed to the stand 102 using a connecting member 120. When moving the system 100, the liquid discharge apparatus 101 and the liquid supply apparatus 1 can be moved integrally.

Since the two liquid supply apparatuses 1 are provided, the system 100 according to this embodiment can use more containers 200. When increasing the number of ink colors for the purpose of raising image quality or increasing the amount of ink of the same color for the purpose of attaining high productivity, providing the plurality of liquid supply apparatuses 1 is advantageous. In this case, when a layout in which some or all of liquid supply apparatuses 1 overlap the liquid discharge apparatus 101 in the X direction, as in this embodiment, is employed, the installation area of the system 100 can be made small. Note that in this embodiment, one of the two liquid supply apparatuses 1 falls within the size of the liquid discharge apparatus 101 in the X direction. If the number of liquid supply apparatuses is two or more, the size slightly runs out from the system 100 in the X direction.

### <Liquid Container and Support Unit>

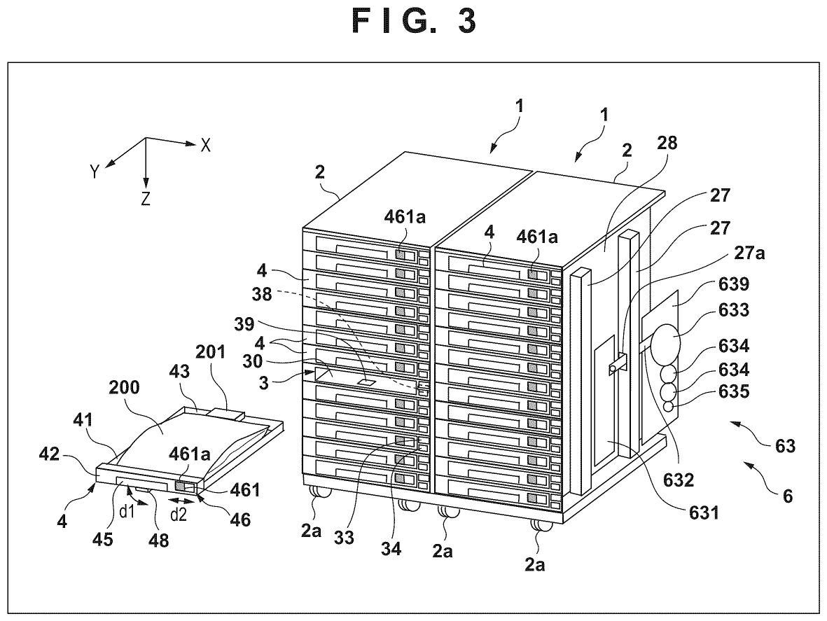

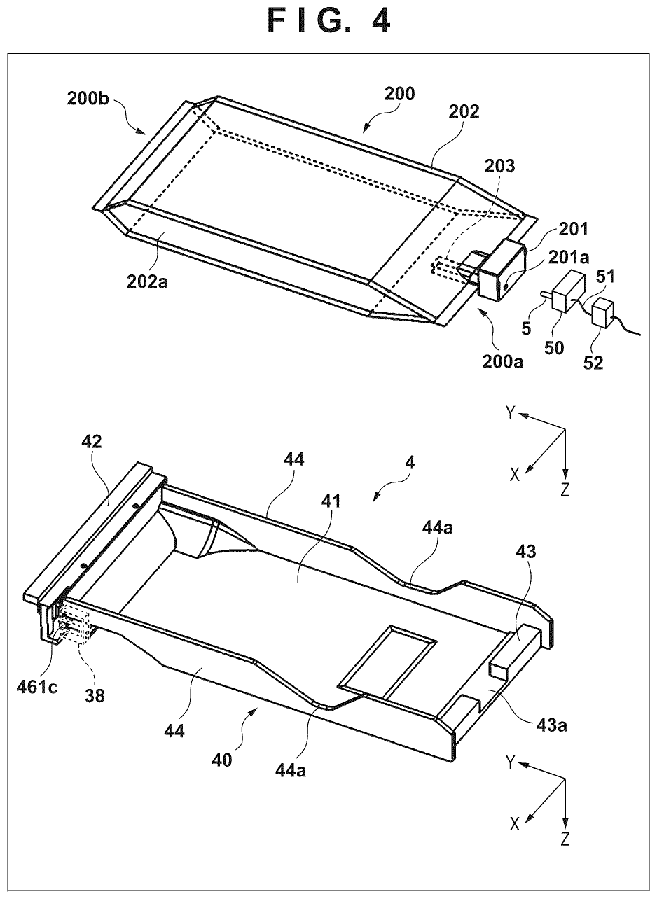

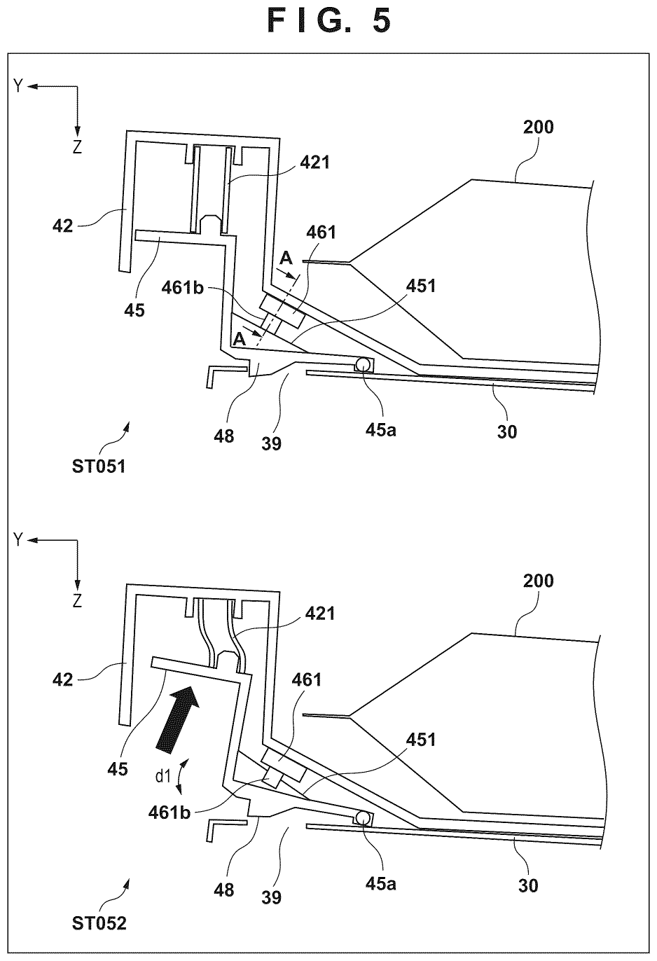

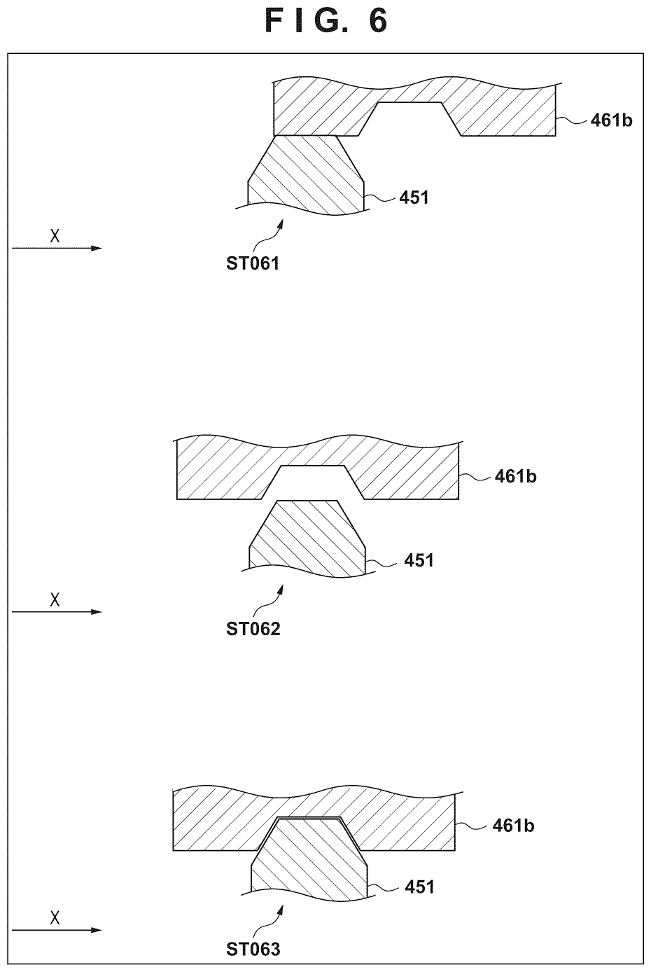

FIGS. 3 to 6 will be referred to. FIG. 3 is a partially exploded perspective view of the liquid supply apparatus 1 and shows a state in which one support unit 4 is detached from a corresponding slot 3. FIG. 3 also shows a state in which one side wall portion of the outer wall portion of the liquid supply apparatus 1 is detached, and the internal mechanism is exposed. FIG. 4 is a perspective view of the container 200 and the support unit 4. FIG. 5 is an explanatory view of operation of a handle 45 and a lock mechanism 46. FIG. 6 is an explanatory view of operation of the lock mechanism 46 and corresponds to a sectional view taken along a line A-A in FIG. 5.

The container 200 includes a bag-shaped container portion 202 made of a material with flexibility. Gusset portions 202a folded inside are provided on both side surfaces of the container portion 202 to increase the liquid storage amount. The container portion 202 is formed into a bag shape by welding sheets forming the upper and lower surfaces and sheets forming the gusset portions 202a to each other, thereby forming a flexible tank for storing a liquid. The shape of the container portion 202 changes in accordance with the stored liquid amount such that if the liquid amount remaining inside is large, the gusset portions 202a expand, and if the liquid amount remaining inside is small, the gusset portions 202a are folded inside. The material of the container portion 202 is, for example, a material having a multiple-layer structure such as PET. If the liquid inside has a property of reacting with air and sticking, or there is concern that the concentration or remaining amount changes due to evaporation, a layer material including an aluminum layer is advantageous as the material of the container portion 202.

The container 200 has one end portion 200a and the other end portion 200b in the longitudinal direction. In an attached state to the liquid supply apparatus 1, the end portion 200a is located on the far side of the liquid supply apparatus 1, and the end portion 200b is located on the near side. A connecting portion 201 is provided at the end portion 200a. In the connecting portion 201, a supply port 201a communicating with an intake port 203 inside the container portion 202 is formed. The liquid stored in the container portion 202 flows to the outside via the intake port 203 and the supply port 201a. A spring biased-type supply port control valve that opens/closes the supply port 201a is provided in the connecting portion 201. By the supply port control valve, the supply port 201a is normally maintained in the closed state.

In the container 200, the side provided with the connecting portion 201 has a length of, for example, about 180 mm, and the side (side surface) orthogonal to this side has a length of, for example, about 400 mm. In the container 200, for example, about 1.5 L of liquid is stored. Note that the side with the connecting portion 201 may be not the short side but the long side. Also, the container portion 202 may have not a rectangular shape but a square shape in a planar view.

The main body 2 includes, on the far side of the slot 3, a connecting unit 50 to be connected to the connecting portion 201. The connecting unit 50 includes a needle-type path forming member 5 to be inserted into the supply port 201a. The connecting unit 50 is provided for each slot 3. If the path forming member 5 is inserted into the supply port 201a and connected, the supply port control valve is opened by the insertion of the path forming member 5. The path forming member 5 communicates with a tube 51. The path forming member 5 forms a path that flows the liquid stored in the container portion 202 to the liquid discharge apparatus 101 that is the supply destination, and the liquid that has flowed out to the path forming member 5 is supplied to the liquid discharge apparatus 101 via the tube 51. An electrically driven passage valve 52 is provided on a midway part of the tube 51. By opening/closing the passage valve 52, the tube 51 can be closed and opened.

The support unit 4 includes a support portion 40 that supports the container 200, and has a form of a tray, as a whole, on which the container 200 in a lying posture is placed. The support unit 4 can displace substantially in the Y direction between a storage position where the container 200 is stored in the main body 2 and an extraction position where the container 200 is exposed to the outside of the main body 2. In FIG. 3, one support unit 4 is located at the extraction position, and all the remaining support units 4 are located at the storage position. At the extraction position, the container 200 can be exchanged. At the storage position, the liquid stored in the container 200 can be supplied to the liquid discharge apparatus 101. In this embodiment, at the extraction position, the support unit 4 is apart from the slot 3. However, the extraction position may be a position where the end portion of the support unit 4 is held inside the slot 3, and can be any position where the container 200 can be exchanged with respect to the support unit 4.

The support portion 40 includes a placement surface 41 on which the container 200 is placed, and the four sides of the placement surface 41 are defined by left and right side plates 44, a front end portion 42, and a rear end portion 43. A notch portion 44a is formed in each side plate 44. A concave portion 43a on which the connecting portion 201 is arranged is formed at the rear end portion 43.

At the front end portion 42, the handle 45 that is rotatable about a shaft 45a extending in the X direction is provided, and the user can rotate the handle 45 in a direction d1. The handle 45 also serves as an operation handle of an engaging portion 48. The handle 45 is provided with the engaging portion 48, and an engaging portion 39 that engages with the engaging portion 48 is formed on the bottom portion of a case 30 that forms the slot 3. In this embodiment, the engaging portion 48 is a projecting portion, and the engaging portion 39 is a concave portion in which the engaging portion 48 is inserted. When the engaging portion 48 and the engaging portion 39 engage with each other, the support unit 4 is attached to the slot 3, and the support unit 4 located at the storage position can be prevented from dropping from the slot 3 even if a vibration acts on it due to, for example, movement of the liquid supply apparatus 1. The handle 45 is always biased, by an elastic member 421, to the side of the engaging position (the position in a state ST051 shown in FIG. 5) where the engaging portion 48 engages with the engaging portion 39. The elastic member 421 is, for example, a coil spring. When the user grasps the handle 45 and rotates it in a direction indicated by an arrow in a state ST052 in FIG. 5, the engaging portion 48 and the engaging portion 39 are disengaged, and the support unit 4 inserted into the slot 3 can be extracted from the slot 3.

To prevent the support unit 4 attached to the slot 3 from being accidentally extracted, the lock mechanism 46 that locks the support unit 4 at the storage position is provided for each slot 3. The lock mechanism 46 includes a slide member 461 incorporated in the front end portion 42. To allow the user to operate the slide member 461, an operation portion 461a that is a part thereof is exposed from the front end portion 42. The slide member 461 is provided to be movable in the direction of an arrow d2 (X direction) between a lock position where rotation of the handle 45 in the direction d1 is regulated and an unlock position where rotation of the handle 45 is permitted.

The state ST051 in FIG. 5 and a state ST061 in FIG. 6 indicate a state in which the slide member 461 is located at the lock position. That is, the lock mechanism 46 in a locked state. The slide member 461 includes an abutment portion 461b, and the abutment portion 461b abuts against an abutment portion 451 provided like a rib in the handle 45. In the state ST051 shown in FIG. 5 and the state ST061 shown in FIG. 6, the slide member 461 is an obstacle that impedes rotation of the handle 45 in the disengaging direction. It is therefore impossible to extract the support unit 4 from the slot 3.

A state ST062 in FIG. 6 indicates a state in which the slide member 461 is located at the unlock position. That is, the lock mechanism 46 is in an unlocked state. The notch portion of the abutment portion 461b and the abutment portion 451 are located at positions where they face each other. At this time, as indicated by a state ST063 in FIG. 6, since the abutment portion 451 can escape to the notch portion of the abutment portion 461b, the handle 45 can be rotated in the disengaging direction, as indicated by a state ST052 in FIG. 5. When the user slides the slide member 461 to the unlock position and then operates the handle 45, the support unit 4 can be extracted from the slot 3.

The slot 3 is provided with a sensor 38 that detects the position of the slide member 461. The sensor 38 is, for example, an optical sensor (for example, a photo interrupter) capable of detecting a detection piece 461c of the slide member 461. If the slide member 461 is located at the lock position, the detection piece 461c is located at the detection position of the sensor 38, as shown in FIG. 4, and is detected by the sensor 38. If the slide member 461 is located at the unlock position, the detection piece 461c is not located at the detection position of the sensor 38 and is not detected by the sensor 38. Thus, based on the detection result of the sensor 38, it can be determined whether the position of the slide member 461 is the lock position or the unlock position, that is, whether the lock mechanism 46 is in the locked state or the unlocked state.

Opening/closing of the passage valve 52 can be synchronized with the detection result of the sensor 38. For example, if the sensor 38 detects that the position of the slide member 461 is the unlock position in a case where the passage valve 52 is in an open state, the passage valve 52 is immediately closed in synchronism with the detection. This can prevent the support unit 4 from being extracted from the slot 3 in a state in which the passage valve 52 is open. If the support unit 4 is extracted from the slot 3 in the state in which the passage valve 52 is open, air may enter from the path forming member 5 into the tube 51. This causes sticking of the liquid in the tube 51 or a discharge failure in the discharge head 108. If it is detected that the position of the slide member 461 is the unlock position, the passage valve 52 is immediately closed by automatic control in synchronism with the detection, thereby preventing air from entering the tube 51.

### (Tilt of Slot)

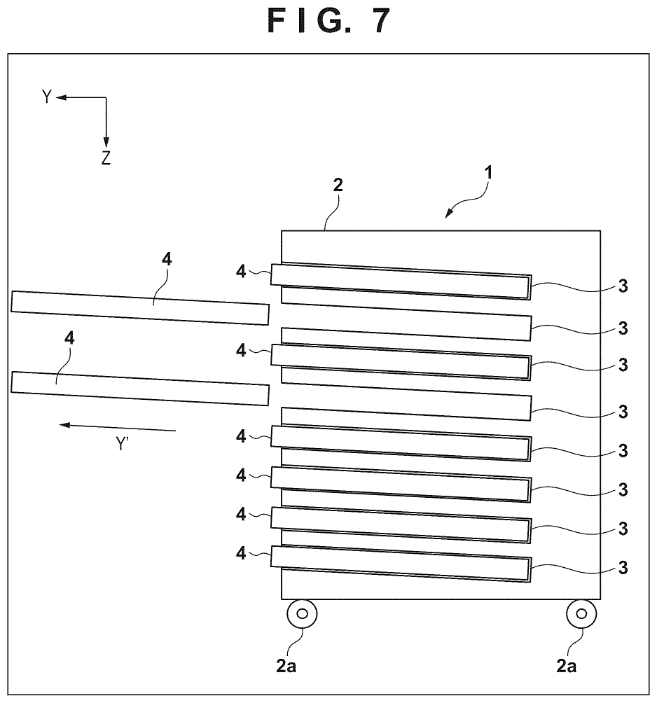

FIG. 7 is a view showing the attachment posture and the insertion/removal mode of the support unit 4 to the slot 3.

As shown in FIG. 7, the slot 3 of each stage provided in the liquid supply apparatus 1 is tilted and lowered to the lower (+Z) side toward the rear side (far side or −Y side). Hence, in the attached state, the support unit 4 is held in a tilting posture, and in the container 200, the end portion 200a is located on the lower side of the end portion 200b in the gravity direction (Z direction). The effect will be described later. The tilt angle is, for example, smaller than 45° with respect to the horizontal plane and particularly 10° or less. In the example shown in FIG. 7, the tilt angle is assumed to be 3°.

### (Liquid Stirring Mechanism)

Various kinds of liquids can be stored in the container 200 and used for image printing, maintenance of the discharge head 108, or the like. For example, an aqueous ink, a latex ink, or a solvent-based ink such as eco-solvent can be contained in the container 200. Depending on the type of ink, the color material (pigment component or the like) in ink may sediment along with the elapse of time. The particle size of a color material or the type and amount of an additive may change between ink colors, and the sedimentation speed may change depending on the ink color. Also, a reaction liquid that is discharged from the discharge head 108 and reacts with ink to fix the ink on the surface of the print medium M can also be stored in the container 200. For the container 200 storing a liquid having a characteristic that its components are separated, the stored liquid is appropriately stirred, thereby improving evenness. This contributes to, for example, preventing lowering of quality of a printed image.

In this embodiment, the container portion 202 of the container 200 is physically pressed from the outside to change (deform) its posture. The stored liquid is thus flowed in the container portion 202 and stirred. Depending on the liquid stored in the container 200, it need not be stirred. In this embodiment, the slots 3 having a stirring function and the slots 3 without the stirring function are provided. More specifically, the slots 3 at the upper stages do not have the stirring function, and the slots 3 at the middle to lower stages have the stirring function. All slots 3 may have the stirring function, as a matter of course.

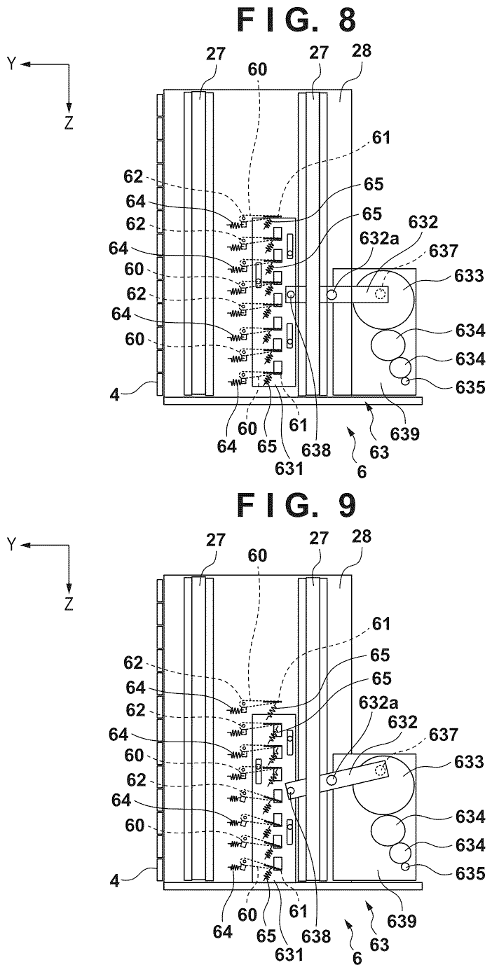

The configuration of a driving unit 6 that implements the stirring function will be described with reference to FIGS. 3, 8, and 9. FIGS. 8 and 9 are explanatory views of operation of the driving unit 6 when the main body 2 is viewed from sideward. The driving unit 6 includes a plurality of pressing members 60, and a moving mechanism 63 common to the plurality of pressing members 60. The pressing member 60 is provided for each slot 3. The pressing member 60 is arranged at a position facing the support unit 4 attached to the slot 3 and the container 200 supported by the support unit 4. When the moving mechanism 63 synchronously rotates each pressing member 60 about a rotation shaft 62, a pressing portion 61 provided on the pressing member 60 presses the container 200 from above and relaxes the pressing. FIG. 8 shows a state in which the pressing portion 61 (and the pressing member 60) are located at a pressing relaxing position, and FIG. 9 shows a state in which the pressing portion 61 (and the pressing member 60) are located at a pressing position.

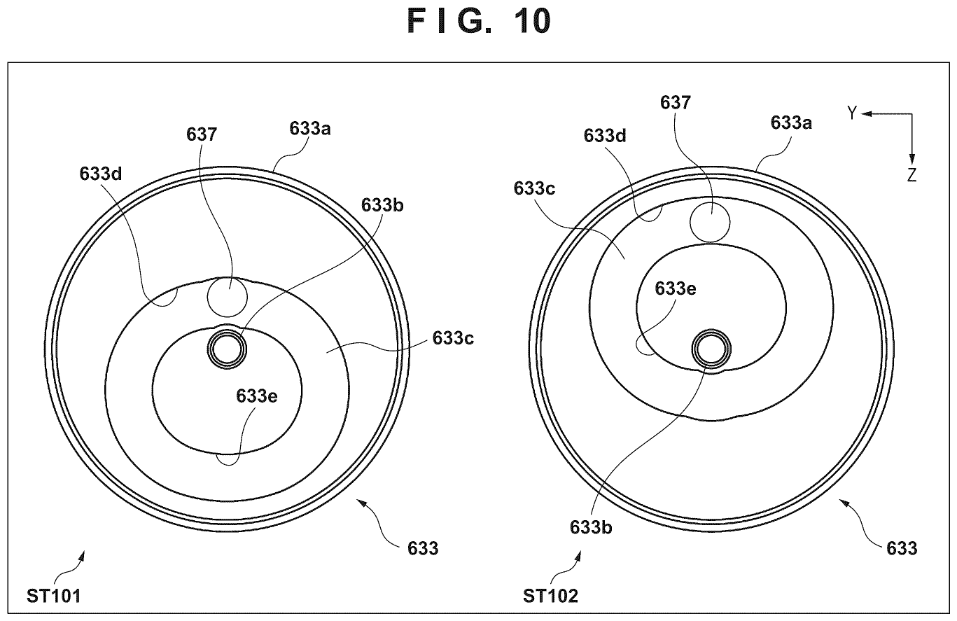

The configuration of the moving mechanism 63 will be described. The output of a motor 635 that is the driving source of the moving mechanism 63 is transmitted to a cam 633 via a plurality of gears 634. Note the rotation shaft of each component is in the X direction. The configuration of the cam 633 will be described here with reference to FIG. 10. FIG. 10 is an explanatory view of the cam 633, and a state ST101 shown in FIG. 10 indicates a state in which the cam 633 has rotated by 180° from a state ST102 in FIG. 10.

The cam 633 is a disc-shaped member that can rotate about a shaft 633b in the X direction, and a gear tooth portion 633a is formed on the outer peripheral surface. The gear tooth portion 633a meshes with the gear 634, and the cam 633 rotates when the gear 634 rotates. A groove 633c is formed in the side surface of the cam 633, and the outer and inner side surfaces of the groove 633c form an outer cam surface 633d and an inner cam surface 633e, respectively. In the groove 633c, a cam follower 637 connected to a driving transmission lever 632 is arranged. The inner cam surface 633e is located on the inner side of the cam follower 637 in the radial direction of the cam 633, and when the cam 633 rotates, the inner cam surface 633e comes into contact with the cam follower 637 and acts to move the cam follower 637 upward. Also, the outer cam surface 633d is located on the outer side of the cam follower 637 in the radial direction of the cam 633, and when the cam 633 rotates, the outer cam surface 633d comes into contact with the cam follower 637 and acts to move the cam follower 637 downward.

FIGS. 3, 8, and 9 will be referred to again.

When the cam follower 637 moves up/down in accordance with the rotation of the cam 633, the driving transmission lever 632 rotates about a rotation shaft 632a. Since the driving transmission lever 632 is rotatably connected to a shaft portion 638 provided on an elevating member 631, the operation of the driving transmission lever 632 is converted into the elevating operation of the elevating member 631. When the cam 633 rotates by one revolution, the cam follower 637 performs a reciprocating operation once in the Z direction, and therefore, the elevating member 631 similarly performs a reciprocating elevating operation once via the driving transmission lever 632.

The elevating member 631 having a plate shape is attached to a side plate 28 of the main body 2 such that it can move up/down in the Z direction. In addition, two, front and rear columns 27 each having a U-shaped section and extending in the Z direction are fixed on the side plate 28. The columns 27 are attached to the side plate on the −X side as well, and the main body 2 ensures its strength as a structure by the total of four columns 27. The weight of a number of containers 200 can thus be supported.

The column 27 has a high strength and a thickness. Hence, if the moving mechanism 63 is provided outside in the X direction with respect to the columns 27 attached to the side plate 28, the size in the X direction becomes large. Hence, in this embodiment, the elevating member 631 and the driving mechanism of the cam 633 and the like are distributed to the front and rear sides of one of the columns 27 in the Y direction. The driving transmission lever 632 is inserted into a through hole 27a formed in the one column 27.

This makes it possible to suppress an increase of the size of the main body 2 in the X direction and arrange the moving mechanism 63 of the driving unit 6 while ensuring the strength. Furthermore, the driving transmission lever 632 is attached to a plate-shaped support member 639 that supports the moving mechanism 63. By detaching fixing elements such as fastening screws, most components of the moving mechanism 63 can be detached to the rear surface side of the main body 2 as an integrated unit together with the support member 639. Hence, parts exchange by a service man can easily be performed. Note that fastening and unfastening of the fixing elements such as fastening screws can easily be done by fastening these from the rear surface side of the main body 2.

Biasing forces of two springs 64 and 65 act on each pressing member 60. The spring 64 has one end attached to the pressing member 60 and the other end attached to the slot 3 (case 30). Also, the spring 65 has one end attached to the pressing member 60 and the other end attached to the elevating member 631. The pressing member 60 is a movable member (particularly a rotating member) that is attached to the slot 3 (case 30) such that it can rotate about the rotation shaft 62 as the rotation center. The rotation shaft 62 is a shaft in a direction crossing the moving direction (Z direction) of the pressing portion 61. Both the two springs 64 and 65 bias the pressing member 60 in a direction to rotate it clockwise in FIGS. 8 and 9.

When the pressing member 60 is at the pressing relaxing position (FIG. 8), the elevating member 631 contacts the pressing member 60 and raises itself. Hence, the biasing force of the spring 65 acts between the elevating member 631 and the pressing member 60. For this reason, the biasing force of the spring 65 acts only between the elevating member 631 and the pressing member 60 and does not serve as a load for the motor 635. That is, the load applied to the moving mechanism 63 at the pressing relaxing position includes only the biasing force of the spring 64 and the weights of the components.

Also, when the pressing member 60 is at the pressing position (FIG. 9), the cam 633 has a phase 180° opposite to that at the pressing relaxing position, and the pressing portion 61 of the pressing member 60 contacts the container 200 and presses it downward. The pressing distance of the pressing portion 61, that is, the rotation amount of the pressing member 60 changes depending on the remaining amount in the container 200. In FIG. 9, the pressing members 60 at the four upper stages indicate a mode in which the containers 200 that are full of liquid are pressed. The pressing members 60 at the four lower stages indicate a mode in which the containers 200 that are deflated because of very little remaining amount are pressed. The biasing forces of both the springs 64 and 65 and the weights of the components act on the container 200. Since the springs 64 and 65 are arranged in each slot 3, even if the remaining amounts in the containers 200 of the slots 3 are different, an optimum pressing force can be applied to each container 200.

At this time, the biasing force of the spring 64 acts on the container 200 but not on the elevating member 631. The biasing force of the spring 65 acts between the container 200 and the elevating member 631 which are in contact with the pressing member 60. The cam 633 acts to move the elevating member 631 downward to the lower side of the container 200. Thus, using the two springs 64 and 65 at different attachment positions and the cam 633 capable of moving both upward and downward, the load applied to the moving mechanism 63 at the time of operation is reduced.

Note that at the pressing position, since the extensions of the springs 64 and 65 are smaller when the container 200 is deflated because of a small remaining amount, the pressing force acting on the container 200 is also small. If the remaining amount in the container 200 is large, the reaction force from the container 200 is readily received at the time of pressing, and a larger pressing force is needed to deeply push in. Conversely, if the remaining amount is small, the reaction force from the container 200 is small. For this reason, even if the pressing force is small, it is possible to deform the container 200 and easily move the liquid inside. In other words, the push-in amount (pressing amount) of the pressing member 60 to push in the container 200 changes in accordance with the remaining amount of the liquid in the container 200. For this reason, the springs 64 and 65 are arranged at positions where the pressing force decreases along with the deflation of the container 200. Hence, the biasing forces of the springs need not be more than is necessary. In this embodiment, the load applied to the pressing portion 61 is adjusted to, for example, about 500 gf when the container 200 is full of liquid or about 300 gf when the remaining amount is little.

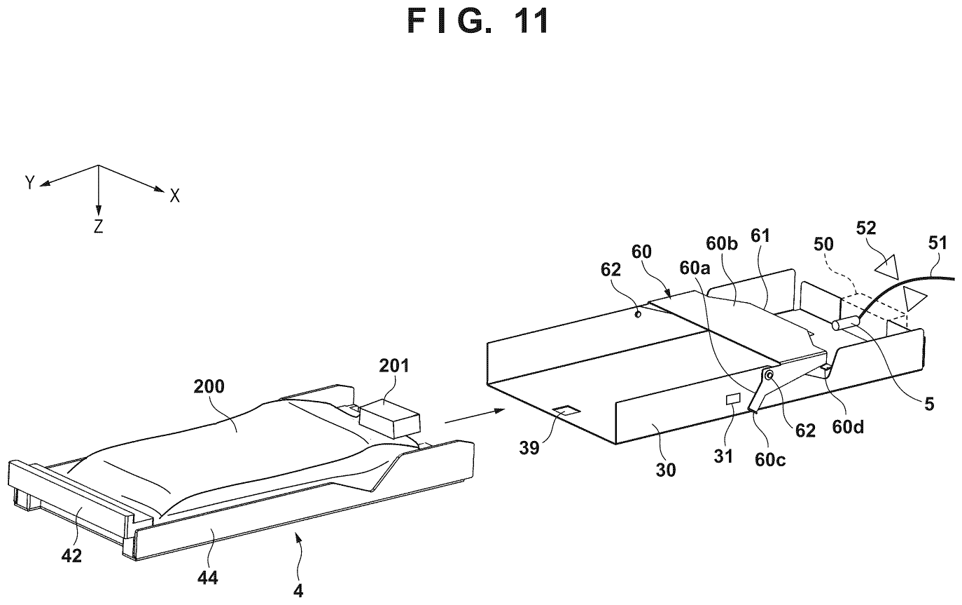

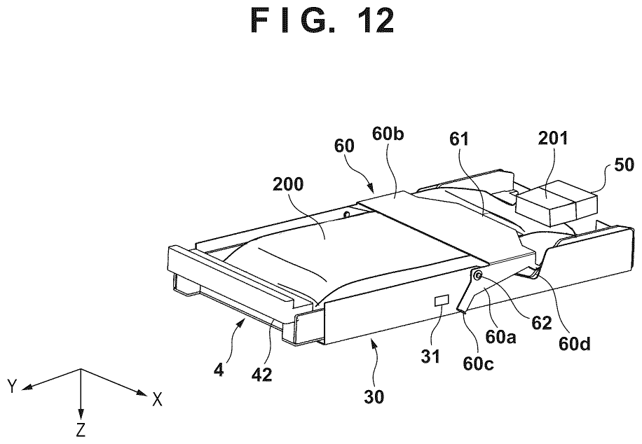

The configuration of the pressing member 60 will be described with reference to FIGS. 11 and 12. FIG. 11 is a perspective view of the case with a stirring function and the support unit in a separated state. FIG. 12 is a perspective view of the case with a stirring function and the support unit in an attached state.

The pressing member 60 includes a pair of side plates 60a located on the side portions of the case 30 in the X direction, and a top plate 60b straddling the case 30 in the X direction and connected between the pair of side plates 60a. On each side plate 60a, the pressing member 60 is rotatably supported by the case 30 via the rotation shaft 62, and the pressing portion 61 is formed at the distal end of the top plate 60b.

A lock portion 60c on which an end portion of the spring 64 is locked, and an abutment portion 60d on which an end portion of the spring 65 is locked and which abuts against the elevating member 631 at the time of rising of the elevating member 631 and causes rotation of the pressing member 60 are formed on each side plate 60a. Both the lock portion 60c and the abutment portion 60d are formed in a form of a projecting piece projecting in the X direction.

A remaining amount detection sensor 31 is provided on a side portion of the case 30. The remaining amount detection sensor 31 is, for example, an optical sensor. The remaining amount detection sensor 31 is a position detection sensor that detects the side plate 60a and thus detects the position of the pressing portion 61, and is also a sensor that detects the remaining amount in the container 200 based on the position detection result. More specifically, as for the detection position of the remaining amount detection sensor 31, it is arranged at a position to detect the side plate 60a when the container 200 deflated because of the decrease of the remaining amount is pressed. This uses the fact that the push-in amount at the time of pressing changes depending on the degree of deflation of the container 200. In this embodiment, since the pressing portion 61 is brought into contact with the container 200, the position of the side plate 60a reflects the remaining amount in the container 200, and therefore, the accuracy of remaining amount detection is high. The detection position of the remaining amount detection sensor 31 is designed such that, for example, the side plate 60a is detected when the container 200 whose remaining amount is about 100 ml is pressed.

The pressing member 60 can be formed by, for example, a plate material made of a metal (steel plate, or the like). As compared to a member of a resin or the like, since the strength is high even if it is thin, the height of the slots 3 can be suppressed. The rotation shaft 62 of the pressing member 60 is arranged on the outer side of the container 200 in the X direction, and is provided at a position where the rotation shaft 62 and the container 200 overlap in the X direction when the container 200 is full of liquid. With these contrivances to suppress the size in the Z direction, even if the pressing member 60 is installed in the slot 3 of each stage to impart the stirring function, the containers 200 of multiple stages can be stored in a limited space under the housing of the system 100.

Also, the width of the pressing member 60 in the X direction is smaller at the pressing portion 61 than near the rotation shaft 62. Thus, if the pressing portion 61 presses a tank, it is possible to prevent portions other than the pressing portion 61 from contacting the container 200 and prevent the container 200 from being damaged.

When the width of the pressing member 60 in the X direction is made smaller at the pressing portion 61 than near the rotation shaft 62, the following advantage can be obtained. As described above, the gusset portions 202a are provided on the side surfaces of the container 200. The gusset portion 202a includes a welded portion between flexible members, and has higher rigidity than the other portions. To deflate the container 200 by folding the gusset portions 202a inside in accordance with a decrease of the remaining amount, an adequate pressing force is needed. In a state in which the remaining amount in the container 200 is large, the gusset portions 202a are expanded in the upward-downward direction, and the gusset portions 202a are sometimes expanded not inside but outside. To squeeze the gusset portions 202a, an adequate pressing force is needed.

When the pressing portion 61 is arranged inside the gusset portions 202a in the X direction, it is possible to efficiently press and deform the container 200 for stirring. That is, the pressing portion 61 is arranged to press the center side of the container 200 with respect to the gusset portions 202a. The height of the gusset portions 202a is, for example, about 20 mm on both side surfaces. When the pressing portion 61 is located inside the gusset portions 202a on both side surfaces, it hardly receives the reaction force of the gusset portions 202a and can efficiently press the container 200. The pressing efficiency can further be improved by designing the width of the pressing portion 61 in the X direction such that it is fitted, for example, 10 mm or more inside from the gusset portions 202a. This is because when the pressing portion 61 is apart from the gusset portions 202a in the X direction, the influence of the reaction force of the gusset portions 202a is smaller. Note that the width of the pressing portion 61 in the X direction is preferably designed apart from the gusset portions 202a by at least 1 mm, and may be designed apart by, for example, 5 mm or 10 mm.

As a form for minimizing the width of the pressing portion 61 in the X direction, for example, the pressing portion 61 may be in point contact with the container 200. However, in a case where the container 200 is long in the Y direction, as in this embodiment, if the pressing portion 61 is in point contact with the container 200, the fluidity of the liquid in the container 200 may lower. More specifically, if the width of the pressing portion 61 in the X direction is too small, the flow of the liquid corresponding to the push-in amount of the pressed container 200 is dispersed even outside in the X direction, the flow amount of the liquid in the Y direction decreases.

Hence, for example, if the width of the pressing portion 61 in the X direction is set to ⅓ or more the width of the container portion 202 of the container 200 in the X direction, the fluidity of the liquid in the Y direction can be improved in the container portion 202 at the time of pressing. For example, if the width of the container portion 202 in the X direction is 180 mm, the width of the pressing portion 61 in the X direction is set to 60 mm or more, thereby improving the fluidity of the liquid in the Y direction in the container portion 202 at the time of pressing.

To summarize, if the width of the container portion 202 in the X direction is 180 mm, and the height of the gusset portions 202a is 20 mm, the width of the pressing portion 61 in the X direction is preferably 60 mm to 120 mm and may be particularly 90 mm.

### (Stirring Operation)

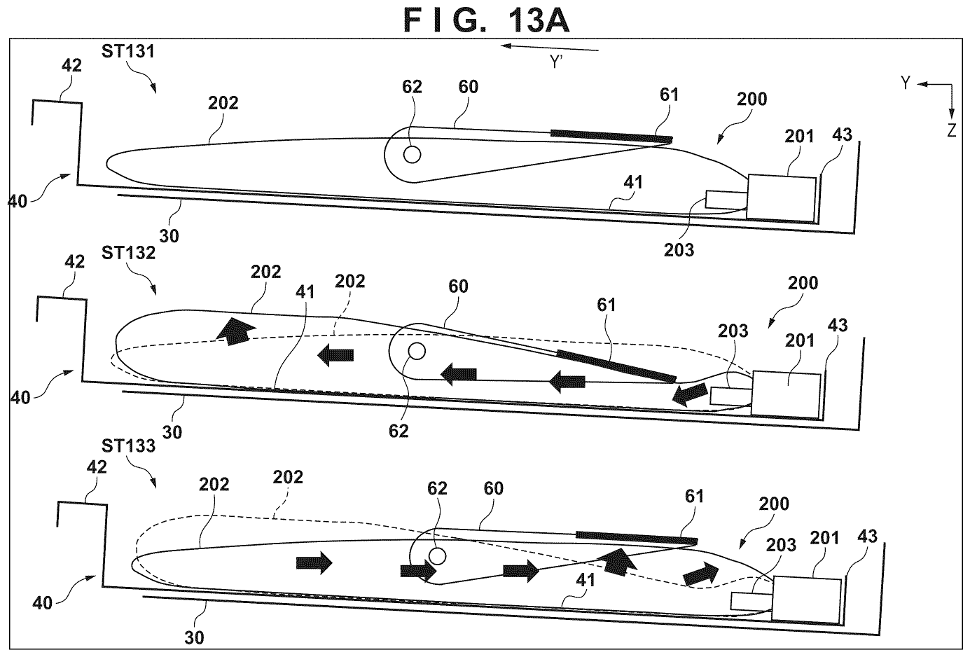

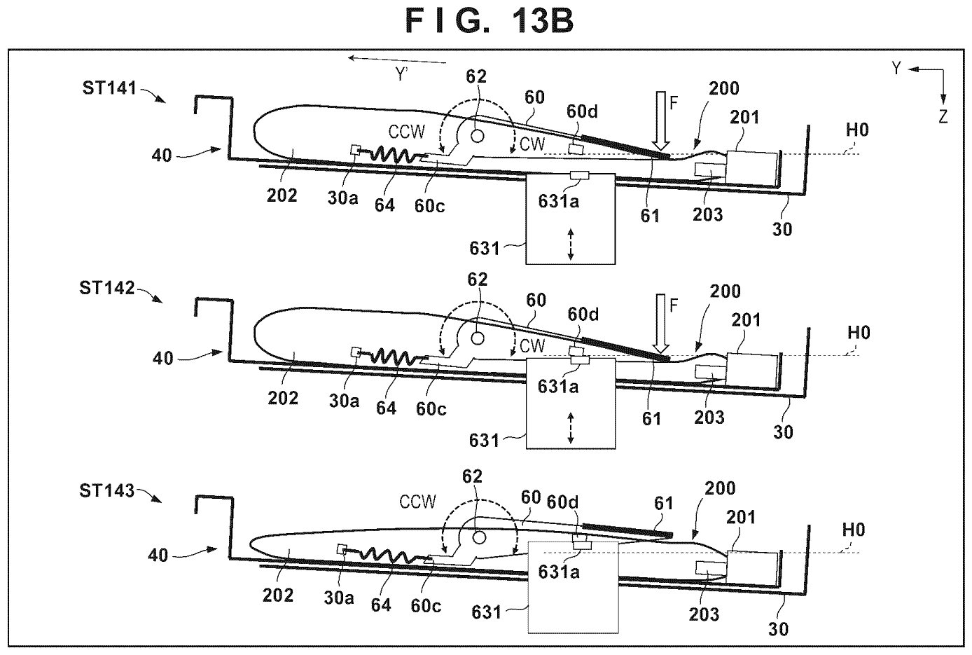

The stirring operation of the liquid in the container 200 by pressing the pressing portion 61 against the container 200 will be described with reference to FIG. 13A. FIG. 13A is an explanatory view of the stirring operation. As shown in FIG. 7, the attachment posture of the support unit 4 is tilted in this embodiment. In FIG. 13A, a direction parallel to the tilt angle direction of the attachment posture is defined as a Y′ direction. In the following explanation, the side of the connecting portion 201 of the container 200 will sometimes be referred to as a −Y′ direction, and the opposite side will sometimes be referred to as a +Y′ direction. Note that arrows in FIG. 13A indicate the direction of liquid flow that occurs in the container portion 202 of the container 200.

In this embodiment, the stirring operation includes a pressing operation and a pressing relaxing operation. The pressing portion 61 is arranged facing the placement surface 41 of the support unit 4. The pressing portion 61 is reciprocally moved between the pressing relaxing position and the pressing position. Thus, the posture of the container portion 202 is changed to cause the flow of the liquid inside and stir it.

A state ST131 in FIG. 13A indicates a state in which the pressing portion 61 (and the pressing member 60) is at the pressing relaxing position. In this embodiment, at the pressing relaxing position, the pressing portion 61 is apart from the placement surface 41 and is located at a height not to contact the container portion 202, and does not press the container portion 202. Hence, it can also be said that the pressing relaxing position is a pressing release position.

The moving mechanism 63 is driven from the state ST131 in FIG. 13A, and the pressing operation is performed, as indicated by a state ST132 in FIG. 13A. In the pressing operation, the pressing member 60 rotates, the pressing portion 61 moves to a position where it is closer to the placement surface 41 than at the pressing relaxing position, and the pressing portion 61 presses the container portion 202 to the side of the placement surface 41. Thus, the posture of the container portion 202 changes such that it is partially recessed, and the liquid inside is flowed to the side of the end portion 200b and stirred.

In this embodiment, the container 200 is attached in a tilting posture to the slot 3 while directing the connecting portion 201 to the lower side in the Z direction. Hence, at the stage of the state ST131 in FIG. 13A, the liquid in the container 200 is readily distributed while being localized on the side of the connecting portion 201 by its own weight, and the container portion 202 expands more on the side of the connecting portion 201 than at the center portion in the Y′ direction. The pressing portion 61 is designed to press the side of the end portion 43 provided with the connecting portion 201 out of the end portions 42 and 43 of the container 200. Since the pressing portion 61 presses the expanded portion of the container portion 202 or a portion close to it, the flow of the liquid in the container portion 202 can be promoted. The portion that the pressing portion 61 presses may be the most expanded portion of the container portion 202.

Note that if the tilt angle is too large, the localization of the liquid in the container 200 is large, and the reaction force by the weight of the gathered liquid increases. As a result, when pressing by the pressing member 60, the load applied to the pressing member 60 increases. For this reason, as described above, the tilt angle is preferably set to less than 45° and particularly preferably 10° or less. The tilt angle in this embodiment is set to 3°. The tilt angle may be set in accordance with the liquid amount that can be contained in the container 200. For example, if the liquid amount is small, the tilt angle may be set larger than a case where the liquid amount is large.

Since the pressing portion 61 presses the container portion 202 on the side of the connecting portion 201, stirring can effectively be performed when the liquid flows to the opposite side. The rotation shaft 62 of the pressing member 60 is located on the opposite side of the connecting portion 201 in the Y′ direction of the container 200 when viewed from the pressing portion 61. In the pressing operation, the rotation direction of the pressing member 60 is the clockwise direction in the state ST132 shown in FIG. 13A. That is, the pressing member 60 rotates clockwise about the rotation shaft 62 as the rotation center. When the rotation direction is thus set, a vector in the +Y′ direction is generated, and the liquid can readily be flowed in the +Y′ direction. That is, the liquid readily flows, in the container portion 202, to the opposite side of the connecting portion 201.

As described above, in this embodiment, the pressing portion 61 is designed to press the side of the end portion 43 provided with the connecting portion 201 out of the end portions 42 and 43 of the container 200. A portion of the container portion 202 near the intake port 203 of the container 200 is pressed, and stirring of the liquid around there is particularly promoted. In printing, the liquid in the container 200 flows out from a region close to the intake port 203 to the tube 51. By pressing the portion near the intake port 203 and stirring the liquid, the liquid whose concentration is more even can be sent to the tube 51.

The moving mechanism 63 is driven from the state ST132 in FIG. 13A, and the pressing relaxing operation is performed, as indicated by a state ST133 in FIG. 13A. In the pressing relaxing operation, the pressing member 60 rotates, and the pressing portion 61 returns from the pressing position to the pressing relaxing position. The pressing member 60 rotates counterclockwise about the rotation shaft 62 as the rotation center in the state ST133 in FIG. 13A. That is, when transiting from the state ST132 in FIG. 13A to the state ST133 in FIG. 13A, the pressing member 60 reverses the rotation direction. When pressing by the pressing member 60 is relaxed, the container portion 202 is going to restore its original shape while the liquid in the container portion 202 flows. That is, the pressing relaxing operation is an operation of returning the posture of the container portion 202 changed by the pressing operation to the original posture. The posture need not be completely the same as the original posture, as a matter of course. After that, the pressing operation can be performed again.

The pressing operation and the pressing relaxing operation are repetitively performed, thereby stirring the liquid in the container portion 202. That is, when the pressing portion 61 is at the pressing position, as indicated by the state ST132 in FIG. 13A, the portion of the container 200 near the pressing portion 61 is recessed, the liquid flows in the +Y′ direction, and the opposite side of the connecting portion 201 of the container 200 is expanded. After that, when pressing is relaxed, as in the state ST133 shown in FIG. 13A, the ink flowed by the pressing flows in the −Y′ direction by the weight of its own. By repeating the pressing operation and the pressing relaxing operation, the liquid is reciprocally moved in the Y′ direction in the container portion 202 and stirred. The flow of the liquid caused by the pressing relaxing operation uses the weight of the liquid. When the weight of the liquid is used, the mechanism necessary for stirring the liquid can have a simple configuration.

Note that during the series of pressing operations shown in FIG. 13A, the passage valve 52 can be either in the open state or the closed state. That is, control is performed such that the passage valve 52 is in the open state in a path where supply of the liquid to the discharge head 108 is performed, and the passage valve 52 is in the closed state in a path where supply of the liquid to the discharge head 108 is not performed. Hence, during the series of pressing operations shown in FIG. 13A, a printing operation by the discharge head 108 can be performed concurrently.

The operations of the pressing member 60 and the moving mechanism 63 in the series of pressing operations shown in FIG. 13A will be described with reference to FIG. 13B. The pressing member 60 rotates about the rotation shaft 62, and the pressing portion 61 is set in the pressing state by rotation in the CW direction and set in the pressing relaxing state by rotation in the CCW direction.

The action of the spring 64 will be described. The lock portion 60c is formed on the pressing member 60, and a lock portion 30a is formed on the case 30. The spring 64 is provided between the lock portions 60c and 30a. By the tensile force of the spring 64, the pressing member 60 is biased to rotate in the CW direction, and the pressing portion 61 is set in the pressing state.

The elevating member 631 is provided with an abutment portion 631a. As indicated by a state ST142 in FIG. 13B, when the elevating member 631 moves upward, the abutment portion 631a of the elevating member 631 abuts against the abutment portion 60d of the pressing member 60. This position is defined as an abutment reference height HO. As indicated by a state ST143 in FIG. 13B, when the elevating member 631 further moves upward, the pressing member 60 rotates about the rotation shaft 62 in the CCW direction, and the pressing portion 61 is set in the pressing relaxing state.

Conversely, when the elevating member 631 moves downward, the abutment portion 631a of the elevating member 631 is separated from the abutment portion 60d of the pressing member 60. By the tensile force of the spring 64, the pressing member 60 is biased to rotate in the CW direction, and the pressing portion 61 is set in the pressing state again. In this way, the pressing member 60 rotates between the pressing position and the pressing relaxing position by the elevating motion of the elevating member 631.

In a state ST141 shown in FIG. 13B, rotation of the pressing member 60 stops at a position where a pressing load F of the pressing portion 61 by the spring 64 balances the reaction force of the container 200. For this reason, if the remaining amount of the liquid in the container 200 decreases, the position (pressing position) where the forces balance lowers accordingly. Since the pressing height of the pressing member 60 changes depending on the remaining amount of the liquid in the container 200, it is possible to press the container 200 and stir the liquid, following the remaining amount of the liquid in the container 200.

Next, when repeating the stirring operation, liquid stirring performance can be adjusted by the period. In the pressing relaxing operation, the liquid in the container portion 202 flows a little later after the rotation of the pressing member 60. In the pressing relaxing operation, the higher the fluidity of the liquid is, the higher the stirring effect is. Also, if the pressing operation is performed after the liquid sufficiently flows, the liquid storage amount of the container portion 202 becomes large near the pressing portion 61, and the container portion 202 expands. Hence, by pressing there, the stirring performance can further be improved. The frequency of the stirring operation is, for example, a frequency lower than several Hz and, particularly, a frequency lower than 1 Hz. If the frequency of the stirring operation is too low, that is, the period is too long, the total time of the stirring operation increases, and the power consumption of the motor 635 may increase. Hence, the frequency of the stirring operation may be set in the range of, for example, 0.5 to 0.7 Hz and, particularly, to 0.6 Hz.

In addition, when the remaining amount decreases, and the container 200 is deflated, the ink on the upper side (+Y′ side) of the tilting container 200 flows by the weight of its own to the −Y′ side, and the storage amount in this portion decreases. To the contrary, the liquid stays on the lower side (−Y′ side). In this state, the flow distance of the liquid in the +Y′ direction at the time of the pressing operation is short, and the time of return of the liquid in the pressing relaxing operation is also short. Hence, the period of the stirring operation may be shortened in accordance with the decrease of the remaining amount in the container 200.

In the stirring operation, the pressing operation and the pressing relaxing operation may be repeated while providing a time interval between the pressing relaxing operation and the next pressing operation. It is possible to ensure a long flow time of the liquid in the container portion 202 from the pressing relaxing operation to the start of the next pressing operation and further promote the flow of the liquid by the weight of its own. For example, when the operation is stopped for 0.1 to 0.5 sec in the state ST132 shown in FIG. 13A and the state ST133 shown in FIG. 13A, it is possible to promote the flow of the liquid and improve the stirring efficiency. The time of stop is appropriately set in accordance with the liquid amount that can be contained in the container portion 202.

There are several methods for adjusting the period of the stirring operation. First, there is a method using a dwell angle that is a range where the cam follower 637 in contact with the inner cam surface 633e or the outer cam surface 633d is not displaced even if the cam 633 rotates. For example, the dwell angle at a position where the cam follower 637 is at the highest point is set to 40°, and the dwell angle at the lowest point is also set to 40°. In particular, when a dwell angle of 40° is ensured at the highest point, the pressing relaxing position can be maintained.

Also, an index angle that is an angle range for raising or lowering the cam follower 637 may largely be set to 140°. As effects, this decreases the load at the time of rotation of the cam 633, and the connected pressing member 60 is slowly transitioned from the pressing state to the pressing relaxing position, thereby ensuring time to move ink to the vicinity of the pressing portion 61. These make it possible to sufficiently move the ink at the time of release of the pressing and enhance the stirring effect.

As another method, the motor 635 is temporarily stopped at the pressing relaxing position. If time corresponding to the dwell angle of 40° is implemented by motor stop, the dwell angle can be made smaller. Hence, the index angle can be made larger, and the load at the time of cam rotation can further be reduced.

As for the timing to execute the stirring operation, it can be executed at any timing during the operation of supplying the liquid to the liquid discharge apparatus 101, during the recovery operation of the discharge head 108 in the liquid discharge apparatus 101, during standby of the printing operation, and the like.

The stirring period to repetitively perform the stirring operation may be set based on time or based on the operation count. For example, several tens of minutes may be defined as one set, and the stirring operation may repetitively be performed only one set a day. Alternatively, for example, several tens of times may be defined as one set, and the stirring operation may repetitively be performed only one set a day. The necessary stirring period or execution timing may be set in consideration of the sedimentation speed of the color material in the liquid.

Referring to FIG. 7, the container 200 and the support unit 4 are attached to the slot 3, and these are tilted with respect to the horizontal plane, as described above. From the viewpoint of the liquid stirring effect, it is advantageous that the tilt angle is smaller than 45°, and it is more advantageous that the tilt angle is, for example, smaller than 20°, particularly, 100 or less. In the example shown in FIG. 7, the tilt angle is assumed to be 30.

Stirring by pressing is possible even if the tilt angle is close to 90°, but the weight of the ink acts in the direction of resisting the flow of the liquid by pressing. Hence, a larger pressing force is needed to make the liquid sufficiently flow. If the tilt angle is less than 45°, the vector of the flow of the liquid toward the −Y direction is relatively small because of the weight of the liquid. As for the expansion amount of the portion of the container portion 202 on the −Y side at the time of pressing operation, if the tilt angle is 10° or less, a large expansion amount can be obtained by a smaller pressing force. If the expansion amount of the container portion 202 at the time of pressing is large, the flow amount of the liquid inside is large. That is, the efficiency of pressing is high.

Note that in this embodiment, at the pressing relaxing position, the pressing portion 61 is located at a height at which it does not contact the container portion 202. However, the pressing portion 61 may contact the container portion 202, and the pressing portion 61 may be located at a position to press the container portion 202 with a pressing amount smaller than that at the pressing position. In such a slightly pushed-in state at the pressing relaxing position, the upper limit position of the pressing member 60 in the Z direction can be lowered, and the size of the liquid discharge apparatus 1 in the Z direction can be reduced.

Also, in this embodiment, the pressing member 60 is provided in the case 30 of the slot 3. However, the pressing member 60 may be provided on the support unit 4. In this case, a configuration that enables driving transmission between the moving mechanism 63 and the pressing member 60 when the support unit 4 is attached to the slot 3 is added.

Additionally, in this embodiment, a configuration in which the container 200 is pressed by the pressing portion 61 has been described. For example, the container 200 may be deformed by repeating application and stoppage of compressed air. Also, the container 200 may be deformed by pressurizing and depressurizing the space around the container 200.

### (Indicator Device)

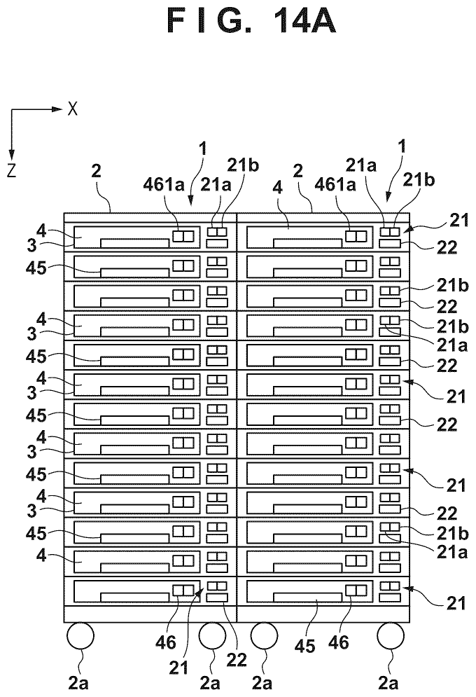

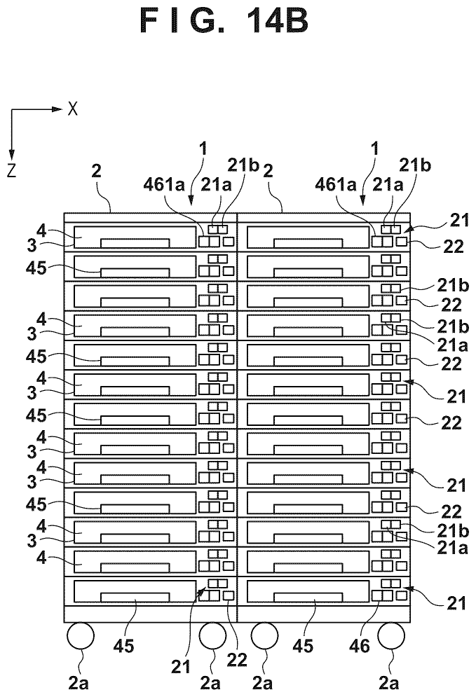

An indicator device provided in the liquid supply apparatus 1 will be described with reference to FIGS. 3 and 14A. FIG. 14A is a front view of the liquid supply apparatus 1. On the main body 2, a state indicator 21 and a type indicator 22 are provided for each slot 3. The state indicator 21 and the type indicator 22 are arranged on the outer wall portion 2b to be adjacent to the opening of the corresponding slot 3. In this embodiment, the state indicator 21 is an electronic indicator and makes a notification concerning the state of the container 200 attached to the corresponding slot 3. More specifically, the state indicator 21 is formed by two light emitting elements 21a and 21b. The light emitting elements 21a and 21b are, for example, LEDs of different light emission colors. The light emitting elements 21a and 21b are independently driven, and the drive mode is switched between light-on, blinking, and light-off. It is possible to notify the user of the state of the corresponding container 200 by combining drive modes (for example, light-on and blinking, light-on and light-off, blinking and light-off, or the like).

The state of the container 200 to be notified to the user is, for example, the remaining amount of the liquid in the container 200. The consumed amount (discharge amount) of the liquid contained in the container 200 can be estimated from the discharge control amount of the discharge head 108. The remaining amount of the liquid in the container 200 is estimated based on the estimated consumed amount, and if the remaining amount is less than a threshold, one of the two light emitting elements 21a and 21b is made to blink. Thus, the user can be notified of the exchange time of the container 200 and promoted to prepare the container 200 that is full of liquid.

The type indicator 22 indicates information concerning the type of the liquid assigned to the corresponding slot 3. The type indicator 22 may be an electronic indicator. In this embodiment, however, it is a nonelectronic indicator and is a plate material or sheet (color label) made of paper or plastic with the color of the liquid. By the type indicator 22, the user can visually understand to which slot 3 the container 200 containing what kind of liquid should be attached.

In this embodiment, the set of the state indicator 21 and the type indicator 22 corresponding to each slot 3 is collectively arranged on a side of the slot 3 in the X direction and, particularly, these are arranged in the Z direction. When the state indicator 21 and the type indicator 22 are arranged such that these overlap in the X direction, the width of the main body 2 in the X direction can be reduced. Also, in this embodiment, the set of the state indicator 21 and the type indicator 22 is arranged on a side of the slot 3 in the +X direction, and the moving mechanism 63 is also arranged on the side portion of the main body 2 in the +X direction, as described above. The moving mechanism 63 is located behind the arrangement space of the set of the state indicator 21 and the type indicator 22. These components are concentrated at the side portion of the main body 2 in the +X direction and made to overlap in the X direction, thereby forming the side portion of the main body 2 in the −X direction so that it is thin. It is possible to implement size reduction of the liquid supply apparatus 1 as a whole.

Furthermore, the operation portion 461a of the lock mechanism 46 is also arranged at an end portion of the support unit 4 in the +X direction. Also, the sensor 38 that detects the position of the slide member 461 is located behind the arrangement space of the set of the state indicator 21 and the type indicator 22. The lock mechanism 46 itself is provided in the support unit 4, and the sensor 38 with a relatively small size is arranged outside the support unit 4 sideward in the +X direction, thereby making the liquid supply apparatus 1 compact. In addition, the components associated with the operation of the user and display to the user are concentrated at one end portion of the front surface of the main body 2 in the +X direction, thereby improving usability.

Note that as an arrangement example of the operation portion 461a, an example shown in FIG. 14B can also be employed. FIGS. 14A and 14B are different mainly in the position of the operation portion 461a, and the operation portion 461a is arranged not on the support unit 4 but on the main body 2. That is, in a state in which the support unit 4 is extracted from the slot 3, the operation portion 461a remains on the side of the main body 2. This can simplify the configuration of the support unit 4.

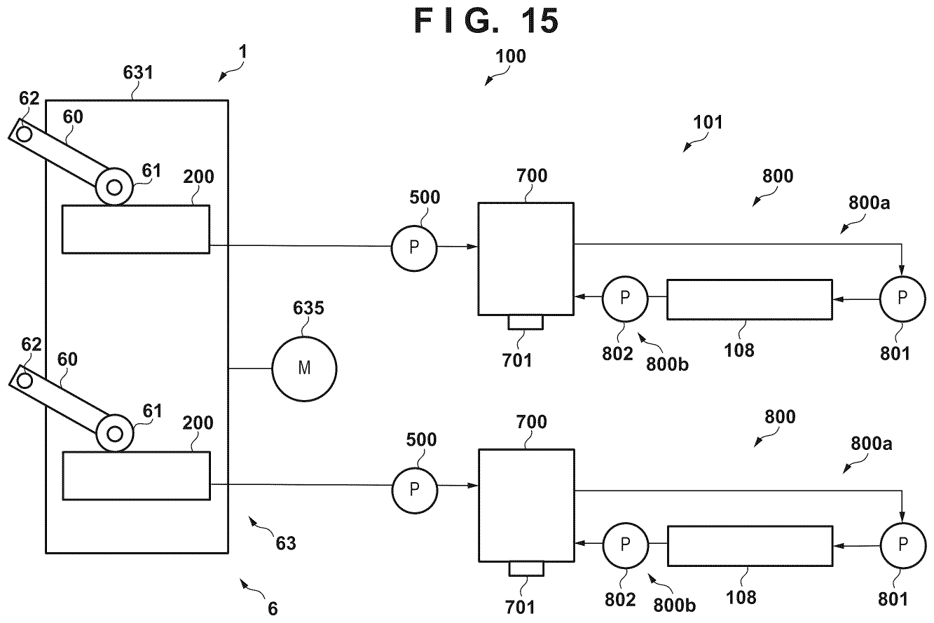

The stirring operation and the supply operation will further be described with reference to FIG. 15. FIG. 15 is a block diagram showing an example of the hardware configuration of each apparatus of the system 100 so as to explain the stirring operation and the supply operation.

The liquid discharge apparatus 101 includes a supply pump 500, a storage portion 700, a sensor 701, and a circulation unit 800. Note that, to simplify the explanation, FIG. 15 shows an example in which the supply pump 500, the storage portion 700, the sensor 701, the circulation unit 800, and the discharge head 108 are provided in the liquid discharge apparatus 101 in correspondence with each of two containers 200. Actually, the above-described components are provided in the liquid discharge apparatus 101 as many as the number of containers 200 stored in the plurality of slots 3 of the liquid discharge apparatus 101.

The supply pump 500 is a pump that performs the supply operation for supplying ink from the container 200 stored in the slot 3 to the discharge head 108. The supply pump 500 is provided between the container 200 and the storage portion 700. The supply pump 500 is connected to the container 200 via the tube 51. Also, the supply pump 500 is connected to the storage portion 700 via a tube. By driving a liquid supply motor 911 to be described later, the supply pump 500 sucks the ink in the container 200 and supplies it to the storage portion 700 which is the supply destination. The remaining amount of the ink in the container 200 is managed by the driving amount of the supply pump 500.

The storage portion 700 is a tank that stores ink to supply it to the discharge head 108. The storage portion 700 stores the ink supplied from the container 200 by the supply pump 500. The sensor 701 detects the remaining amount of the ink stored in the storage portion 700. If the ink is consumed by the discharge head 108 when it discharges the ink in the printing operation or the recovery operation, the ink amount stored in the storage portion 700 decreases. As for the timing to execute the supply operation by the supply pump 500, it is executed when the sensor 701 detects that the remaining amount of the ink stored in the storage portion 700 is a predetermined amount or less.

Note that in this embodiment, the liquid discharge apparatus 101 includes the supply pump 500 and the storage portion 700, but the form is not limited to this. The supply pump 500 and the storage portion 700 may be provided outside the liquid discharge apparatus 101 of the system 100. Alternatively, the supply pump 500 and the storage portion 700 may be provided in the liquid supply apparatus 1.

The circulation unit 800 circulates the ink between the storage portion 700 and the discharge head 108. The circulation unit 800 includes, as ink circulation paths, a supply path 800a that supplies the ink from the storage portion 700 to the discharge head 108, and a recovery path 800b that recovers the ink from the discharge head 108 to the storage portion 700. The circulation unit 800 also includes a supply pump 801 provided in the supply path 800a and configured to supply the ink from the storage portion 700 to the discharge head 108. The circulation unit 800 also includes a recovery pump 802 provided in the recovery path 800b and configured to recover the ink from the discharge head 108 to the storage portion 700.

The stirring operation is performed by the driving unit 6. More specifically, as described above with reference to FIGS. 8 and 9, when the motor 635 is driven, the output of the motor 635 is transmitted to the gear 634, the cam 633, and the like. In FIG. 15, the transmission members such as the gear 634 and the cam 633 are not illustrated. When the motor 635 is driven, the elevating member 631 moves up, and the pressing portion 61 reciprocally moves between the pressing relaxing position and the pressing position. By the stirring operation of the driving unit 6, the ink in the container 200 is stirred. That is, in other words, the driving unit 6 is a stirring unit that performs the stirring operation for the container 200 stored in the slot 3 that is a storage portion such that the ink contained in the container 200 is stirred.

Also, as described above, when the moving mechanism 63 synchronously rotates the pressing members 60 about the rotation shafts 62 as the center of rotation, the pressing portion 61 provided in each pressing member 60 presses the container 200 from above and relaxes the pressing. That is, in this embodiment, the driving unit 6 synchronously performs the stirring operation for the containers 200 stored in the plurality of slots 3 such that the ink stored in each container 200 is stirred.

The stirring operation is necessary when, for example, the container 200 is exchanged. This is because a color material in ink contained in the new container 200 after exchange is sometimes sedimented. The stirring operation by the driving unit 6 is synchronously performed for the plurality of containers 200, as described above. For this reason, if at least one container 200 is exchanged, stirring is performed even for the remaining containers 200 that have not undergone exchange even if the stirring operation is not needed at that timing.

However, in some cases, for example, the supply operation is being performed by the supply pump 500 for the remaining containers 200 that have not undergone exchange. For example, if the stirring operation is synchronously performed for the container 200 that needs the stirring operation and the containers 200 for which the supply operation is being performed, ink supply may be impeded. More specifically, if the stirring operation is performed during the supply operation, the ink contained in the container 200 pulsates. If the ink in the container 200 pulsates, the ink supply amount does not stabilize, and this may impede ink supply. Hence, in this embodiment, in the system 100, the stirring operation and the supply operation are exclusively performed.

As described above, in the system 100, the container 200 sometimes needs the supply operation and the stirring operation simultaneously. In this case, for example, if the supply operation is stopped and the stirring operation is performed, the ink amount in the storage portion 700 is insufficient, and it may be impossible to discharge the ink from the discharge head 108. In this case, an image printing operation on the print medium M cannot be performed until the stirring operation is ended. That is, time needed for the stirring operation may be the wait time for the user. Hence, in the system 100, a contrivance to preferentially execute the supply operation as much as possible is required.

In addition, for example, the stirring operation needs to be executed periodically for the container 200. Even in the container 200 that has undergone the stirring operation once, the color material in the ink may sediment over time after the execution of the stirring operation. However, in some cases, the supply pump 500 is performing the supply operation for the container 200 at the periodical execution timing of the stirring operation. That is, in some cases, the stirring operation is needed even for the container 200 for which the supply operation is being executed. However, in this case, if priority is given to the supply operation, the supply operation may be performed in a state in which the color material of the ink may sediment.

Hence, the system 100 needs a technique for executing one of the supply operation and the stirring operation, which should be given priority, in a case where the supply operation and the stirring operation are simultaneously necessary for the container 200. In this embodiment, in the system 100, if the supply operation and the stirring operation are needed simultaneously, control for executing the operation that should be given priority is performed.

### <Control Circuit>

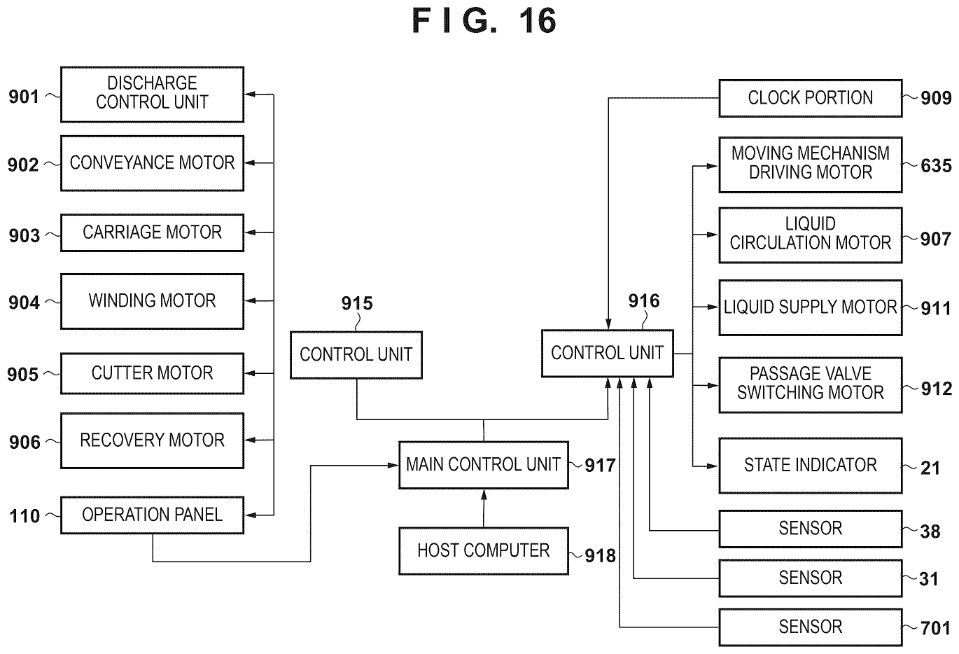

The configuration of the control circuit of the system 100 will be described with reference to FIG. 16. FIG. 16 is a block diagram of the control circuit of the system 100. A main control unit 917 controls the entire system 100 in accordance with an instruction from a host computer 918 or the operation panel 110. A control unit 915 controls the liquid discharge apparatus 101 based on an instruction from the main control unit 917, a control unit 916 controls the liquid supply apparatus 1 based on an instruction from the main control unit 917. The main control unit 917, the control unit 915, and the control unit 916 each include, for example, at least one processor, at least one storage device, and at least one input/output interface. The storage device is, for example, a semiconductor memory such as a RAM or a ROM. The input/output interface inputs/outputs a signal between the processor and an external device (a sensor or a motor).

A discharge control unit 901 controls the discharge head 108, particularly, controls discharge of the liquid. A conveyance motor 902 drives the conveyance unit 106. A carriage motor 903 is the driving source of the moving mechanism of a carriage (not shown). A winding motor 904 is the driving source of the winding unit 105. A cutter motor 905 is the driving source of a cutter (not shown) that cuts the print medium M after image printing. A recovery motor 906 is the driving source of the recovery unit 109. These are controlled by the control unit 915.

A clock portion 909 has a timer function and counts elapsed time. Also, the clock portion 909 outputs the count result of the elapsed time to the control unit 916. If the stirring time is managed by time, the count result of the clock portion 909 can be used. In addition, the stirring timing can be decided using the count result of the clock portion 909. For example, the clock portion 909 resets the remaining time of the timer every time the stirring operation is completed. A timing at which the remaining time of the timer decreases to a predetermined time (a threshold A to be described later) can be decided as the stirring timing.

The sensor 31, the sensor 38, and the sensor 701 detect the remaining amount in the container 200, the position of the slide member 461, and the ink remaining amount in the storage portion 700, respectively, and the detection results are acquired by the control unit 916. A liquid circulation motor 907 is a driving source for circulating ink between the storage portion 700 and the discharge head 108. When the liquid circulation motor 907 drives the supply pump 801 and the recovery pump 802, the ink in the circulation path is circulated. The motor 635 drives the moving mechanism 63, and a passage valve switching motor 913 switches the closed state and the open state of the passage valve 52. The liquid supply motor 911 is a driving source that sends the liquid from the container 200 to the liquid discharge apparatus 101. When the liquid supply motor 911 is driven in the open state of the passage valve 52, the liquid is sucked from the container 200 and supplied to the side of the liquid discharge apparatus 101. That is, when the liquid supply motor 911 drives the supply pump 500, the liquid is supplied from the container 200 to the storage portion 700. These motors are controlled by the control unit 916. Driving of the state indicator 21 is also controlled by the control unit 916.

### (Example of Control Concerning Stirring Operation and Supply Operation)

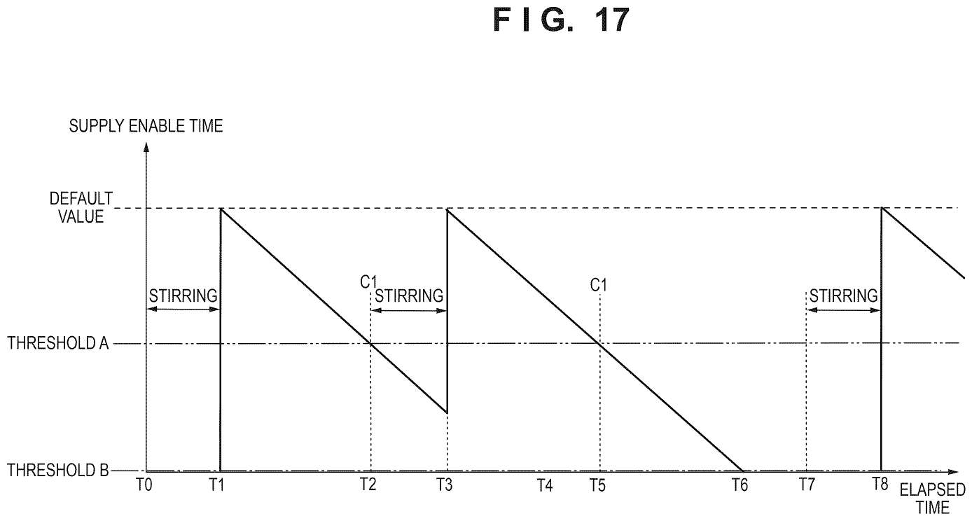

An example of control executed by the control unit 916 concerning the stirring operation and the supply operation of ink in the system 100 will be described with reference to FIGS. 17 to 21B. FIGS. 17 to 21B are timing charts for explaining an example of control of each of the stirring operation and the supply operation. In FIGS. 17 to 21B, the abscissa indicates elapsed time. The ordinate indicates a supply enable time in which the supply operation can be executed by the supply pump 500. The supply enable time is counted by the timer function of the clock portion 909 and decreases over time.

### (Example of Execution Timing of Stirring Operation)

An example of the timing to perform the stirring operation in the system 100 will be described first with reference to FIG. 17. Time TO of the timing chart of FIG. 17 is the time when the container 200 is set. That is, the time TO is the timing when the container 200 is exchanged. For example, at the time TO, if the sensor 38 detects that the position of the slide member 461 changes from the unlock position to the lock position, the control unit 916 considers that the container 200 is exchanged, and sets the supply enable time to a threshold B. In other words, the control unit 916 sets the remaining time of the timer counted by the clock portion 909 to the threshold B. If the supply enable time equals the threshold B, the supply operation is inhibited because the color material in the ink in the container 200 may sediment. Then, the control unit 916 causes the driving unit 6 to start the stirring operation. That is, if the container 200 is exchanged, the control unit 916 executes control to prioritize the stirring operation over the supply operation. Note that in the following explanation, the control to prioritize the stirring operation over the supply operation will sometimes be referred to as stirring priority control. After that, at time T1, the control unit 916 stops the stirring operation by the driving unit 6. When the stirring operation is ended, the supply enable time increases to a default value. That is, the supply enable time is the remaining time of the timer that is reset when the stirring operation is performed.

After the stirring operation is stopped at the time T1, the supply enable time decreases over time. At timing (time T2) when the supply enable time is less than the threshold A, a start condition C1 of the stirring operation (to be referred to as a stirring start condition hereinafter) is satisfied. In other words, if the supply enable time is less than the threshold A, the start trigger for the stirring operation is generated. When the stirring start condition C1 is satisfied at the time T2, the control unit 916 causes the driving unit 6 to start the stirring operation. After that, at time T3, the control unit 916 stops the stirring operation. When the stirring operation is ended, the supply enable time increases to the default value.

However, for example, assume that after the stirring operation is stopped at time T3, the system 100 is powered off at time T4 before time T5. The time T5 is the time when the stirring start condition C1 is satisfied because the supply enable time is less than the threshold A. The stirring start condition C1 is satisfied at the time T5 but the stirring operation is not executed because the system 100 is powered off at the time T4. Hence, the supply enable time decreases over time and reaches the threshold B at time T6. When the supply enable time reaches the threshold B, sedimentation of the ink may progress in the container 200, as described above. Hence, after the system 100 is powered off at the time T4 and when the system 100 is powered on at time T7, the control unit 916 causes the driving unit 6 to start the stirring operation on condition that the supply enable time equals the threshold B. More specifically, for example, the time T4 when the system 100 is powered off is stored in a storage device. After that, if the system 100 is powered on, the control unit 916 determines, based on the time T7 when the system 100 is powered on and the time T4 stored in the storage device, whether the supply enable time reaches the threshold B. Upon determining that the supply enable time reaches the threshold B, the control unit 916 causes the driving unit 6 to start the stirring operation.

Note that a case where the system 100 is powered off at the time T4 has been described as an example. However, the control unit 916 executes the above-described control even in a case where an error occurs in the system 100 at the time T4. That is, although the stirring start condition C1 is satisfied at the time T5, the stirring operation is not executed because an error occurs in the system 100 at the time T4. Hence, after an error occurs in the system 100 at the time T4 and if the error is eliminated at the time T7, the control unit 916 causes the driving unit 6 to start the stirring operation on condition that the supply enable time equals the threshold B. More specifically, for example, the time T4 when the error occurs in the system 100 is stored in a storage device. Then, if the system 100 is powered on, the control unit 916 determines, based on the time T7 when the system 100 is powered on and the time T4 stored in the storage device, whether the supply enable time reaches the threshold B. Upon determining that the supply enable time reaches the threshold B, the control unit 916 causes the driving unit 6 to start the stirring operation.

(Example of Control in Case where Stirring Start Condition is Satisfied During Supply Operation)

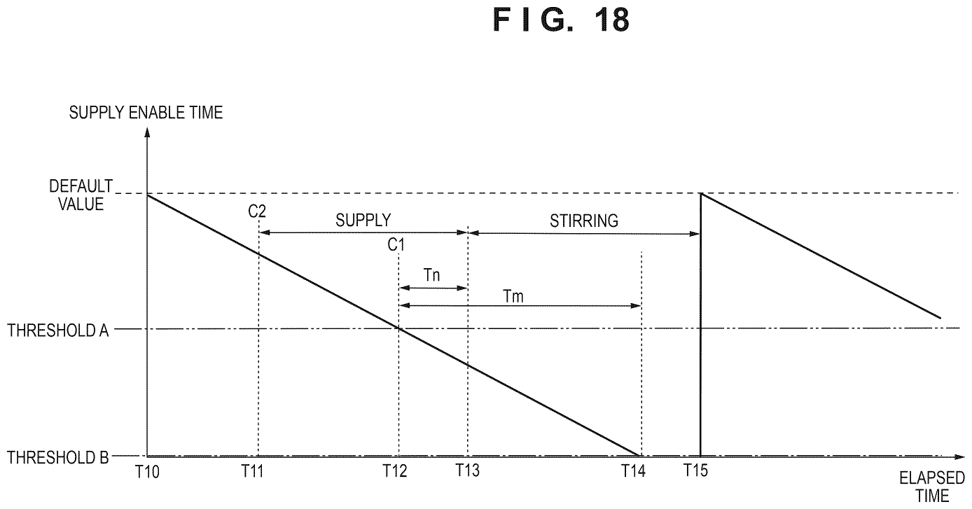

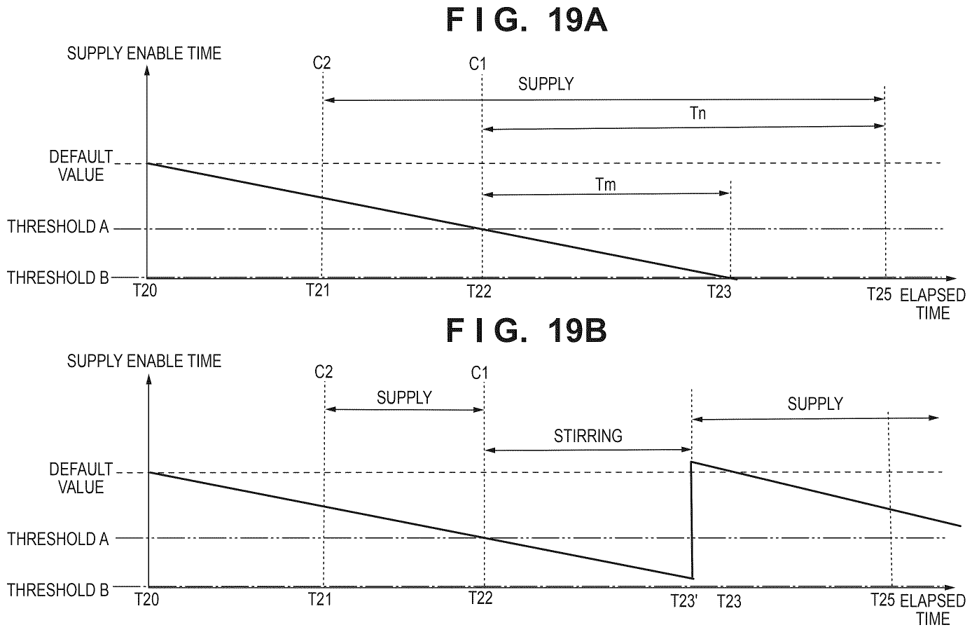

In the timing chart of FIG. 17, an example of the execution timing of the stirring operation has been described. However, in the system 100, the stirring start condition C1 may be satisfied in a case where the supply operation is being performed by the supply pump 500. An example of control of the supply operation and the stirring operation in the system 100 in such a case will be described with reference to FIGS. 18 to 19B.

FIG. 18 will be referred to first. Time T10 of the timing chart of FIG. 18 indicates timing when the stirring operation is completed. At the time T10, since the stirring operation is completed, the supply enable time increases to the default value.

Next, after the time T10, before time T12 when the start condition of the stirring operation is satisfied, a start condition C2 of the supply operation (to be referred to as a supply start condition hereinafter) is satisfied at time T11. The supply start condition C2 is satisfied if the sensor 701 detects that the remaining amount of the ink in the storage portion 700 is a predetermined amount or less. That is, the start trigger for the supply operation is generated at the time T11. Note that the stirring operation is assumed not to be performed by the driving unit 6 at the time T11. In this case, the control unit 916 drives the liquid supply motor 911 at the time T11 and causes the supply pump 500 to start the supply operation.

After that, at the time T12, the supply enable time falls below the threshold A, and the stirring start condition C1 is satisfied. However, at the time T12, the supply operation started at the time T11 is being continued. In the example shown in FIG. 18, time Tn required for the remaining supply operation is shorter than time Tm until the supply enable time reaches the threshold B. In the following explanation, the time required for the remaining supply operation will sometimes be referred to as supply required time, and the time until the supply enable time reaches the threshold B will sometimes be referred to as supply grace time. If the supply required time Tn is shorter than the supply grace time Tm, the supply enable time does not reach the threshold B even if the supply operation is continued. Hence, the control unit 916 executes control to prioritize the supply operation over the stirring operation (to be referred to as supply priority control hereinafter). That is, if the stirring start condition C1 is satisfied when the supply operation is being performed by the supply pump 500, the control unit 916 executes supply priority control based on the fact that the supply operation continuation condition (the supply required time Tn is shorter than the supply grace time Tm) is satisfied. That is, if the supply operation is being performed at the stirring operation start timing (time T12), the control unit 916 selects supply priority control based on the fact that the supply required time Tn is shorter than the supply grace time Tm. More specifically, as the supply priority control, the control unit 916 continues the supply operation by the supply pump 500 in a state in which the stirring operation is stopped, and starts the stirring operation by the driving unit 6 at time T13 after completion of the supply operation. Thus, if the stirring start condition is satisfied during the supply operation and the supply operation is to be ended in the supply grace time Tm, the supply operation is prioritized. By this control, as compared to a case where the supply operation is interrupted to execute the stirring operation, ink supply to the discharge head 108 can be completed quickly.

In the timing chart of FIG. 18, an example of control in a case where the stirring start condition C1 is satisfied during the supply operation and the supply required time Tn is shorter than the supply grace time Tm has been described. Next, a comparative example will be described concerning control in a case where the stirring start condition C1 is satisfied during the supply operation and the supply required time Tn is longer than the supply grace time Tm.

Time T20 of the timing chart of FIG. 19A indicates timing when the stirring operation is completed. At the time T20, since the stirring operation is completed, the supply enable time increases to the default value.

Next, after the time T20 and before time T22 when the stirring start condition C1 is satisfied, the supply start condition C2 is satisfied at time T21. Assume that the stirring operation is not being performed at the time T21. In this case, at the time T21, the control unit 916 causes the supply pump 500 to start the supply operation.

After that, at the time T22, the supply enable time falls below the threshold A, and the stirring start condition C1 is satisfied. Note that at the time T22, the supply operation started at the time T11 is being continued. Also, at the timing of the time T22, the time from the time T22 to time T25 is required for the remaining supply operation. The time T25 is after time T23 when the supply enable time reaches the threshold B.

That is, assume a case where after the supply operation is started, at the timing (time T22) when the stirring start condition C1 is satisfied, the supply required time Tn is longer than the supply grace time Tm. In this case, if the supply operation is continued, the supply enable time reaches the threshold B during the supply operation, and the color material in the ink contained in the container 200 may sediment.

Hence, in this embodiment, in a case where the supply required time Tn is longer than the supply grace time Tm, the control unit 916 executes stirring priority control. Here, FIG. 19B will be referred to. FIG. 19B is a timing chart for explaining an example of control by the control unit 916 in a case where the stirring start condition C1 is satisfied during the supply operation and the supply required time Tn is longer than the supply grace time Tm.

In the comparative example described with reference to FIG. 19A, at the time T22, the supply operation is continued without executing the stirring operation. On the other hand, in the example shown in FIG. 19B, at the time T22, the control unit 916 executes stirring priority control. That is, if the stirring start condition C1 is satisfied when the supply operation is being performed by the supply pump 500, the control unit 916 executes stirring priority control based on the fact that the interruption condition of the supply operation (the supply required time Tn is longer than the supply grace time Tm) is satisfied. That is, in this example, if the supply operation is being performed at the stirring operation start timing (time T22), the control unit 916 selects stirring priority control based on the fact that the supply required time Tn is longer than the supply grace time Tm. More specifically, as the stirring priority control, the control unit 916 interrupts the supply operation at the time T22 and causes the driving unit 6 to perform the stirring operation in a state in which the supply operation is stopped. When the stirring operation is ended at time T23′, the supply operation is resumed. If the stirring start condition is satisfied during the supply operation and the supply operation will not be ended in the supply grace time Tm, the stirring operation is prioritized. This control can prevent the supply operation from being performed in a state in which sedimentation of the color material may progress in the ink in the container 200.

(Example of Control in Case where Supply Start Condition is Satisfied During Stirring Operation)

An example of control in a case where the stirring start condition C1 is satisfied during the supply operation has been described above. Next, an example of control in a case where the supply start condition C2 is satisfied during the stirring operation will be described.

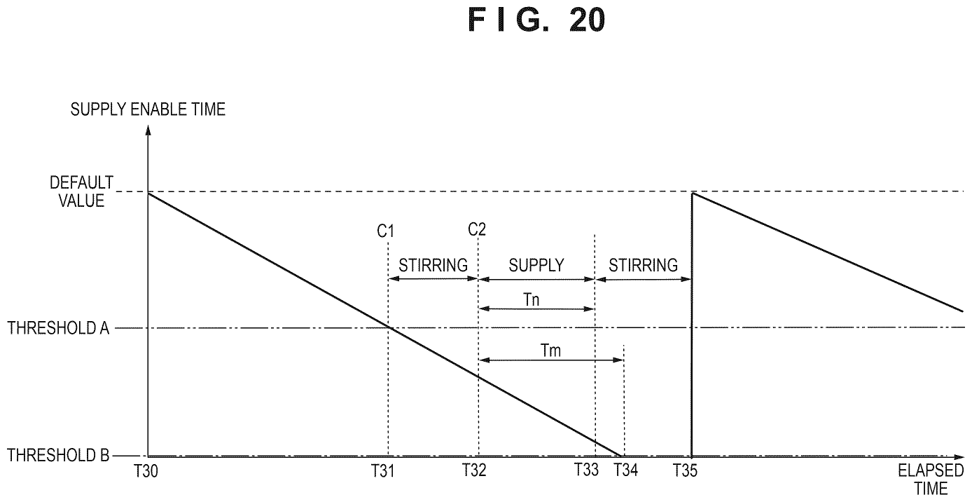

FIG. 20 will be referred to first. Time T30 of the timing chart of FIG. 20 indicates timing when the stirring operation is completed. At the time T30, since the stirring operation is completed, the supply enable time increases to the default value.

After the time T30, the supply enable time decreases over time. At time T31, the supply enable time falls below the threshold A, and the stirring start condition C1 is satisfied. In this example, the supply operation is not being executed at the time T31. Hence, the control unit 916 causes the driving unit 6 to start the stirring operation at the time T31.

Assume that after the stirring operation is started at the time T31, the supply start condition C2 is satisfied at time T32 before the stirring operation is ended. Also, assume that the supply operation is ended at time T33 before time T34 when the supply enable time reaches the threshold B. That is, the supply required time Tn is shorter than the supply grace time Tm. In such a case, even if the supply operation is started, the supply operation is ended before the supply enable time reaches the threshold B. For this reason, at the time T32, the control unit 916 executes supply priority control. That is, if the supply start condition C2 is satisfied when the stirring operation is being performed by the driving unit 6, the control unit 916 executes supply priority control based on the fact that the interruption condition of the stirring operation (the supply required time Tn is shorter than the supply grace time Tm) is satisfied. That is, if the stirring operation is being performed at the supply operation start timing (time T32), the control unit 916 selects supply priority control based on the fact that the supply required time Tn is shorter than the supply grace time Tm. More specifically, as the supply priority control, the control unit 916 interrupts the stirring operation and causes the supply pump 500 to perform the supply operation in a state in which the stirring operation is stopped. If the supply start condition is satisfied during the stirring operation and the supply operation is to be ended in the supply grace time Tm, the supply operation is prioritized. By this control, as compared to a case where the supply operation is performed after the end of the stirring operation, ink supply to the discharge head 108 can be completed quickly.

After the supply operation is started at the time T32, the supply operation is ended at the time T33. The control unit 916 then resumes the stirring operation at the time T33.

An example of control in a case where the supply start condition C2 is satisfied during the stirring operation and the supply required time Tn is shorter than the supply grace time Tm has been described above. Next, a comparative example will be described concerning control in a case where the supply start condition C2 is satisfied during the stirring operation and the supply required time Tn is longer than the supply grace time Tm.

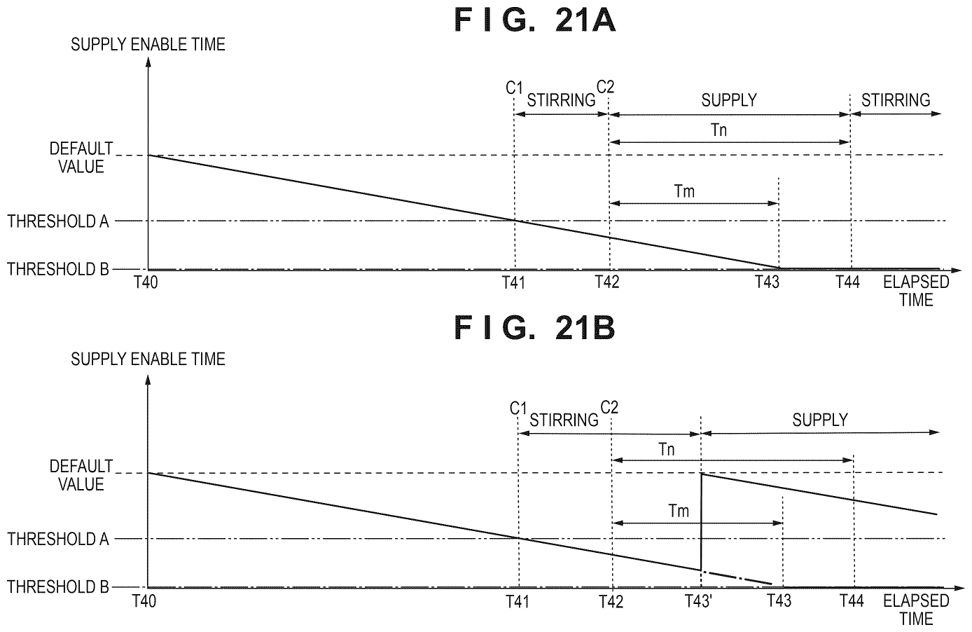

Time T40 of the timing chart of FIG. 21A indicates timing when the stirring operation is completed. At the time T40, since the stirring operation is completed, the supply enable time increases to the default value.

After the time T40, the supply enable time decreases over time. At time T41, the supply enable time falls below the threshold A, and the stirring start condition C1 is satisfied. In this example, the supply operation is not being executed at the time T41. Hence, the control unit 916 causes the driving unit 6 to start the stirring operation at the time T41.

Assume that after the stirring operation is started at the time T41, the supply start condition C2 is satisfied at time T42 before the supply enable time reaches the threshold B at time T43. Here, assume that when the supply operation is started at the time T42, the supply operation is performed up to time T44 after the supply enable time reaches the threshold B at the time T43. That is, assume that the supply required time Tn is longer than the supply grace time Tm. In such a case, if the stirring operation is interrupted and the supply operation is started at the time T42, as shown in FIG. 21A, the supply enable time reaches the threshold B during the supply operation.

Hence, in this embodiment, if the supply start condition C2 is satisfied during the stirring operation, in a case where the supply required time Tn is longer than the supply grace time Tm, the control unit 916 executes stirring priority control. Here, FIG. 21B will be referred to. FIG. 21B is a timing chart for explaining an example of control in a case where the supply start condition C2 is satisfied during the stirring operation and the supply required time Tn is longer than the supply grace time Tm.

In the comparative example described with reference to FIG. 21A, at the time T42, the stirring operation is interrupted and the supply operation is continued. In this control, the supply enable time reaches the threshold B during the supply operation. Hence, in the example shown in FIG. 21B, after the stirring operation is started at the time T41, if the supply start condition C2 is satisfied at the time T42, the control unit 916 executes stirring priority control. That is, if the supply start condition C2 is satisfied when the stirring operation is being performed by the driving unit 6, the control unit 916 executes stirring priority control based on the fact that the stirring operation continuation condition (the supply required time Tn is longer than the supply grace time Tm) is satisfied. That is, in this example, if the stirring operation is being performed at the supply operation start timing (time T42), the control unit 916 selects stirring priority control based on the fact that the supply required time Tn is longer than the supply grace time Tm. More specifically, as the stirring priority control, the control unit 916 causes the driving unit 6 to continue the stirring operation in a state in which the supply operation is stopped. Then, at time T43′, the control unit 916 ends the stirring operation by the driving unit 6 and causes the supply pump 500 to start the supply operation. If the supply start condition is satisfied during the stirring operation and the supply operation will not be ended in the supply grace time Tm, the stirring operation is prioritized. This control can prevent a state in which the color material in the ink may sediment halfway through the supply operation.

### (Example of Processing of Control Circuit)

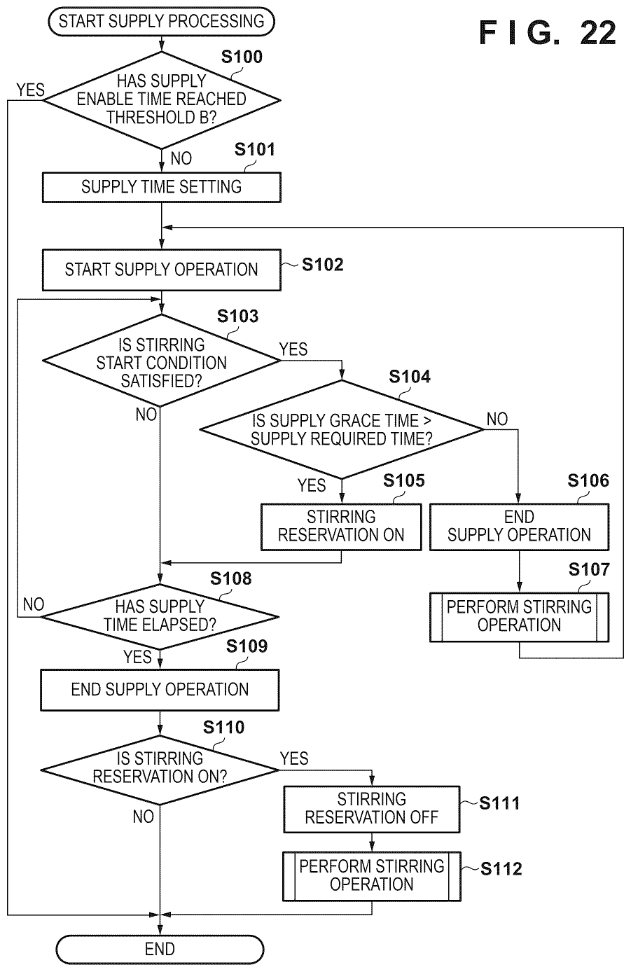

An example of processing executed by the control unit 916 for the supply operation will be described. FIG. 22 is a flowchart of the processing. This flowchart is started by the control unit 916 if, for example, the remaining amount of the ink in the storage portion 700 detected by the sensor 701 is a predetermined amount or less. That is, this flowchart is started if the supply start condition is satisfied.

In step S100, the control unit 916 determines whether the supply enable time reaches the threshold B. Upon determining that the supply enable time reaches the threshold B, the control unit 916 ends the processing shown in FIG. 22. If the supply enable time reaches the threshold B, the color material in the ink contained in the container 200 may sediment. Hence, if the supply enable time reaches the threshold B, the control unit 916 ends the processing without executing the ink supply operation. On the other hand, upon determining that the supply enable time does not reach the threshold B, the control unit 916 advances the process to step S101. The control unit 916 performs the determination based on, for example, the count result of the clock portion 909.

In step S101, the control unit 916 sets a supply time to supply ink from the container 200 to the storage portion 700. The supply time is the driving time of the supply pump 500 and is time required for the supply operation. The control unit 916 may calculate the supply amount to be supplied to the storage portion 700 based on, for example, the remaining amount of the ink in the storage portion 700 detected by the sensor 701. The control unit 916 may then set the supply time based on, for example, the calculated supply amount. Also, when, for example, setting the supply time, the control unit 916 may use temperature information or ink viscosity information for reference. The temperature information is, for example, the temperature of the environment where the system 100 is operating. Since the temperature or viscosity affects the fluidity of ink, the control unit 916 may adjust the supply time based on these pieces of information.

In step S102, the control unit 916 causes the supply pump 500 to start the supply operation. More specifically, the control unit 916 drives the liquid supply motor 911. The supply pump 500 is thus driven, and the ink in the container 200 is supplied to the storage portion 700. Also, in step S102, when, for example, driving the liquid supply motor 911, the control unit 916 causes the clock portion 909 to start counting the supply time.

In step S103, the control unit 916 determines whether the stirring start condition is satisfied. Upon determining that the stirring start condition is satisfied, the control unit 916 advances the process to step S104. On the other hand, upon determining that the stirring start condition is not satisfied, the control unit 916 advances the process to step S108. For example, if the supply enable time counted by the clock portion 909 is less than the threshold A, the control unit 916 determines that the stirring start condition is satisfied.

In step S104, the control unit 916 determines whether the supply grace time Tm is longer than the supply required time Tn. Upon determining that the supply grace time Tm is long, the control unit 916 advances the process to step S105. On the other hand, upon determining that the supply grace time Tm is short, the control unit 916 advances the process to step S106. If the supply grace time Tm is longer than the supply required time Tn, ink sedimentation does not occur in the container 200 even if the supply operation is continued. On the other hand, if the supply grace time Tm is shorter than the supply required time Tn, ink sedimentation may occur in the container 200 if the supply operation is continued. Hence, if the stirring start condition is satisfied during the supply operation, the determination of step S104 is performed.

In step S105, the control unit 916 sets a stirring reservation to start the stirring operation by the driving unit 6 to ON. For example, the control unit 916 stores information (a reservation flag, a reservation queue, and the like) for starting the stirring operation in a storage device.

In step S106, the control unit 916 interrupts the supply operation by the supply pump 500. More specifically, the control unit 916 stops driving of the liquid supply motor 911. Thus, driving of the supply pump 500 is also stopped. Also, in step S106, the control unit 916 stops counting of the supply time by the clock portion 909.

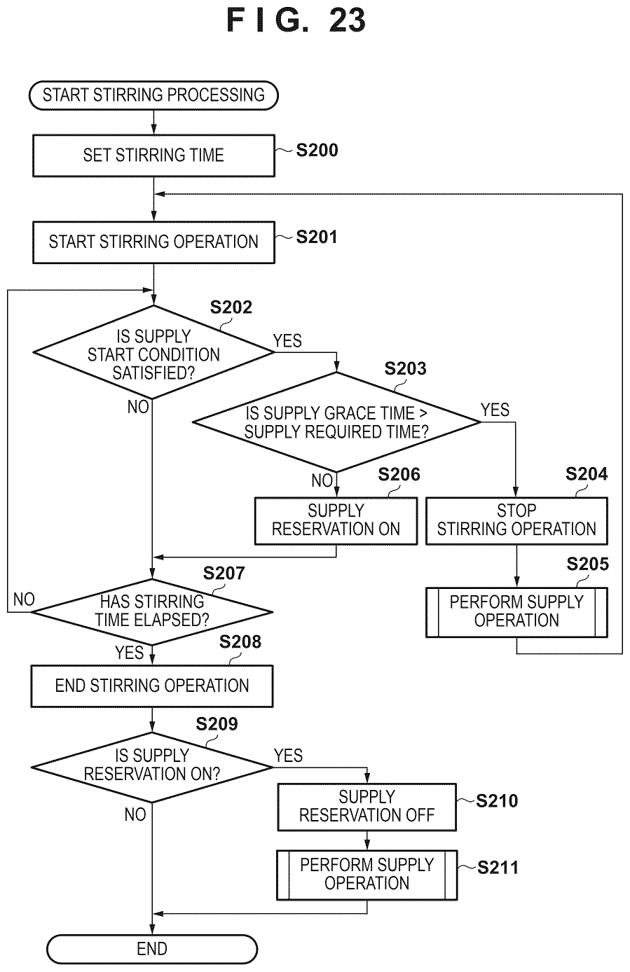

In step S107, the control unit 916 executes the stirring operation by the driving unit 6. Details of this processing will be described later with reference to FIG. 23. After the process of step S107, the control unit 916 advances to step S102 and resumes the supply operation by the supply pump 500.

In step S108, the control unit 916 determines whether the time counted by the clock portion 909 exceeds the supply time set in step S101. Upon determining that the time exceeds the supply time, the control unit 916 advances the process to step S109. On the other hand, upon determining that the time does not exceed the supply time, the control unit 916 returns the process to step S103.

In step S109, the control unit 916 stops the supply pump 500 under driving, thereby ending the supply operation by the supply pump 500.

In step S110, the control unit 916 determines whether the stirring reservation is ON. Upon determining that the stirring reservation is ON, the control unit 916 advances the process to step S111. On the other hand, upon determining that the stirring reservation is not ON, the control unit 916 ends the processing shown in FIG. 22. For example, the control unit 916 determines whether information for starting the stirring operation is stored in the storage device.

In step S111, the control unit 916 sets the stirring reservation to OFF. For example, the control unit 916 erases the information for starting the stirring operation, which is stored in the storage device.

In step S112, the control unit 916 performs stirring processing for executing the stirring operation by the driving unit 6. Details of this processing will be described later with reference to FIG. 23.

An example of processing executed by the control unit 916 for the stirring operation will be described next. FIG. 23 is a flowchart of the processing. This flowchart is started, for example, in step S107 of FIG. 22 described above. Also, this flowchart is executed, for example, in step S112 of FIG. 22 described above. This flowchart is executed, for example, after exchange of the container 200. This flowchart is started, for example, upon receiving a user operation for starting the stirring operation.

In step S200, the control unit 916 sets a stirring time. The stirring time is the driving time of the motor 635. The control unit 916 may set, for example, a predetermined time as the stirring time. Also, the control unit 916 may adjust the stirring time based on temperature information or ink viscosity information.

In step S201, the control unit 916 causes the driving unit 6 to start the stirring operation. More specifically, the control unit 916 drives the motor 635 to drive the moving mechanism 63 and rotate the pressing member 60. Thus, the pressing portion 61 reciprocally moves between the pressing position and the pressing relaxing position, and the pressing operation and the pressing relaxing operation are repeated. Also, in step S201, when, for example, driving the motor 635, the control unit 916 causes the clock portion 909 to start counting the stirring time.

In step S202, the control unit 916 determines whether the supply start condition is satisfied. Upon determining that the supply start condition is satisfied, the control unit 916 advances the process to step S203. On the other hand, upon determining that the supply start condition is not satisfied, the control unit 916 advances the process to step S207. More specifically, the control unit 916 performs the determination based on the detection result of the sensor 701.

In step S203, the control unit 916 determines whether the supply grace time Tm is longer than the supply required time Tn. Upon determining that the supply grace time Tm is long, the control unit 916 advances the process to step S204. On the other hand, upon determining that the supply grace time Tm is short, the control unit 916 advances the process to step S206.

In step S204, the control unit 916 stops driving of the motor 635, thereby stopping the stirring operation by the driving unit 6. Also, in step S204, the control unit 916 stops counting of the stirring time by the clock portion 909.

In step S205, the control unit 916 performs supply processing for executing the supply operation by the supply pump 500. In step S205, the above-described processing shown in FIG. 22 is performed.

In step S206, the control unit 916 sets a supply reservation to start the supply operation to ON. For example, the control unit 916 stores information (a reservation flag, a reservation queue, and the like) for starting the supply operation in a storage device.

In step S207, the control unit 916 determines whether the time counted by the clock portion 909 exceeds the stirring time set in step S200. Upon determining that the time exceeds the stirring time, the control unit 916 advances the process to step S208. On the other hand, upon determining that the time does not exceed the stirring time, the control unit 916 returns the process to step S202.

In step S208, the control unit 916 stops the motor 635, thereby ending the stirring operation by the driving unit 6.

In step S209, the control unit 916 determines whether the supply reservation is ON. Upon determining that the supply reservation is ON, the control unit 916 advances the process to step S210. On the other hand, upon determining that the supply reservation is not ON, the control unit 916 ends the processing shown in FIG. 23. For example, the control unit 916 determines whether information for starting the supply operation is stored in the storage device.

In step S210, the control unit 916 sets the supply reservation to OFF. For example, the control unit 916 erases the information for starting the supply operation, which is stored in the storage device.

In step S211, the control unit 916 performs supply processing for executing the supply operation by the supply pump 500. In this processing, the processing shown in FIG. 22 is executed.

### Second Embodiment

In the first embodiment, the moving mechanism 63 is shared by all pressing members 60. However, while sharing a moving mechanism 63, a mechanism for switching transmission/blocking of the driving force to each pressing member 60 may be provided for each pressing member 60, and the pressing members 60 may individually be rotated. Alternatively, an independent moving mechanism may be provided for each pressing member 60, and the pressing members 60 may independently be rotated. Also, the motion of the pressing member 60 in a stirring operation may be not a rotary motion but a translation motion.

### Third Embodiment

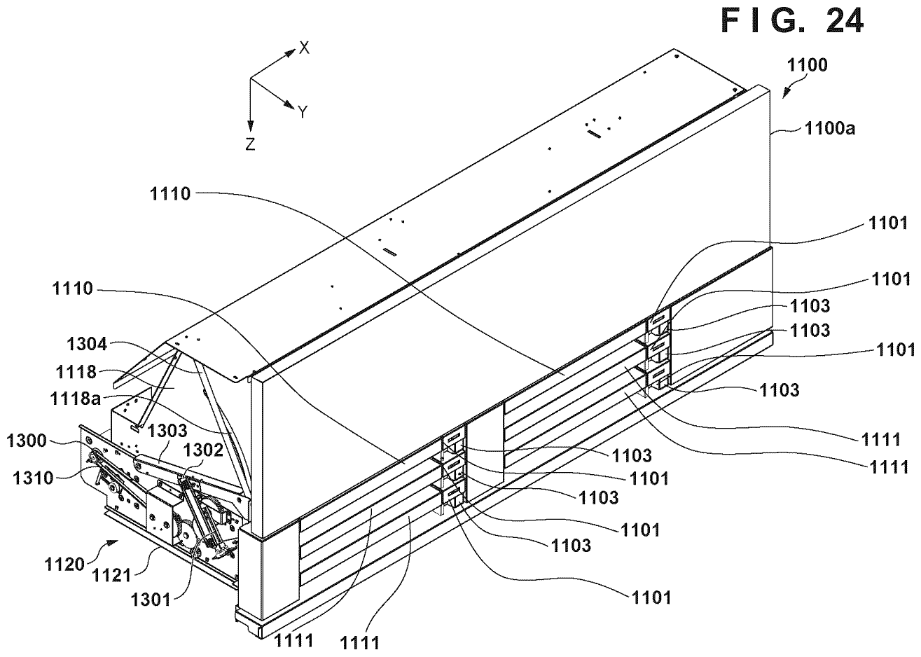

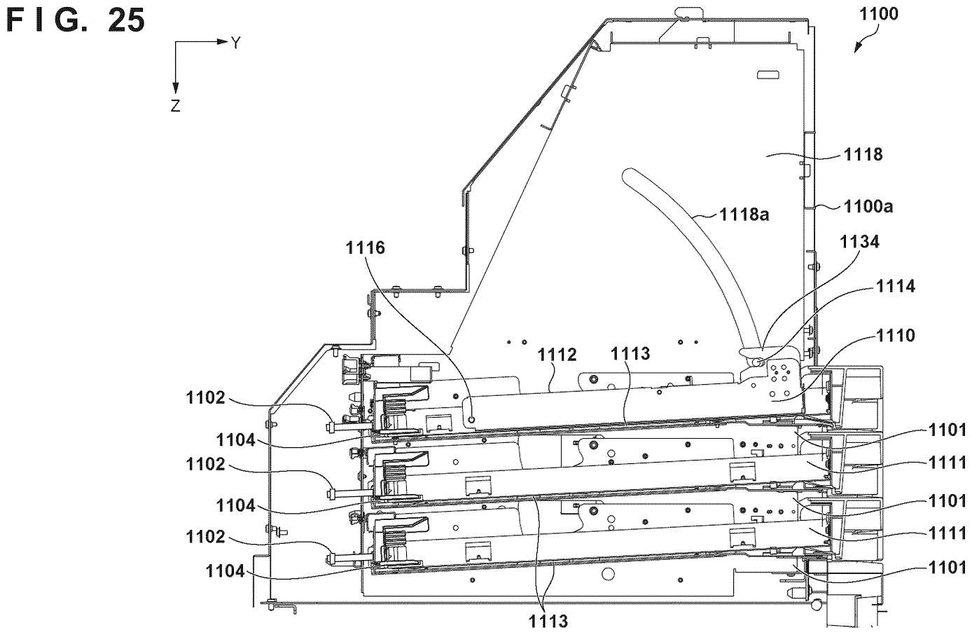

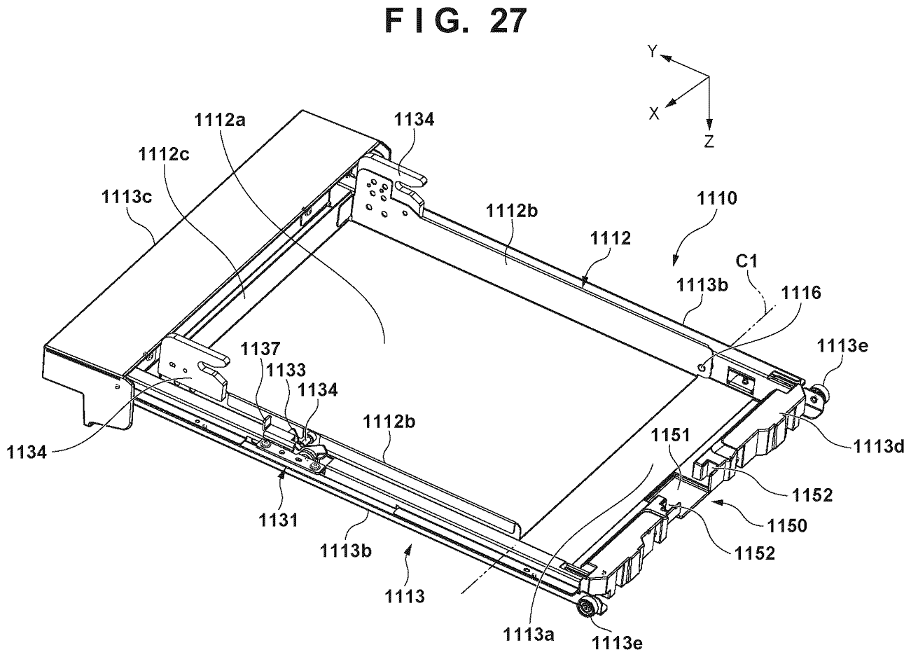

A liquid supply apparatus with a different stirring mechanism will be described. The above-described examples of control executed by the control unit 916 shown in FIGS. 22 and 23 can also be applied to a liquid supply apparatus 1100 to be described in this embodiment. FIG. 24 is a perspective view of the liquid supply apparatus 1100 according to this embodiment, and FIG. 25 is an explanatory view showing the internal structure of the liquid supply apparatus 1100. A main body 1100a of the liquid supply apparatus 1100 includes a plurality of storage portions 1101 each capable of storing a liquid container 1200 (FIG. 27) that contains ink. In this embodiment, six storage portions 1101 are provided. The six storage portions 1101 are arranged in three stages in the Z direction and two columns in the X direction. Each storage portion 1101 is a space having a flat rectangular parallelepiped shape in which the lengths in the X and Y directions are longer than the length in the Z direction. Note that in this embodiment, the length of the storage portion 1101 in the Y direction is longer than the length in the X direction. A connecting unit 1104 connected to the liquid container 1200 is provided at an end portion on the far side of each storage portion 1101 (an end portion in the Y direction).

A tray 1110 or a tray 1111 is attached to each storage portion 1101 to be detachable in the Y direction. In this embodiment, the liquid container 1200 is placed on the tray 1110 or the tray 1111 and detachably stored in the storage portion 1101. In the storage portions 1101 of three stages, the tray 1110 is attached to the storage portion 1101 of the uppermost stage, and the trays 1111 are attached to the storage portions 1101 of the middle and lower stages. Hence, two trays 1110 and four trays 1111 are used. The trays 1110 and 1111 basically have the same structure. The tray 1110 has a structure for stirring ink in the liquid container 1200, as will be described later.

Each storage portion 1101 is also provided with an operation member 1103 that regulates detachment of the tray 1110 or the tray 1111 and locks the tray to a corresponding storage portion 1101. The operation member 1103 is provided to be slidable in the X direction, and the user can operate this.

### (Liquid Container)

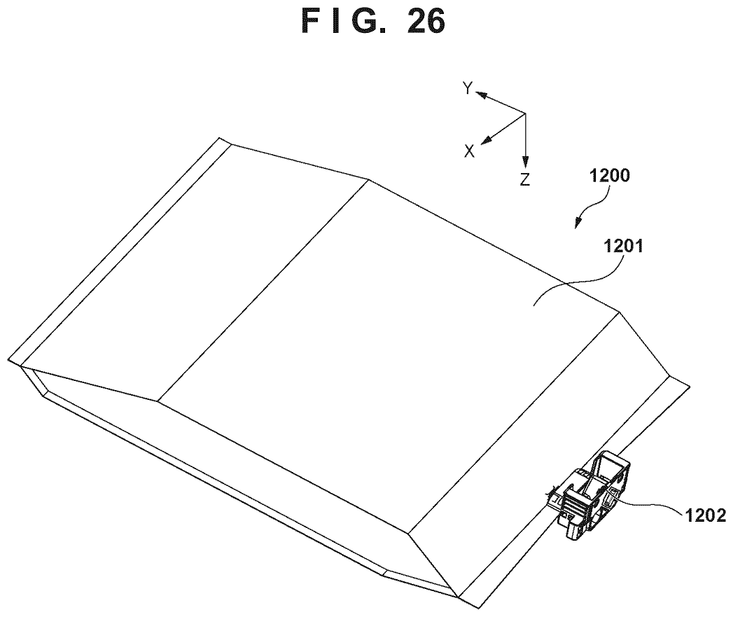

The liquid container 1200 will be described. FIG. 26 is a perspective view of the liquid container 1200. The liquid container 1200 includes a container portion 1201 that contains ink, and a connecting portion 1202 connected to the connecting unit 1104 of the storage portion 1101. The container portion 1201 is a bag-type ink pack made of a material having flexibility. As for the flexibility of the container portion 1201, it may only be deflected by the weight of its own, or may hold the shape against the weight of its own and only be deflected when a load larger than the weight of its own is applied.

The container portion 1201 is formed into a bag shape by welding sheets forming the upper and lower surfaces and sheets forming gusset portions on the left and right sides (the side portions in the X direction) to each other, thereby forming a flexible tank that has a rectangular shape in a planar view and contains a liquid. The material of the container portion 1201 is, for example, a material having a multiple layer structure such as PET, and the multiple layer structure may include an aluminum layer.

The connecting portion 1202 is provided at an end portion of the container portion 1201 in the Y direction and at the central portion in the X direction. The connecting portion 1202 is detachably connected to the connecting unit 1104 and forms an ink path between the container portion 1201 and the connecting unit 1104.

### (Trays)

The trays 1110 and 1111 will be described. FIG. 27 is a perspective view of the tray 1110. The tray 1110 includes a tray main body 1113. The tray main body 1113 is a member that includes a bottom wall portion 1113a, left and right side wall portions 1113b, a front wall portion 1113c, and a rear wall portion 1113d and has a shallow rectangular box shape with its top portion open. A roller 1113e is rotatably supported on each side wall portion 1113b. Insertion/removal of the tray 1110 into/from the storage portion 1101 can smoothly be performed by rolling of the rollers 1113e.

FIGS. 24 and 28 will be referred to. FIG. 28 is a perspective view of the tray 1110, and shows a part of the bottom surface of the bottom wall portion 1113a. An engaging portion 1119 that engages with the operation member 1103 is provided on the bottom surface of the bottom wall portion 1113a of the tray main body 1113. The engaging portion 1119 according to this embodiment is a projection having a columnar shape. The operation member 1103 includes an arm member 1141 with a C-shaped engaging portion 1141a that engages with the engaging portion 1119, and a knob portion 1142 that the user can grip.

The arm member 1141 is a plate-shaped member extended in the X direction along the bottom surface of the bottom wall portion 1113a, and is connected to the knob portion 1142. FIG. 28 shows a state in which the engaging portions 1119 and 1141a engage with each other, and movement of the tray 1110 in the Y direction (that is, detachment from the storage portion 1101) is regulated. When the knob portion 1142 is moved in the X direction from the state shown in FIG. 28, the arm member 1141 is displaced in the X direction, and the engagement between the engaging portion 1119 and the engaging portion 1141a can be released. The tray 1110 can thus be extracted from the storage portion 1101. This engagement mechanism can prevent the tray 1110 from being unintentionally removed from the storage portion 1101.

Referring back to FIG. 27, a placement member 1112 is mounted on the tray main body 1113. The placement member 1112 is a member that includes a bottom wall portion 1112a overlaid on the bottom wall portion 1113a, left and right side wall portions 1112b located inside the left and right side wall portions 1113b, and a front wall portion 1112c located inside the front wall portion 1113c and has a shallow rectangular box shape with its top portion and rear end portion open. The tray 1110 according to this embodiment has a double tray structure in which the tray main body 1113 is the outer tray, and the placement member 1112 is the inner tray.

The bottom wall portion 1112a of the placement member 1112 is shorter than the bottom wall portion 1113a of the tray main body 1113 in the Y direction, and the edge (rear edge) of the bottom wall portion 1112a in the Y direction is apart from the rear wall portion 1113d of the tray main body 1113. The placement member 1112 is rotatably supported by the tray main body 1113 via a shaft 1116. The left and right side wall portions 1112b are supported by the left and right side wall portions 1113b of the tray main body 1113 via the shafts 1116 (FIG. 27 shows only one shaft 1116). The placement member 1112 can rotate, with respect to the tray main body 1113, about a rotation centerline C1 passing through the shafts 1116 as the rotation center. In this viewpoint, the placement member 1112 can also be called a movable member or a rotation member. FIG. 27 shows a state in which the placement member 1112 is located at an initial position with respect to the tray main body 1113. At the initial position, the bottom surface of the bottom wall portion 1112a of the placement member 1112 abuts against the upper surface of the bottom wall portion 1113a of the tray main body 1113 and these are overlaid in the Z direction.

An engaging portion 1134 is fixed to each side wall portion 1112b of the placement member 1112. A driving unit 1120 to be described later inputs a rotation biasing force to the engaging portion 1134, and the placement member 1112 thus rotates. The engaging portion 1134 has a C shape open to one side (rear side) in the Y direction.

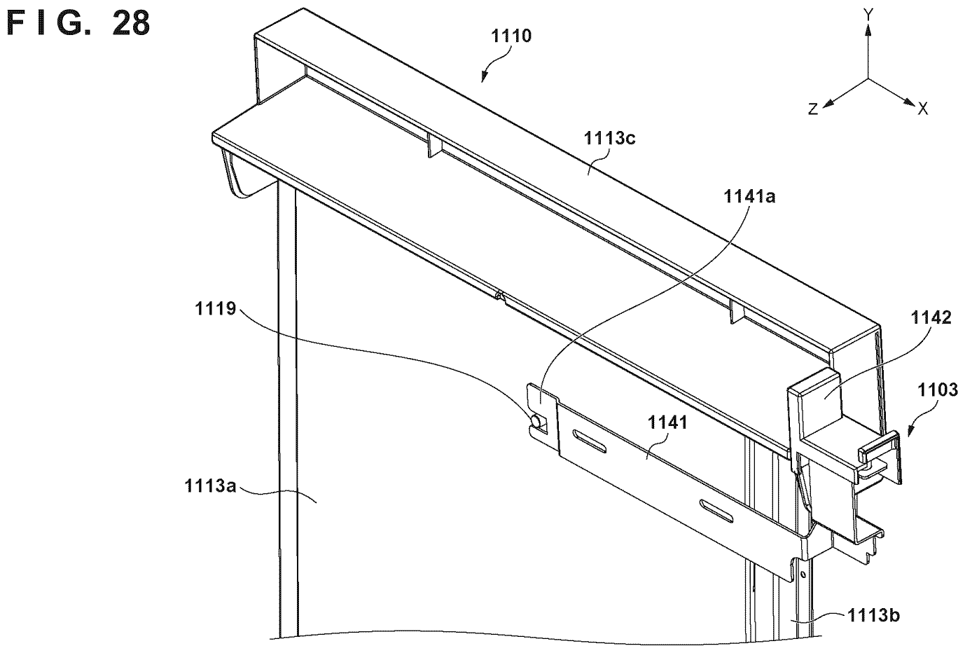

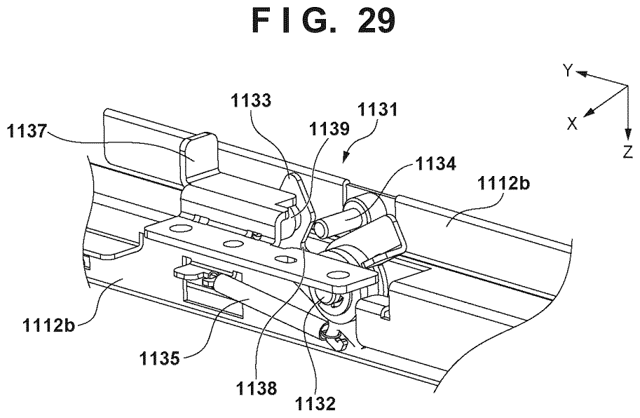

The tray main body 1113 is also provided with a lock mechanism 1131 that locks the placement member 1112 to the tray main body 1113 and regulates its rotation from the initial position. The lock mechanism 1131 operates in synchronism with attachment/detachment of the tray 1110 to/from the storage portion 1101. When attaching the tray 1110 to the storage portion 1101, the lock mechanism 1131 allows the placement member 1112 to rotate. When the tray 1110 is detached from the storage portion 1101, the lock mechanism 1131 regulates rotation of the placement member 1112. FIG. 29 is a perspective view of the lock mechanism 1131.

The lock mechanism 1131 includes a rotation shaft 1132 provided on one side wall portion 1113b of the tray main body 1113, and a lock member 1133 rotatably supported by the tray main body 1113 via the rotation shaft 1132. The lock mechanism 1131 further includes a biasing member 1136 that biases the lock member 1133 in a rotation direction RR. The biasing member 1136 is an elastic member such as a coil spring connected between the side wall portion 1113b and the lock member 1133. An unlock member 1137 is fixed to the storage portion 1101, and the engaging portion 1134 is provided on the placement member 1112. The engaging portion 1134 is a shaft member projecting from the side wall portion 1112b in the X direction. The lock member 1133 includes a lock portion 1138 having a roller shape engaging with the engaging portion 1134, and an abutment portion 1139 having a shape of a concave portion abutting against the unlock member 1137.

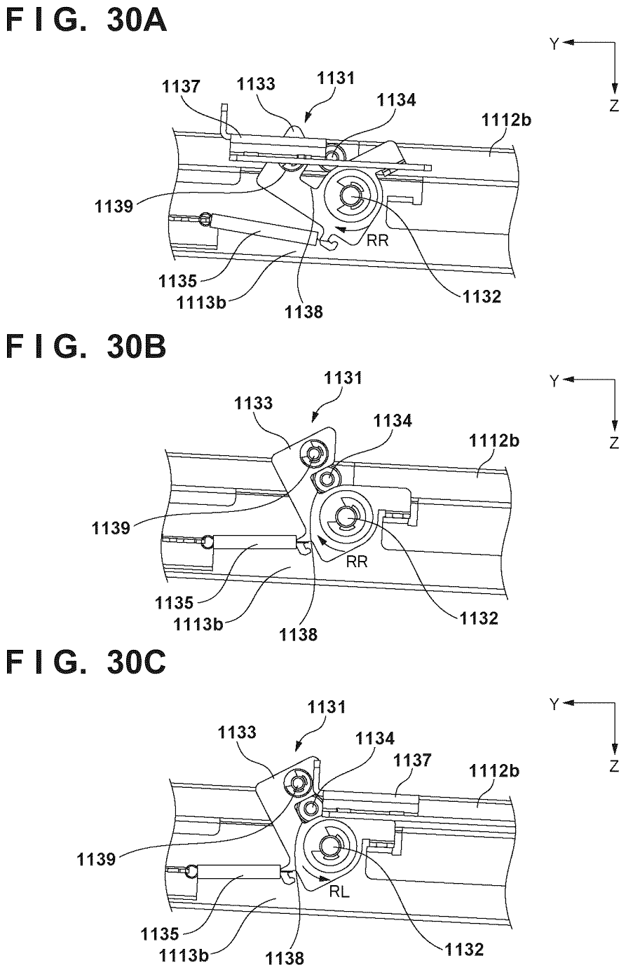

FIGS. 30A to 30C are explanatory views of operation of the lock mechanism 1131. FIG. 30A shows the state of the lock mechanism 1131 in a state in which the tray 1110 is stored in the storage portion 1101. The lock member 1133 receives a biasing force to rotate in the rotation direction RR from the biasing member 1136, and the abutment portion 1139 contacts the unlock member 1137. The abutment portion 1139 contacts the unlock member 1137 to impede engagement between the lock portion 1138 and the engaging portion 1134. The placement member 1112 is in an unlocked state, that is, in a state in which the placement member 1112 can rotate from the initial position with respect to the tray main body 1113.

FIG. 30B shows the state of the lock mechanism 1131 in a state in which the tray 1110 is extracted from the storage portion 1101. The lock member 1133 receives the biasing force to rotate in the rotation direction RR from the biasing member 1136, and the lock portion 1138 engages with the engaging portion 1134. When the lock portion 1138 engages with the engaging portion 1134, the placement member 1112 is in a locked state, that is, in a state in which rotation with respect to the tray main body 1113 is regulated and the placement member 1112 is locked to the initial position.

FIG. 30C shows the state of the lock mechanism 1131 in a halfway state in which the tray 1110 is being inserted into the storage portion 1101. The lock member 1133 receives the biasing force to rotate in the rotation direction RR from the biasing member 1136, and the lock portion 1138 engages with the engaging portion 1134. Along with the insertion operation of the tray 1110 into the storage portion 1101, the abutment portion 1139 contacts the unlock member 1137, and the lock member 1133 rotates in a rotation direction RL. When the tray 1110 is stored in the storage portion 1101, the lock mechanism 1131 is set in the state shown in FIG. 30A, and the engagement between the lock portion 1138 and the engaging portion 1134 is released.

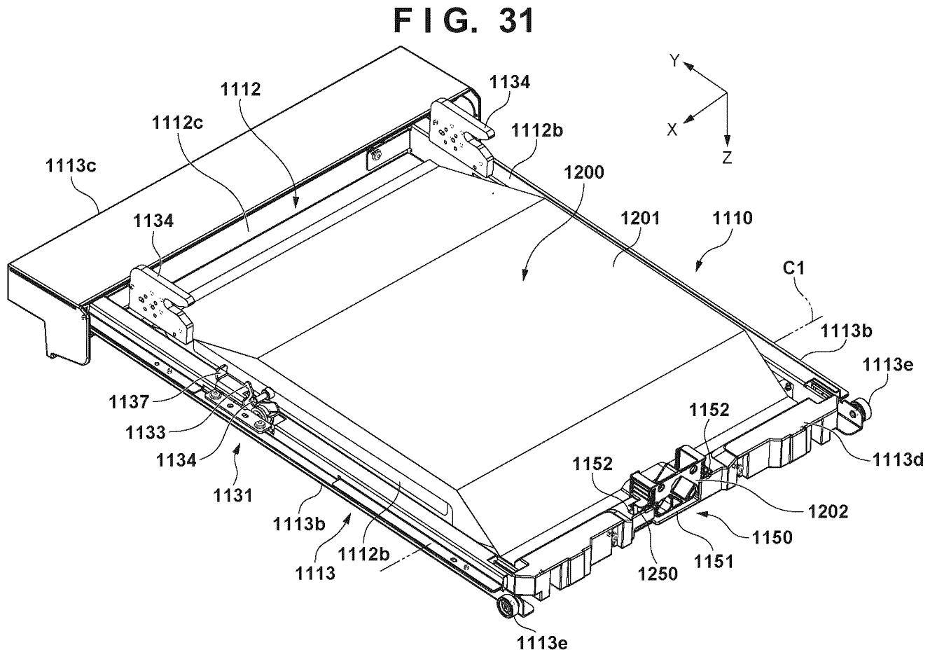

FIGS. 27 and 31 will be referred to. FIG. 31 is a perspective view of the tray 1110 on which the liquid container 1200 is placed. The container portion 1201 of the liquid container 1200 is placed on the placement member 1112. Apart of the container portion 1201 on the side of the connecting portion 1202 is placed on the tray main body 1113, and the rotation centerline C1 is apart from the connecting portion 1202 in the Y direction and passes through the container portion 1201.

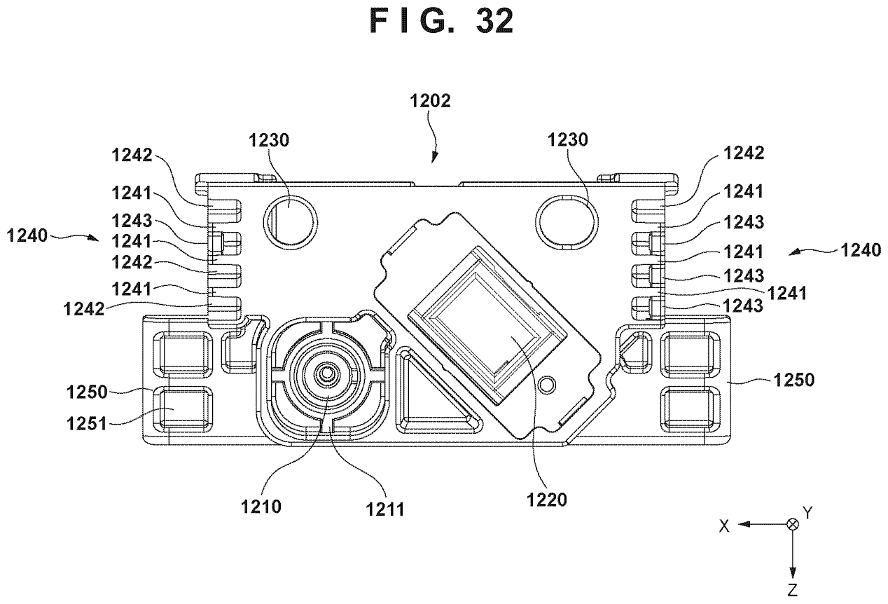

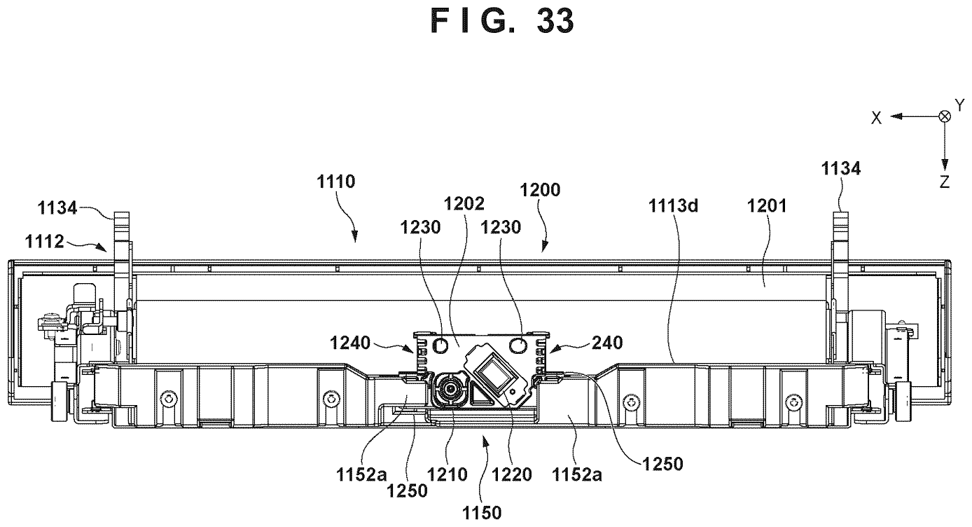

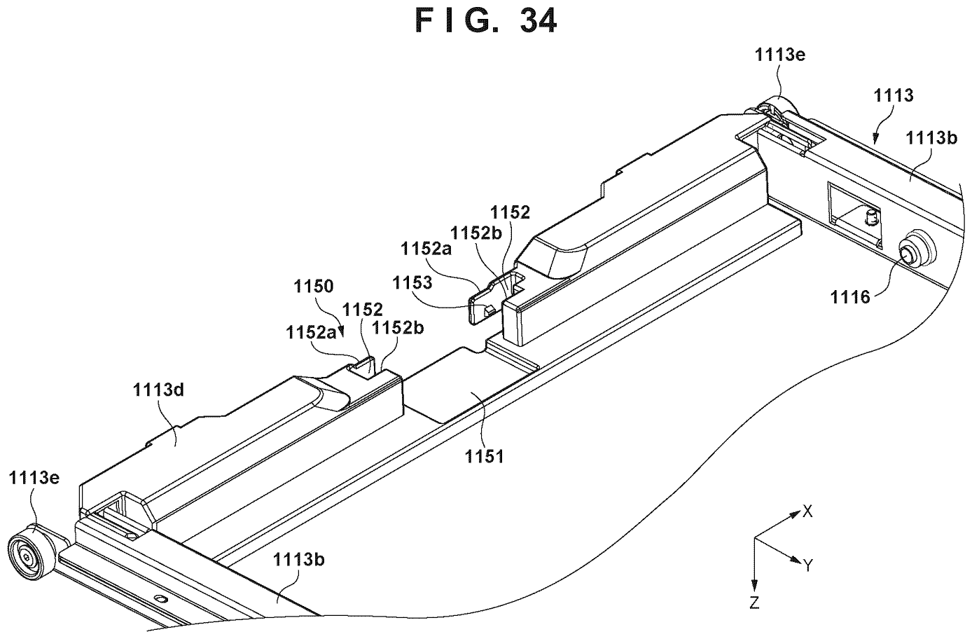

A holding portion 1150 that holds the connecting portion 1202 of the liquid container 1200 is formed at the central portion of the rear wall portion 1113d in the X direction. The structure of the connecting portion 1202 and the holding portion 1150 will be described with reference to FIGS. 32 to 34 in addition to FIGS. 27 and 31. FIG. 32 is a front view of the connecting portion 1202 viewed in the Y direction. FIG. 33 is a view of the tray 1110 with the liquid container 1200 placed thereon viewed from the side of the rear wall portion 1113d in the Y direction. FIG. 34 is a perspective view of the periphery of the holding portion 1150.

The holding portion 1150 includes a concave portion 1151 that is recessed downward from the upper surface of the rear wall portion 1113d in the Z direction, and engaging portions 1152 formed on both sides of the concave portion 1151 in the X direction. Each engaging portion 1152 is a groove extended in the Z direction and having a depth in the X direction, and is formed by vertical walls 1152a and 1152b apart in the Y direction. Left and right engaging portions 1250 of the connecting portion 1202 are inserted into the engaging portions 1152 in the Z direction, and the remaining part of the connecting portion 1202 is arranged on the concave portion 1151. The engaging portions 1250 are plate-shaped members projecting to both sides of the connecting portion 1202 in the X direction.

The holding portion 1150 positions the connecting portion 1202 with respect to the tray 1110 in the X, Y, and Z directions. Also, since each engaging portion 1152 includes the pair of vertical walls 1152a and 1152b apart in the Y direction, displacement of the engaging portions 1250 in the Y direction is regulated. As a result, displacement of the connecting portion 1202 in the Y direction is regulated by the engaging portions 1152 with respect to the tray 1110.

The engaging portions 1250 are the side portions of the connecting portion 1202 and are arranged on the lower side. The connecting portion 1202 substantially has a convex shape projecting upward on the XZ plane and has a convex shape projecting in the Y direction on the XY plane. The Z-direction width of the engaging portion 1152 equals that of the engaging portion 1250, and the connecting portion 1202 projects upward in the Z direction from the periphery of the holding portion 1150. The user can thus easily pinch the connecting portion 1202 and easily detach the connecting portion 1202 from the concave portion 1151. When exchanging the liquid container 1200 in the tray 1110, the convenience of the exchange work can be improved.

Also, an engaging portion 1153 is formed on the vertical wall 1152a of each engaging portion 1152. The engaging portion 1153 is a projection projecting from the vertical wall 1152a in the Y direction. Each engaging portion 1250 includes an engaging portion 1251 that engages with the engaging portion 1153. The engaging portion 1251 is formed as a hole extending through the engaging portion 1250 in the Y direction or a concave portion recessed in the Y direction.

When attaching the liquid container 1200 to the tray 1110, the lower surfaces of the engaging portions 1250 contact the surfaces (tilting surfaces) of the engaging portions 1153 during the process of insertion of the engaging portions 1250 into the engaging portions 1152. Thus, the vertical walls 1152a of the engaging portions 1152 are elastically displaced to the rear side in the Y direction. When insertion of the engaging portions 1250 into the engaging portions 1152 progresses, the engaging portions 1153 reach the engaging portions 1251. Thus, the vertical walls 1152a return to the original positions, and the engaging portions 1153 engage with the engaging portions 1251.

The engaging direction between the engaging portion 1153 and the engaging portion 1251 is the Z direction, and this is different from the attachment/detachment direction (Y direction) of the tray 1110 to/from the storage portion 1101. This can prevent the connecting portion 1202 from falling from the holding portion 1150 at the time of attachment/detachment of the tray 1110.

### (Path Connection Structure)

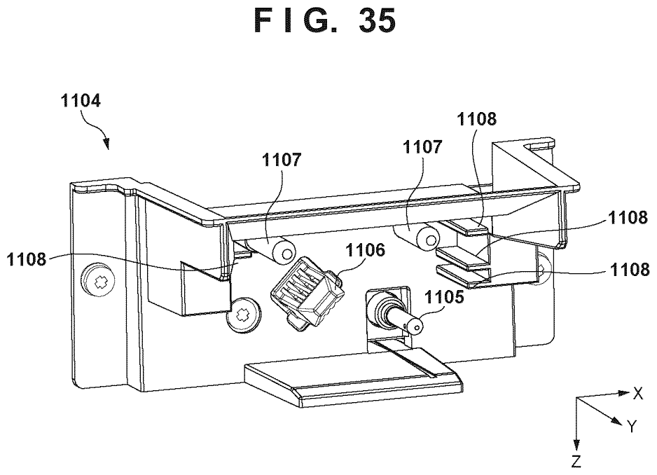

The connection structure between the connecting portion 1202 of the liquid container 1200 and the connecting unit 1104 of the storage portion 1101 will be described with reference to FIGS. 25, 32, and 35. FIG. 35 is a perspective view of the connecting unit 1104. The connecting portion 1202 of the liquid container 1200 is connected to the connecting unit 1104 by attaching the tray 1110 with the liquid container 1200 mounted to the storage portion 1101 and pushing it to the far side. Conversely, when the tray 1110 with the liquid container 1200 mounted is drawn from the storage portion 1101 to the near side, the connection between the connecting portion 1202 and the connecting unit 1104 is released.

The connecting portion 1202 is formed by, for example, molding a resin member such as polypropylene. The connecting portion 1202 is provided with a connecting hole 1210, an electrical connecting portion 1220, a plurality of positioning holes 1230, and fitting portions 1240.

The connecting unit 1104 includes a tube connecting pipe 1102 (FIG. 25) extended to the outside of the storage portion 1101, and a tube to be connected to a storage portion 700 is connected to the tube connecting pipe 1102. These form an ink path. The ink contained in the liquid container 1200 is supplied to a discharge head 108 via the storage portion 700.

The connecting hole 1210 is an opening portion of the path that is open in the Y direction and communicates with the inside of the container portion 1201. The center axis of the connecting hole 1210 is parallel to the Y direction. An introduction pipe 1105 of the connecting unit 1104 is connected to the connecting hole 1210 in the Y direction. The introduction pipe 1105 communicates with the tube connecting pipe 1102, and the ink in the liquid container 1200 is discharged via the connecting hole 1210 and the introduction pipe 1105.

Note that a structure configured to prevent ink leakage can be provided inside the connecting portion 1202. This structure may be a valve structure or seal structure that maintains a closed state before the introduction pipe 1105 is inserted into the connecting hole 1210 and opens when the introduction pipe 1105 is inserted.

In this embodiment, in the connecting portion 1202, a peripheral portion 1211 of the connecting hole 1210 is recessed in the Y direction as a whole, and the connecting hole 1210 opens at a position where it projects in the Y direction with respect to the peripheral portion 1211. Thus, the periphery of the connecting hole 1210 is surrounded by a wall portion formed by the peripheral portion 1211, and protectability of the connecting hole 1210 is improved. For example, user's touch on the connecting hole 1210 by mistake is suppressed. Also, when the liquid container 1200 falls by mistake, degradation such as damage or deformation of the connecting hole 1210 caused by collision is suppressed. A peripheral rib that is provided to surround the connecting hole 1210 and project in the Y direction may be formed on the peripheral portion 1211.

An electrical connecting portion 1106 of the connecting unit 1104 is inserted into the electrical connecting portion 1220 in the Y direction and structurally connected and electrically connected to it. The electrical connecting portion 1220 includes a circuit board and an electrical connecting terminal. The circuit board includes a memory that stores information of the liquid container 1200, and the like. By the electrical connection of the electrical connecting portion 1220 and the electrical connecting portion 1106, a control unit 961 can read out the information in the memory.

A shaft member 1107 of the connecting unit 1104 is inserted into each positioning hole 1230. The connecting portion 1202 and the connecting unit 1104 are positioned to each other. In this embodiment, two sets of positioning holes 1230 and shaft members 1107 are provided apart in the X direction, and the connecting hole 1210 and the introduction pipe 1105 are arranged between these in the X direction. This improves positioning accuracy of the connecting hole 1210 to the introduction pipe 1105 in the X direction.

In this embodiment, the type of liquid container 1200 to be stored in each storage portion 1101 (or the type of ink to be contained) is predetermined. The fitting portions 1240 structurally prevent the liquid container 1200 of a different type from being erroneously attached to the storage portion 1101.

The fitting portions 1240 are formed on the connecting portion 1202 divisionally in the X direction. The fitting portions 1240 project the same length in the X direction and each have a concave-convex structure in which a plurality of projecting portions 1241 having a substantially rectangular shape and parallelly extending in the −Y direction are arrayed. Sealing portions 1243 are arranged in a predetermined pattern on valley portions 1242 that are concave portions between the projecting portions 1241 in the fitting portion 1240. The sealing portion 1243 is a portion that closes the valley portion 1242, and the arrangement pattern of the sealing portions 1243 changes depending on the type of liquid container 1200.

Fitting portions 1108 to be fitted in the fitting portions 1240 are provided on the connecting unit 1104. The valley portions 1242 are sealed by arranging the sealing portions 1243, and the concave and convex portions in the arrangement pattern of the concave-convex structure of each fitting portion 1240 are reverse to those in the array pattern of the concave-convex structure of the corresponding fitting portion 1108 that is the connection target. When connecting the connecting portion 1202 to the connecting unit 1104, if the type of liquid container 1200 matches, fitting between the concave-convex structures of the fitting portions 1108 and the concave-convex structures of the fitting portions 1240 is permitted. On the other hand, if the type of liquid container 1200 does not match, the concave-convex structures of the fitting portions 1108 are not adapted to the concave-convex structures of the fitting portions 1240, and fitting is impossible. Hence, connection of a wrong liquid container 1200 to the connecting unit 1104 is suppressed.

### (Other Trays)

The tray 1110 and the tray 1111 basically have the same structure. The tray 1110 has a structure for stirring ink in the liquid container 1200, but not the tray 1111. For this reason, the tray 1111 does not include the placement member 1112 (and engaging portions) and the lock mechanism 1131.

### (Driving Unit and Stirring of Liquid)

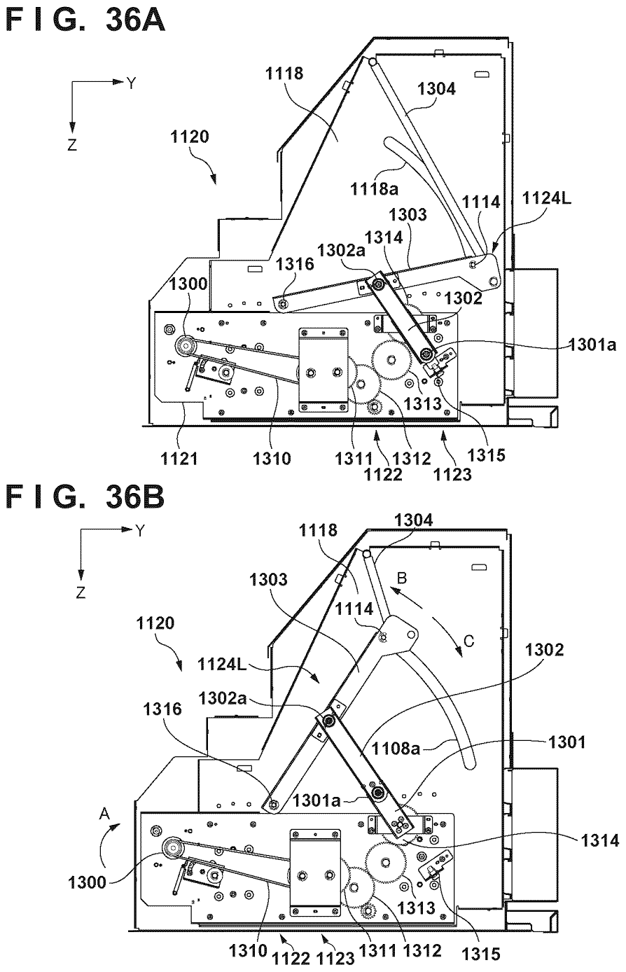

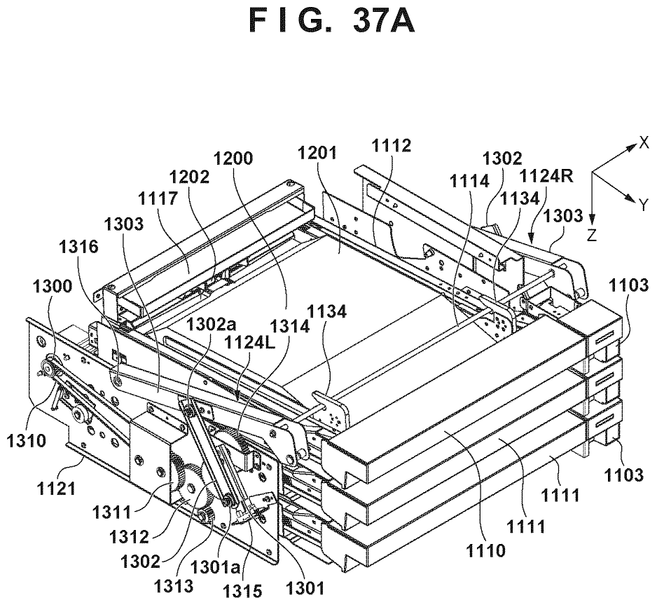

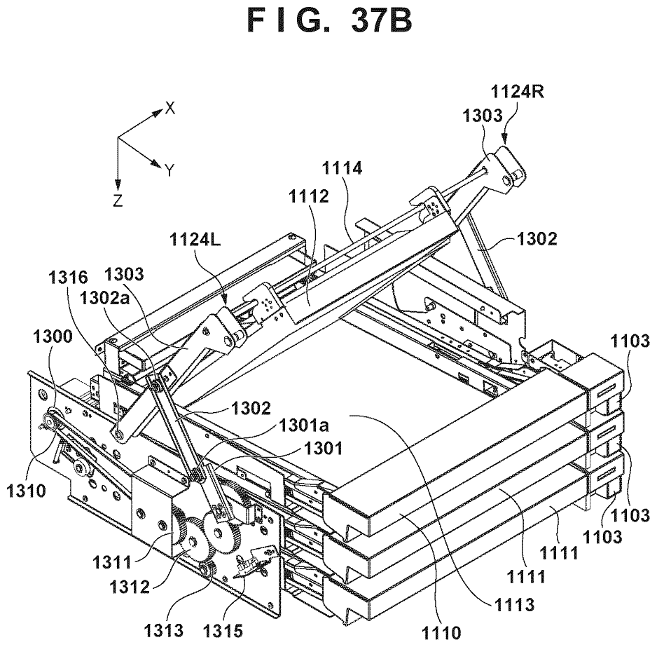

In this embodiment, the liquid container 1200 placed on the tray 1110 is rotated, thereby stirring the ink contained in the liquid container 1200. In this embodiment, the liquid container 1200 is rotated by rotating the placement member 1112. The configuration of the driving unit 1120 that rotates the placement member 1112 will be described with reference to FIG. 24 and FIGS. 36A to 37B. FIGS. 36A and 36B and FIGS. 37A and 37B are explanatory views of operation of the driving unit 1120.

FIGS. 36A and 37A show the state of the driving unit 1120 when the placement member 1112 is located at an initial position. FIGS. 36B and 37B show the state of the driving unit 1120 when the placement member 1112 is located at a maximum rotation position from the initial position. The rotation operation from the initial position to the maximum rotation position is called a tilting operation, and the rotation operation from the maximum rotation position to the initial position is called a recovery operation. In a tilting posture, the liquid in the container portion 1201 of the liquid container 1200 readily flows to the lower side (an end portion on the side of the connecting portion 1202). The recovery operation is an operation of returning the posture of the liquid container 1200 to the original posture (initial position).

The initial position is a position at which the tray 1110 can be inserted/removed into/from the storage portion 1101, and the entire tray 1110 and the liquid container 1200 are in a substantially horizontal posture (the side of the connecting portion 1202 is lightly lower). The maximum rotation position is a position at which the rotation amount of the placement member 1112 is maximum and, in this embodiment, it is a position about 45° from the initial position, and the container portion 1201 of the liquid container 1200 is in the tilting posture. At the maximum rotation position, the tray 1110 cannot be inserted/removed into/from the storage portion 1101. Concerning the posture of the container portion 1201 of the liquid container 1200, the container portion 1201 is closer to horizontal at the initial position than the maximum rotation position.

The driving unit 1120 is provided for each of the two storage portions 1101 of the uppermost stage. The driving unit 1120 includes a driving source 1300, a driving mechanism 1122 that rotates the placement member 1112 by the driving force of the driving source 1300, and a biasing member 1304.

The driving source 1300 is, for example, a stepping motor. In the drawings, the main body of the driving source 1300 is hidden behind a base plate 1121, and only a part thereof is shown. The rotation amount of the placement member 1112 can be controlled by the rotation amount of the driving source 1300. The driving source 1300 may be a DC motor. In this case, to control the rotation amount, a rotation amount sensor such as a rotary encoder may be provided.

The driving mechanism 1122 is a driving force transmission mechanism that rotates the placement member 1112 by the driving force of the driving source 1300, and is a conversion mechanism that converts the driving force of the driving source 1300 into the rotary motion of the placement member 1112. In this embodiment, the driving mechanism 1122 includes a gear device 1123, and a pair of link mechanisms 1124R and 1124L. The configuration of the driving mechanism 1122 is merely an example, and it may be a mechanism of another method.

The driving source 1300 and the gear device 1123 are mounted on the base plate 1121 arranged on one side portion of the storage portion 1101 in the X direction. The rotation force of the driving source 1300 is transmitted to the gear device 1123 via a belt transmission mechanism 1310. The gear device 1123 includes a gear 1311 that is rotated by the belt transmission mechanism 1310, a gear 1312 that meshes with the gear 1311, a gear 1313 that meshes with the gear 1312, and a gear 1314 that meshes with the gear 1313.

The pair of link mechanisms 1124R and 1124L are divisionally arranged on the side portions of the storage portion 1101 in the X direction. The link mechanism 1124L is arranged on the side of the driving source 1300, and the link mechanism 1124R is arranged on the opposite side. The link mechanism 1124L is a mechanism on the driving side, and the link mechanism 1124R is a mechanism on the driven side. These basically have the same configuration and form a crank mechanism to be described below.

The link mechanisms 1124R and 1124L each include arm members 1301 to 1303. The arm member 1301 rotates around one end portion thereof as the rotation center, and the other end portion is rotatably connected to one end portion of the arm member 1302 via a shaft 1301a. One end portion of the arm member 1301 of the link mechanism 1124L is coaxially fixed to the gear 1314 and rotates together with the gear 1314. One end portion of the arm member 1301 of the link mechanism 1124R is supported to be free to rotate, although not illustrated.

The other end portion of the arm member 1302 is rotatably connected to the intermediate portion of the arm member 1303 via a shaft 1302a. A pair of side plates 1118 are arranged on both side portions of the storage portion 1101 in the X direction. One end portion of the arm member 1303 is rotatably supported on the side plate 1118 via a shaft 1316. The shaft 1316 is located on the same axis as the rotation centerline C1 (FIG. 27) so that the rotation of the placement member 1112 synchronizes with the rotation of the arm member 1303.

A guide hole 1118a that has an arc shape and defines the swing track of a swing shaft 1114 is formed in the side plate 1118. The swing shaft 1114 is extended across the storage portion 1101 in the X direction. The swing shaft 1114 is disposed between the other end portions of the arm members 1303 of the link mechanisms 1124R and 1124L.

In a state in which the tray 1110 is attached to the storage portion 1101, the swing shaft 1114 engages with the engaging portion 1134. Since the engaging portion 1134 has a C shape open to one side (rear side) in the Y direction, at the time of attachment/detachment of the tray 1110, the swing shaft 1114 does not hinder it. When the tray 1110 is attached to the storage portion 1101, the swing shaft 1114 engages with the engaging portion 1134 in the Z direction. When the tray 1110 is detached from the storage portion 1101, the engagement between the swing shaft 1114 and the engaging portion 1134 is released.

The biasing member 1304 is provided between the other end portion of the arm member 1303 of the link mechanism 1124L and the adjacent side plate 1118. The biasing member 1304 is an elastic member such as a coil spring and generates a biasing force to the arm member 1303 in a direction in which the placement member 1112 is located at the maximum rotation position. A similar biasing member may be provided between the other end portion of the arm member 1303 of the link mechanism 1124R and the adjacent side plate 1118.

In FIG. 36B, if the driving source 1300 is one-directionally driven in the direction of an arrow A, the rotary motion of the motor shaft is converted into the swing motion of the swing shaft 1114 via the driving mechanism 1122, and the swing shaft 1114 is reciprocally continuously operated in the directions of arrows B and C. Along with the operation of the swing shaft 1114, the placement member 1112 and the liquid container 1200 set in it rotate, and the ink contained in the liquid container 1200 is stirred. As handling to the stirring, the placement member 1112 may be rotated continuously between the initial position and the maximum rotation position, or may be stopped at the maximum rotation position or the initial position for a predetermined time and rotated.

The biasing member 1304 is configured to bias the placement member 1112 to the maximum rotation position. As for the rotation of the placement member 1112 from the initial position to the maximum rotation position, the driving force of the driving source 1300 is minimum, and power consumption can be reduced. A sensor 1315 is a sensor that detects the posture of the placement member 1112. The sensor 1315 is an optical sensor configured to detect the position of the arm member 1301, and is arranged to detect the arm member 1301 when the placement member 1112 is at the initial position. Hence, when the sensor 1315 detects the arm member 1301, the excitation of the driving source 1300 is turned off, and the placement member 1112 can be rotated to the maximum rotation position by the biasing force of the biasing member 1304. After the elapse of a predetermined time from the detection of the arm member 1301 by the sensor 1315, regarding that the placement member 1112 is rotated to the maximum rotation position, the driving source 1300 may be driven to return the placement member 1112 to the initial position.

When exchanging the liquid container 1200, the placement member 1112 can be held at the initial position by exciting the driving source 1300 in a state in which the placement member 1112 is located at the initial position. This enables the insertion/removal operation of the tray 1110. The sensor 1315 is not limited to an optical sensor, and an encoder sensor that detects an angle or a sensor of another method of directly detecting the placement member 1112 may be used.

### Fourth Embodiment

In the configuration according to the first embodiment, an example of the execution timing of the stirring operation will be described. The stirring operation is performed in a case where, for example, a user instructs it, a container 200 is exchanged with a new one, or a predetermined time has elapsed. Here, control in a case where the stirring operation is periodically executed using time as a reference will be described. When the stirring operation is periodically performed, sedimentation of the color material in ink can be suppressed.

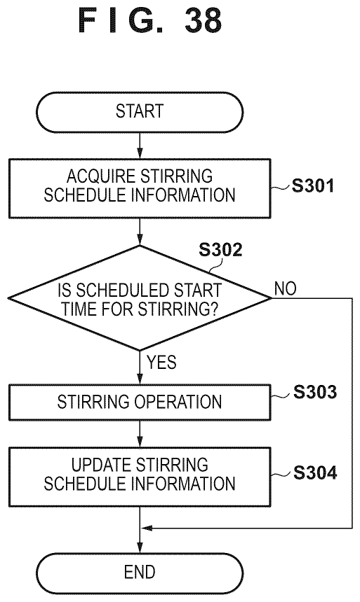

FIG. 38 is a flowchart showing an example of processing executed by a main control unit 917 and shows an example of processing concerning control of the execution time of the stirring operation. In step S301, stirring schedule information is acquired. The stirring schedule information is information that specifies the next execution time of the stirring operation and is stored in the storage device of the main control unit 917. The stirring schedule information includes at least a scheduled start time for execution of the stirring operation. The scheduled start time for execution may be expressed as a date/time. The stirring schedule information may include information that specifies the end time of the stirring operation, and this information may be information representing the end time or may be information of the execution time of the stirring operation. In a case where the execution time of the stirring operation is a fixed time, if the execution start time is specified, the end time is also specified. Hence, the stirring schedule information need only include information of the execution start time.

In step S302, it is determined, based on the stirring schedule information acquired in step S301 and the current date/time, whether the scheduled start time for stirring has arrived. Upon determining that the scheduled start time for stirring has arrived, the process advances to step S303. In step S303, a stirring operation start instruction is transmitted to a sub control unit 916, and the stirring operation is started under the control of the sub control unit 916.

In step S304, the stirring schedule information is updated to information indicating the next execution time of the stirring operation. For example, the stirring schedule information is updated to the date/time several days after. The processing is thus ended.

The relationship between a printing operation and the stirring operation will be described next. If the remaining amount in a storage portion 700 decreases during the printing operation, ink is supplied by a supply pump 500. On the other hand, during the stirring operation, the ink contained in a container 200 pulsates. If the stirring operation is performed during the supply operation and the ink in the container 200 pulsates, the ink supply amount does not stabilize. Hence, simultaneously performing the stirring operation and the supply operation is not preferable.

As a measure, preparing for the supply operation, the stirring operation may be performed in advance for every printing operation. In this measure, however, the downtime before the printing operation is large. Hence, in this embodiment, based on the stirring schedule information, if a printing operation start request is received, one of a plurality of control operations is selected and executed. One of these control operations is control for changing the stirring schedule information and executing the stirring operation before the printing operation (to be referred to as stirring preceding control), and another control operation is control for performing the stirring operation as indicated by the stirring schedule information without performing the stirring operation before the printing operation (to be referred to as normal stirring control).

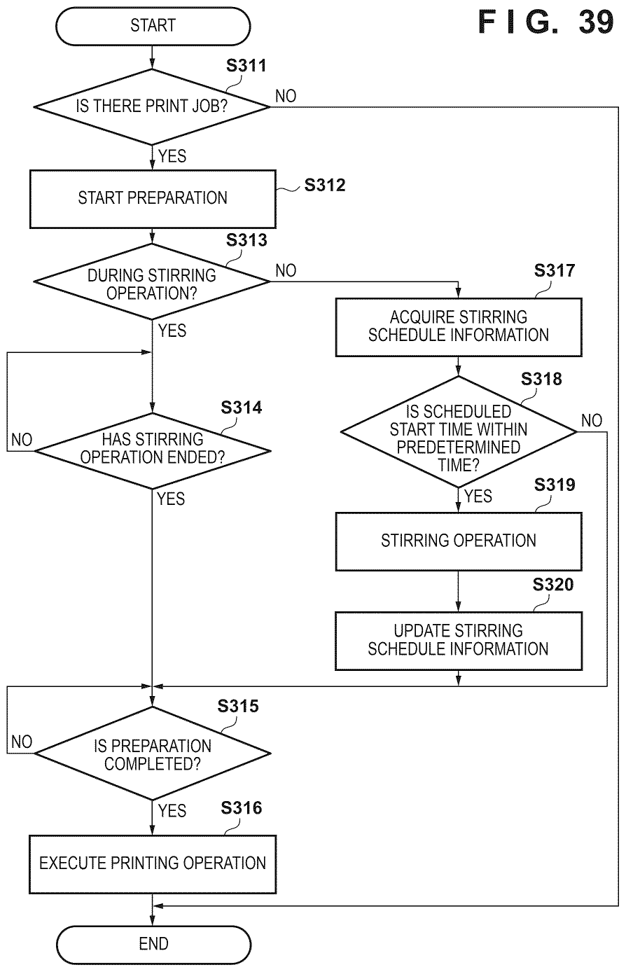

FIG. 39 is a flowchart showing an example of processing executed by the main control unit 917 and shows an example of processing concerning start control of the stirring operation in a case where a printing operation start request is received.

In step S311, it is determined whether a print job execution instruction exists as a printing operation start request. A case where a print job execution instruction exists includes a case where a print job is received from a host computer 918 and a case where a print job waiting for execution is stored in the storage device of the main control unit 917. Upon determining that a print job execution instruction exists, the process advances to step S312.

In step S312, print job execution preparation is started. The contents of the preparation are, for example, processing of print data and performance recovery processing for the discharge head 108 by a recovery unit 109. In step S313, it is determined, by communication with the control unit 916, whether the stirring operation is being performed. Upon determining that the stirring operation is being performed, the process advances to step S314. Upon determining that the stirring operation is not being performed, the process advances to step S317. In step S314, it is determined, by communication with the control unit 916, whether the stirring operation is ended. Upon determining that the stirring operation is ended, the process advances to step S315.

In step S317, stirring schedule information is acquired. In step S318, it is estimated, based on the acquired stirring schedule information, whether the scheduled start time for stirring arrives within a predetermined reference time from the start of the printing operation in the current print job. The start of the printing operation is, for example, the estimated completion time of the execution preparation started in step S312. The estimated completion time may be time after the elapse of a predetermined time. The predetermined time may be an average time required for execution preparation or may be a maximum time required for execution preparation. The reference time need only be time more than the execution time of the printing operation and may be, for example, the maximum time of a continuous printing operation executable in a liquid discharge apparatus 101. Upon estimating that the scheduled start time for stirring arrives within the reference time, stirring preceding control is selected, and the process advances to step S319. Upon estimating that the scheduled start time does not arrive in the reference time, normal stirring control is selected, and the process advances to step S315.

In step S319, the control unit 916 is instructed to start the stirring operation, and the stirring operation is executed. After the end of the stirring operation, in step S320, the stirring schedule information is updated to information indicating the next execution time of the stirring operation. This is the same processing as step S304 of FIG. 38. After that, the process advances to step S315.

In step S315, it is determined whether the execution preparation started in step S312 is completed. Upon determining that the execution preparation is completed, the process advances to step S316. In step S316, a control unit 915 is instructed to start the printing operation, and the printing operation is executed. The processing is thus ended.

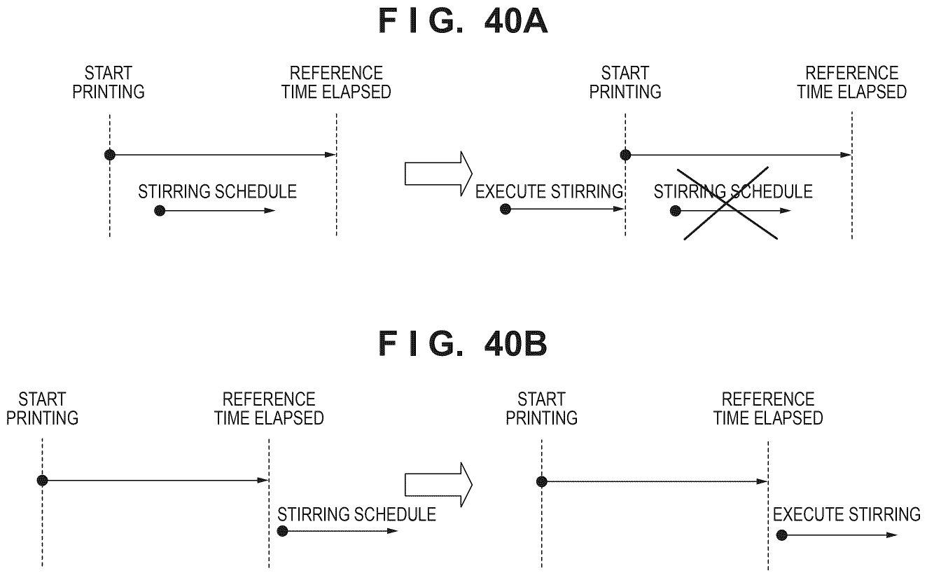

FIGS. 40A and 40B are timing charts showing a detailed example based on the processing shown in FIG. 39. In the example shown in FIG. 40A, the scheduled start time for the stirring operation arrives during time from the start of the printing operation to the elapse of the reference time. Hence, the scheduled start time is canceled, and the stirring operation is executed before the start of the printing operation (stirring preceding control).

In the example shown in FIG. 40B, the stirring operation is scheduled after the elapse of the reference time from the start of the printing operation. Hence, the stirring operation is executed as indicated by the scheduled start time (normal stirring control).

According to this embodiment, by this control, execution of the stirring operation during the printing operation is avoided. Hence, if the supply operation is performed during the printing operation, it does not overlap the stirring operation, and the ink supply amount can be stabilized. This can suppress the downtime while suppressing sedimentation of a substance in the ink.

### Fifth Embodiment

In the fourth embodiment, the scheduled start time for the stirring operation is compared with the reference time from the start of the printing operation, and one of stirring preceding control and normal stirring control is selected. As another example, the period of the printing operation may be estimated, and control may be selected by comparing the scheduled start time for the stirring operation with the estimated period.

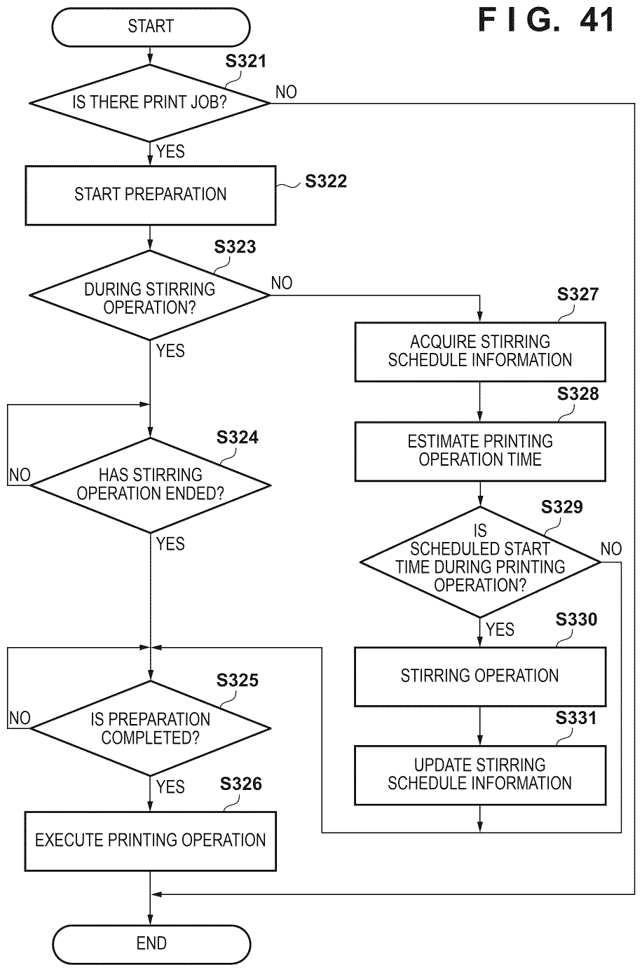

FIG. 41 is a flowchart showing an example of processing executed by a main control unit 917 and shows an example of processing replacing the example of processing shown in FIG. 39.

In step S321, it is determined whether a print job execution instruction exists as a printing operation start request. This is the same processing as step S311 of FIG. 39. Upon determining that a print job execution instruction exists, the process advances to step S322. In step S322, print job execution preparation is started. This is the same processing as step S312 of FIG. 39. In step S323, it is determined, by communication with a control unit 916, whether the stirring operation is being performed. This is the same processing as step S313 of FIG. 39. Upon determining that the stirring operation is being performed, the process advances to step S324. Upon determining that the stirring operation is not being performed, the process advances to step S327. In step S324, it is determined, by communication with the control unit 916, whether the stirring operation is ended. Upon determining that the stirring operation is ended, the process advances to step S325.

In step S327, stirring schedule information is acquired. This is the same processing as step S317 of FIG. 39. In step S328, the period (execution time) of the printing operation of the print job scheduled to be executed is estimated. This estimation can be performed based on a calculation result obtained by, for example, calculating the print scanning count or the conveyance amount of a print medium from the contents of the print job (the volume of the print data and the like).

In step S329, it is estimated, based on the stirring schedule information acquired in step S327 and the period of the printing operation estimated in step S328, whether the scheduled start time for stirring arrives during the printing operation. Note that the start of the printing operation is, for example, the estimated completion time of the execution preparation started in step S322. Upon estimating that the scheduled start time for stirring arrives during the printing operation, stirring preceding control is selected, and the process advances to step S330. Upon estimating that the scheduled start time does not arrive during the printing operation, normal stirring control is selected, and the process advances to step S325.

In step S330, the control unit 916 is instructed to start the stirring operation, and the stirring operation is executed. After the end of the stirring operation, in step S331, the stirring schedule information is updated to information indicating the next execution time of the stirring operation. After that, the process advances to step S325.

In step S325, it is determined whether the execution preparation started in step S322 is completed. Upon determining that the execution preparation is completed, the process advances to step S326. In step S326, a control unit 915 is instructed to start the printing operation, and the printing operation is executed. The processing is thus ended.

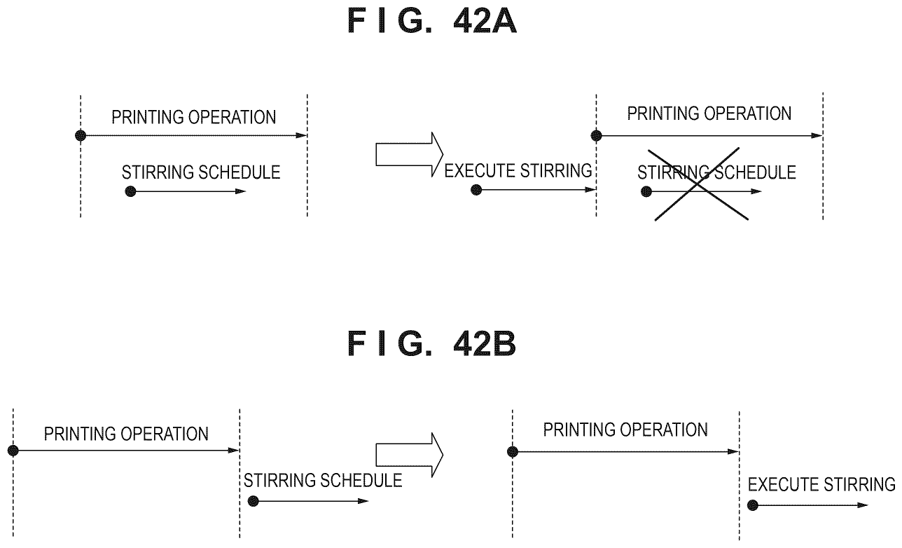

FIGS. 42A and 42B are timing charts showing a detailed example based on the processing shown in FIG. 41. In the example shown in FIG. 42A, the scheduled start time for the stirring operation arrives during the printing operation. Hence, the scheduled start time is canceled, and the stirring operation is executed before the start of the printing operation (stirring preceding control).

In the example shown in FIG. 42B, the stirring operation is scheduled after the printing operation. Hence, the stirring operation is executed as indicated by the scheduled start time (normal stirring control).

According to this embodiment, by this control, execution of the stirring operation during the printing operation is avoided. Hence, if the supply operation is performed during the printing operation, it does not overlap the stirring operation, and the ink supply amount can be stabilized. This can suppress the downtime while suppressing sedimentation of a substance in the ink. Also, as compared to the example of processing shown in FIG. 39 according to the fourth embodiment, it is more correctly determined whether the scheduled start time for the stirring operation arrives during the printing operation, and it is possible to prevent the scheduled start time for the stirring operation from being unnecessarily changed.

### Sixth Embodiment

In the fifth embodiment, the scheduled start time for the stirring operation is compared with the execution period of the printing operation, and one of stirring preceding control and normal stirring control is selected. As another example, the necessity of ink supply during the printing operation may be estimated, and control may be selected by comparing the scheduled start time for the stirring operation with the execution period of the printing operation or the necessity of ink supply.

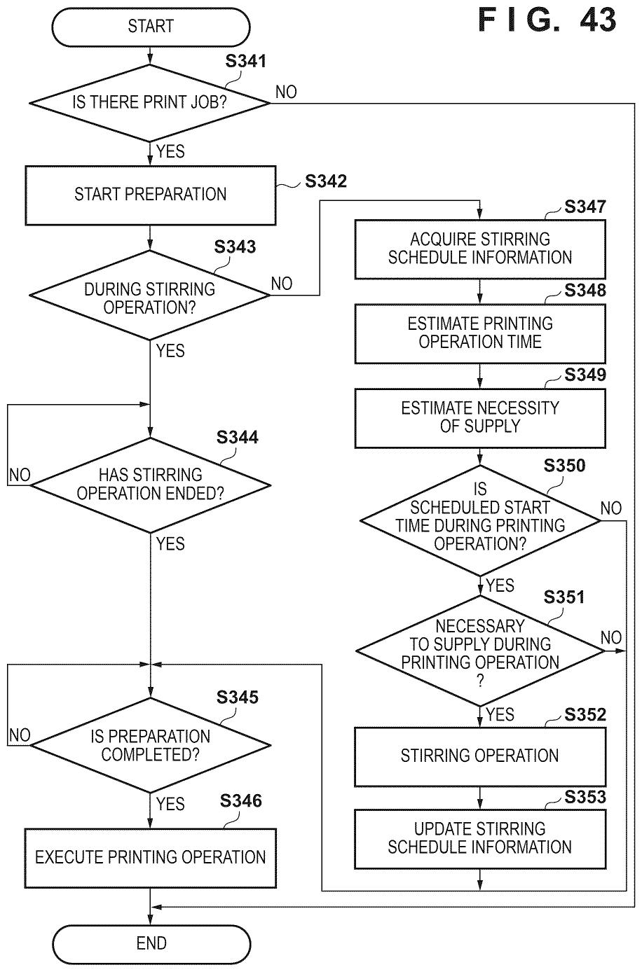

FIG. 43 is a flowchart showing an example of processing executed by a main control unit 917 and shows an example of processing replacing the example of processing shown in FIG. 39 or FIG. 41.

In step S341, it is determined whether a print job execution instruction exists as a printing operation start request. This is the same processing as step S311 of FIG. 39. Upon determining that a print job execution instruction exists, the process advances to step S342. In step S342, print job execution preparation is started. This is the same processing as step S312 of FIG. 39. In step S343, it is determined, by communication with a control unit 916, whether the stirring operation is being performed. This is the same processing as step S313 of FIG. 39. Upon determining that the stirring operation is being performed, the process advances to step S344. Upon determining that the stirring operation is not being performed, the process advances to step S347. In step S344, it is determined, by communication with the control unit 916, whether the stirring operation is ended. Upon determining that the stirring operation is ended, the process advances to step S345.

In step S347, stirring schedule information is acquired. This is the same processing as step S317 of FIG. 39. In step S348, the period (execution time) of the printing operation of the print job scheduled to be executed is estimated. This is the same processing as step S328 of FIG. 41.

In step S349, the necessity of ink supply during the printing operation is estimated. This estimation can be performed by, for example, calculating the consumption amount of ink based on the contents of the print job (the volume of the print data and the like) and comparing the calculation result with the ink remaining amount in each storage portion 700.

In step S350, it is estimated, based on the stirring schedule information acquired in step S347 and the period of the printing operation estimated in step S348, whether the scheduled start time for stirring arrives during the printing operation. Note that the start of the printing operation is, for example, the estimated completion time of the execution preparation started in step S342. Upon estimating that the scheduled start time for stirring arrives during the printing operation, the process advances to step S351. Upon estimating that the scheduled start time does not arrive during the printing operation, normal stirring control is selected, and the process advances to step S345.

In step S351, it is estimated, based on the estimation result of step S349, whether ink supply is performed during the printing operation. Upon estimating that ink supply is necessary, stirring preceding control is selected, and the process advances to step S352. Upon estimating that ink supply is unnecessary, normal stirring control is selected, and the process advances to step S345.

In step S352, the control unit 916 is instructed to start the stirring operation, and the stirring operation is executed. After the end of the stirring operation, in step S353, the stirring schedule information is updated to information indicating the next execution time of the stirring operation. After that, the process advances to step S345.

In step S345, it is determined whether the execution preparation started in step S342 is completed. Upon determining that the execution preparation is completed, the process advances to step S346. In step S346, a control unit 915 is instructed to start the printing operation, and the printing operation is executed. The processing is thus ended.

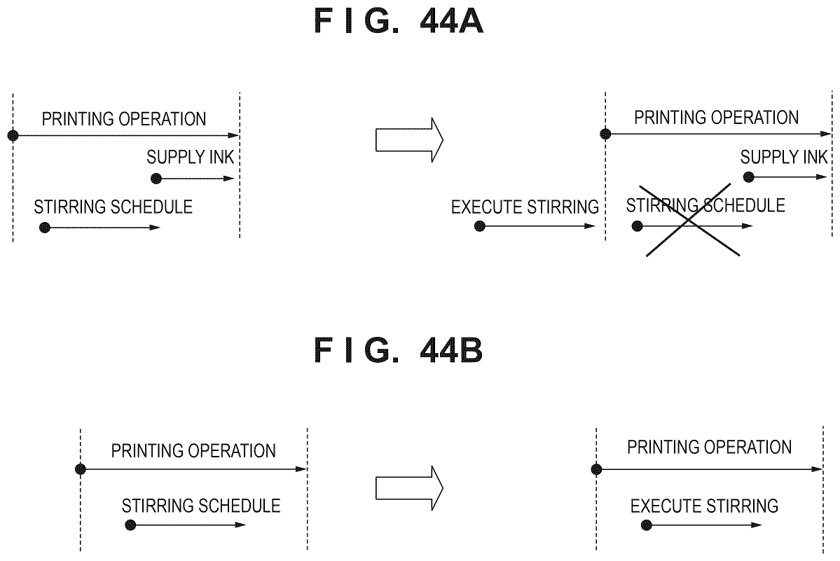

FIGS. 44A and 44B are timing charts showing a detailed example based on the processing shown in FIG. 43. In the example shown in FIG. 44A, the scheduled start time for the stirring operation arrives during the printing operation and it is estimated that ink supply is necessary. Hence, the scheduled start time is canceled, and the stirring operation is executed before the start of the printing operation (stirring preceding control).

In the example shown in FIG. 44B, the stirring operation is scheduled after the printing operation. However, it is estimated that ink supply is unnecessary. Hence, the stirring operation is executed as indicated by the scheduled start time (normal stirring control).

According to this embodiment, by this control, execution of the stirring operation during the ink supply operation is avoided. Hence, if the supply operation is performed during the printing operation, it does not overlap the stirring operation, and the ink supply amount can be stabilized. This can suppress the downtime while suppressing sedimentation of a substance in the ink. Also, as compared to the example of processing shown in FIG. 41 according to the fifth embodiment, it is more correctly determined whether the scheduled start time for the stirring operation arrives during the ink supply operation, and it is possible to prevent the scheduled start time for the stirring operation from being unnecessarily changed.

### Seventh Embodiment

In the sixth embodiment, the scheduled start time for the stirring operation is compared with the execution period of the printing operation or the necessity of ink supply, and control is selected. As another example, the ink supply period may be estimated, and control may be selected by comparing the scheduled start time for the stirring operation with the execution period of the printing operation or the ink supply period.

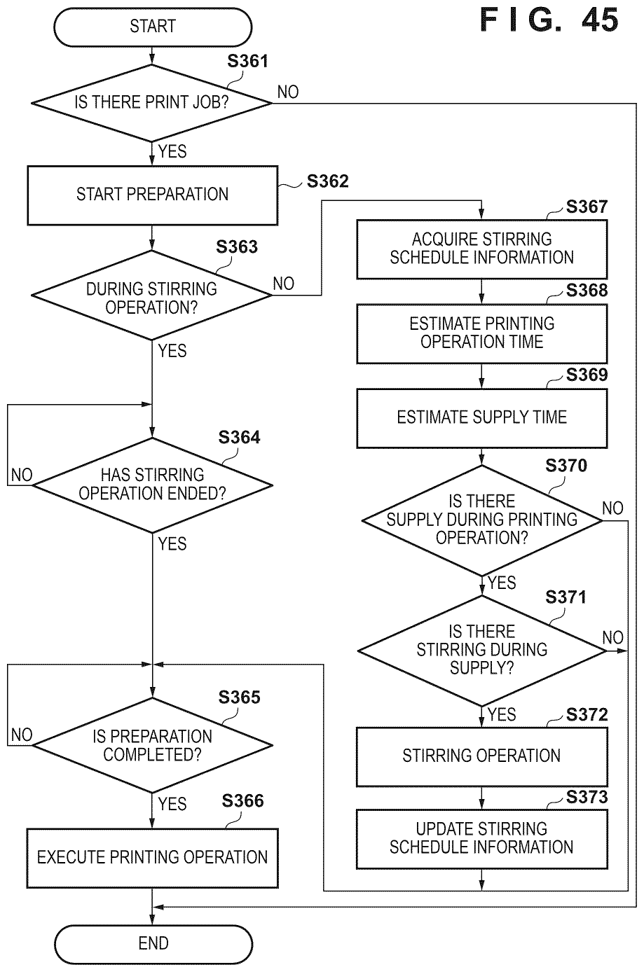

FIG. 45 is a flowchart showing an example of processing executed by a main control unit 917 and shows an example of processing replacing the example of processing shown in FIG. 39, 41, or 43.

In step S361, it is determined whether a print job execution instruction exists as a printing operation start request. This is the same processing as step S311 of FIG. 39. Upon determining that a print job execution instruction exists, the process advances to step S362. In step S362, print job execution preparation is started. This is the same processing as step S312 of FIG. 39. In step S363, it is determined, by communication with a control unit 916, whether the stirring operation is being performed. This is the same processing as step S313 of FIG. 39. Upon determining that the stirring operation is being performed, the process advances to step S364. Upon determining that the stirring operation is not being performed, the process advances to step S367. In step S364, it is determined, by communication with the control unit 916, whether the stirring operation is ended. Upon determining that the stirring operation is ended, the process advances to step S365.

In step S367, stirring schedule information is acquired. This is the same processing as step S317 of FIG. 39. In step S368, the period (execution time) of the printing operation of the print job scheduled to be executed is estimated. This is the same processing as step S328 of FIG. 41.

In step S369, the necessity of ink supply during the printing operation and the supply period are estimated. This estimation of the necessity can be performed by, for example, calculating the consumption amount of ink based on the contents of the print job (the volume of the print data and the like) and comparing the calculation result with the ink remaining amount in each storage portion 700. Also, as for the supply period, the start time of the ink supply operation can be estimated based on transition of the consumption amount of ink based on the contents of the print job (the volume of the print data and the like) in the period of the printing operation estimated in step S368. In addition, the end time can be estimated based on time required for the ink supply operation.

In step S370, it is estimated, based on the estimation result of step S369, whether ink supply is performed during the printing operation. Upon estimating that ink supply is necessary, the process advances to step S371. Upon estimating that ink supply is unnecessary, normal stirring control is selected, and the process advances to step S365.

In step S371, it is estimated, based on the stirring schedule information acquired in step S367 and the ink supply period estimated in step S369, whether the stirring operation is performed during ink supply. Upon estimating that the stirring operation is performed during ink supply, stirring preceding control is selected, and the process advances to step S372. Upon estimating that the stirring operation is not performed during ink supply, normal stirring control is selected, and the process advances to step S365.

In step S372, the control unit 916 is instructed to start the stirring operation, and the stirring operation is executed. After the end of the stirring operation, in step S373, the stirring schedule information is updated to information indicating the next execution time of the stirring operation. After that, the process advances to step S365.

In step S365, it is determined whether the execution preparation started in step S362 is completed. Upon determining that the execution preparation is completed, the process advances to step S366. In step S366, a control unit 915 is instructed to start the printing operation, and the printing operation is executed. The processing is thus ended.

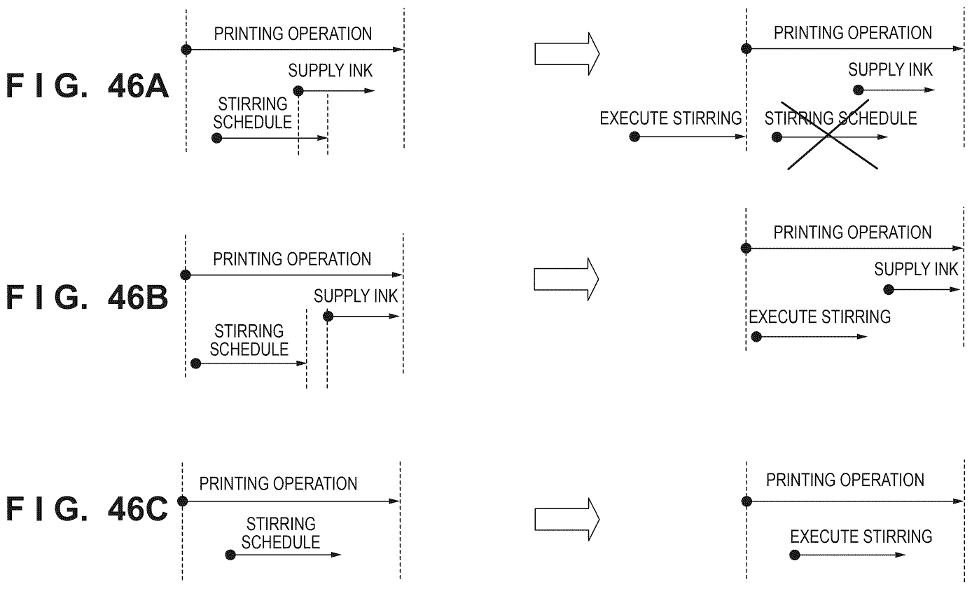

FIGS. 46A to 46C are timing charts showing a detailed example based on the processing shown in FIG. 45. In the example shown in FIG. 46A, it is estimated that ink supply is necessary during the printing operation and the stirring operation is performed during ink supply. Hence, the scheduled start time for the stirring operation is canceled, and the stirring operation is executed before the start of the printing operation (stirring preceding control).

In the example shown in FIG. 46B, it is estimated that ink supply is necessary during the printing operation but the stirring operation is not performed during ink supply. Hence, the stirring operation is executed as indicated by the scheduled start time (normal stirring control).

In the example shown in FIG. 46C, it is estimated that the scheduled time for stirring arrives during the printing operation but ink supply is unnecessary during the printing operation. Hence, the stirring operation is executed as indicated by the scheduled start time (normal stirring control).

According to this embodiment, by this control, execution of the stirring operation during the ink supply operation is avoided. Hence, if the supply operation is performed during the printing operation, it does not overlap the stirring operation, and the ink supply amount can be stabilized. This can suppress the downtime while suppressing sedimentation of a substance in the ink. Also, as compared to the example of processing shown in FIG. 43 according to the sixth embodiment, it is more correctly determined whether the stirring operation is performed during the ink supply operation, and it is possible to prevent the scheduled start time for the stirring operation from being unnecessarily changed.

### Eighth Embodiment

In the fourth to seventh embodiments, as the examples of control selected in a case where a printing operation start request is received, two types of control including stirring preceding control and normal stirring control have been exemplified. However, one of three or more types of control may be selected. For example, as the stirring preceding control, control with a normal operation time and control with a short operation time may be included as options. Also, as the stirring preceding control, control with a normal stirring intensity and control with a high stirring intensity may be included as options.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-203414, filed Nov. 21, 2024, and No. 2024-227962, filed Dec. 24, 2024, which are hereby incorporated by reference herein in their entirety.

What is claimed is:

1. A system comprising:
a storage unit configured to store a liquid container;
a discharging unit configured to discharge a liquid to a medium;
a stirring unit configured to perform a stirring operation for the liquid container stored in the storage unit such that the liquid stored in the liquid container is stirred;
a supplying unit configured to perform a supply operation for supplying the liquid from the liquid container stored in the storage unit to the discharging unit; and
a control unit configured to execute first control of prioritizing the supply operation over the stirring operation.

2. The system according to claim 1, wherein
if a start condition of the stirring operation is satisfied when the supply operation is being performed by the supplying unit, the control unit executes the first control based on satisfaction of a continuation condition of the supply operation.

3. The system according to claim 1, wherein
if a start condition of the supply operation is satisfied when the stirring operation is being performed by the stirring unit, the control unit executes the first control based on satisfaction of an interruption condition of the stirring operation.

4. The system according to claim 1, wherein
in the first control, the supply operation is performed by the supplying unit in a state in which the stirring operation by the stirring unit is stopped.

5. The system according to claim 1, wherein
the control unit is configured to execute second control of prioritizing the stirring operation over the supply operation.

6. The system according to claim 5, wherein
if a start condition of the stirring operation is satisfied when the supply operation is being performed by the supplying unit, the control unit executes the second control based on satisfaction of an interruption condition of the supply operation.

7. The system according to claim 5, wherein
if a start condition of the supply operation is satisfied when the stirring operation is being performed by the stirring unit, the control unit executes the second control based on satisfaction of a continuation condition of the stirring operation.

8. The system according to claim 5, wherein
the control unit executes the second control if the liquid container stored in the storage unit is exchanged.

9. The system according to claim 5, wherein
in the second control, the stirring operation is performed by the stirring unit in a state in which the supply operation by the supplying unit is stopped.

10. The system according to claim 5, wherein
the control unit selects one of the first control and the second control based on a remaining time of a timer that is reset when the stirring operation is performed.

11. The system according to claim 10, wherein
if the supply operation is being performed by the supplying unit at a start timing of the stirring operation by the stirring unit, the control unit selects the first control based on a fact that a supply time required for the supply operation is shorter than the remaining time.

12. The system according to claim 11, wherein
as the first control, the control unit is configured to cause the supplying unit to perform the supply operation and after that to cause the stirring unit to perform the stirring operation.

13. The system according to claim 10, wherein
if the supply operation is being performed by the supplying unit at a start timing of the stirring operation by the stirring unit, the control unit selects the second control based on a fact that a supply time required for the supply operation is longer than the remaining time.

14. The system according to claim 13, wherein
as the second control, the control unit is configured to interrupt the supply operation by the supplying unit and after that to cause the stirring unit to perform the stirring operation.

15. The system according to claim 10, wherein
if the stirring operation is being performed by the stirring unit at a start timing of the supply operation by the supplying unit, the control unit selects the first control based on a fact that a supply time required for the supply operation is shorter than the remaining time.

16. The system according to claim 15, wherein
as the first control, the control unit interrupts the stirring operation by the stirring unit and causes the supplying unit to perform the supply operation.

17. The system according to claim 10, wherein
if the stirring operation is being performed by the stirring unit at a start timing of the supply operation by the supplying unit, the control unit selects the second control based on a fact that a supply time required for the supply operation is longer than the remaining time.

18. The system according to claim 17, wherein
as the second control, the control unit is configured to cause the stirring unit to perform the stirring operation and after that to cause the supplying unit to perform the supply operation.

19. A system comprising:
a plurality of storage units each configured to store a liquid container;
a discharging unit configured to discharge a liquid to a medium;
a stirring unit configured to synchronously perform a stirring operation for the liquid containers stored in the plurality of storage units such that the liquid stored in each liquid container is stirred;
a plurality of supplying units configured to perform a supply operation for supplying the liquid from each liquid container stored in each of the plurality of storage units to the discharging unit; and
a control unit configured to execute first control of prioritizing the supply operation by a first supplying unit of the plurality of supplying units over the stirring operation.

20. A system comprising:
a storage unit configured to store a liquid container;
a discharging unit configured to discharge a liquid to a medium;
a stirring unit configured to perform a stirring operation for the liquid container stored in the storage unit such that the liquid stored in the liquid container is stirred; and
a control unit configured to control the stirring unit,
wherein if there is a start request of a discharge operation of the liquid by the discharging unit, the control unit executes control selected from a plurality of control operations, and
the plurality of control operations include
first control of changing a scheduled start time for the stirring operation and executing the stirring operation before the discharge operation, and
second control of executing the stirring operation at the scheduled start time for the stirring operation.

21. The system according to claim 20, wherein
the control unit executes control selected from the plurality of control operations based on the scheduled start time.

22. The system according to claim 20, wherein
the control unit is configured to estimate a period of the discharge operation and to execute control selected from the plurality of control operations based on the scheduled start time and the period of the discharge operation.

23. The system according to claim 20, further comprising a supplying unit configured to perform a supply operation for supplying the liquid from the liquid container stored in the storage unit to the discharging unit,
wherein the control unit is configured to estimate whether the supply operation is performed during the discharge operation, and to execute control selected from the plurality of control operations based on an estimation result.

24. The system according to claim 20, further comprising a supplying unit configured to perform a supply operation for supplying the liquid from the liquid container stored in the storage unit to the discharging unit,
wherein the control unit is configured to estimate a period of the supply operation during the discharge operation and to execute control selected from the plurality of control operations based on the scheduled start time and the period of the supply operation.

25. The system according to claim 20, wherein
upon estimating that the scheduled start time arrives within a predetermined time from a start of the discharge operation, the control unit executes the first control.

26. The system according to claim 25, wherein
upon estimating that the scheduled start time does not arrive within the predetermined time, the control unit executes the second control.

27. The system according to claim 20, wherein
upon estimating that the scheduled start time arrives during the discharge operation, the control unit executes the first control.

28. The system according to claim 27, wherein
upon estimating that the scheduled start time does not arrive during the discharge operation, the control unit executes the second control.

29. The system according to claim 20, further comprising a supplying unit configured to perform a supply operation for supplying the liquid from the liquid container stored in the storage unit to the discharging unit,
wherein upon estimating that the scheduled start time arrives and the supply operation is performed during the discharge operation, the control unit executes the first control.

30. The system according to claim 29, wherein
upon estimating that the supply operation is not performed during the discharge operation, the control unit executes the second control.

31. The system according to claim 20, further comprising a supplying unit configured to perform a supply operation for supplying the liquid from the liquid container stored in the storage unit to the discharging unit,
wherein the control unit is configured to estimate a period of the supply operation during the discharge operation and to execute the first control if the stirring operation is performed during the supply operation.

32. The system according to claim 31, wherein if the stirring operation is not performed during the supply operation, the control unit executes the second control.

33. The system according to claim 20, wherein the discharging unit discharges ink as the liquid and prints an image on the medium.
